(19) United States
(12) Patent Application Publication
(10) Pub. No.: US 2025/0384859 A1
(43) Pub. Date: Dec. 18, 2025

(54) DISPLAY DEVICE, DISPLAY SYSTEM, AND DISPLAY METHOD

(71) Applicant: SONY SEMICONDUCTOR SOLUTIONS CORPORATION, KANAGAWA (JP)

(72) Inventors: KOTA MASE, KANAGAWA (JP); TAKAYUKI KANDA, KANAGAWA (JP); TARO ICHITSUBO, KANAGAWA (JP)

(21) Appl. No.: 19/251,668

(22) Filed: Jun. 26, 2025

Related U.S. Application Data
(63) Continuation of application No. 18/712,794, filed on May 23, 2024.

(30) Foreign Application Priority Data
Dec. 1, 2021 (JP) 2021-195400

(51) Int. Cl. G09G 5/391

(52) U.S. Cl. CPC G09G 5/391; G09G 2340/0407

(57) ABSTRACT

A display device according to the present disclosure includes: a reception circuit that is configured to receive a piece of first image data, a piece of second image data, and a piece of third image data, the piece of first image data representing an entire image having a first resolution, the piece of second image data representing a peripheral image having a second resolution less than or equal to the first resolution, the peripheral image including an image outside the entire image, the piece of third image data representing a first partial image having a third resolution higher than the first resolution, the first partial image including an image having an image range narrower than an image range of the entire image; a display section that includes a plurality of pixels, and is configured to display an image having a same image range as the image range of the entire image; a first sensor that is configured to detect a change in orientation of the display device; an image processing circuit that is configured to perform a first image processing for generating a piece of display image data by performing a geometric deformation processing on the piece of first image data, the piece of second image data, and the piece of third image data on the basis of a result of detection by the first sensor; and a display drive circuit that is configured to drive the display section on the basis of the piece of display image data.

### CROSS-REFERENCE TO RELATED APPLICATIONS

The present application is a continuation application of U.S. patent application Ser. No. 18/712,794, filed May 23, 2024, which is a National Stage Entry of PCT/JP2022/037182, filed on Oct. 4, 2022, and claims the benefit of priority from Japanese Priority Patent Application JP 2021-195400 filed in the Japan Patent Office Dec. 1, 2021, the entire contents of which are hereby incorporated by reference.

### TECHNICAL FIELD

The present disclosure relates to a display device that displays an image, a display system, and a display method used in the display device and the display system.

### BACKGROUND ART

For example, there is a display device that generates a display image by performing a reprojection processing on the basis of a piece of image data supplied. For example, PTL 1 discloses a technology for generating a display image by performing the reprojection processing with use of information about a depth value on the basis of a piece of image data supplied (for example, PTL 1).

### CITATION LIST

### Patent Literature

PTL 1: Japanese Unexamined Patent Application Publication No. 2021-15372

### SUMMARY OF THE INVENTION

Incidentally, in a head-mounted display used for augmented reality (AR; Augmented Reality) or virtual reality (VR; Virtual Reality), reduction in a latency is desired so as to allow an image corresponding to a change in direction of the head-mounted display to be immediately displayed.

It is desirable to provide a display device, a display system, and a display method that make it possible to reduce a latency.

A display device according to an embodiment of the present disclosure includes a reception circuit, a display section, a first sensor, an image processing circuit, and a display drive circuit. The reception circuit is configured to receive a piece of first image data, a piece of second image data, and a piece of third image data. The piece of first image data represents an entire image having a first resolution. The piece of second image data represents a peripheral image having a second resolution less than or equal to the first resolution. The peripheral image includes an image outside the entire image. The piece of third image data represents a first partial image having a third resolution higher than the first resolution. The first partial image includes an image having an image range narrower than an image range of the entire image. The display section includes a plurality of pixels, and is configured to display an image having a same image range as the image range of the entire image. The first sensor is configured to detect a change in orientation of the display device. The image processing circuit is configured to perform a first image processing for generating a piece of display image data by performing a geometric deformation processing on the piece of first image data, the piece of second image data, and the piece of third image data on the basis of a result of detection by the first sensor. The display drive circuit is configured to drive the display section on the basis of the piece of display image data.

A display system according to an embodiment of the present disclosure includes an image generation device and a display device. The image generation device is configured to transmit a piece of first image data, a piece of second image data, and a piece of third image data. The piece of first image data represents an entire image having a first resolution. The piece of second image data represents a peripheral image having a second resolution less than or equal to the first resolution. The peripheral image includes an image outside the entire image. The piece of third image data represents a first partial image having a third resolution higher than the first resolution. The first partial image includes an image having an image range narrower than an image range of the entire image. The display device includes a reception circuit, a display section, a first sensor, an image processing circuit, and a display drive circuit. The reception circuit is configured to receive the piece of first image data, the piece of second image data, and the piece of third image data. The display section includes a plurality of pixels, and is configured to display an image having a same image range as the image range of the entire image. The first sensor is configured to detect a change in orientation of the display device. The image processing circuit is configured to perform a first image processing for generating a piece of display image data by performing a geometric deformation processing on the piece of first image data, the piece of second image data, and the piece of third image data on the basis of a result of detection by the first sensor. The display drive circuit is configured to drive the display section on the basis of the piece of display image data.

A display method according to an embodiment of the present disclosure includes: receiving a piece of first image data, a piece of second image data, and a piece of third image data, the piece of first image data representing an entire image having a first resolution, the piece of second image data representing a peripheral image having a second resolution less than or equal to the first resolution, the peripheral image including an image outside the entire image, the piece of third image data representing a first partial image having a third resolution higher than the first resolution, the first partial image including an image having an image range narrower than an image range of the entire image; detecting a change in orientation of a display device with use of a first sensor; performing a first image processing for generating a piece of display image data by performing a geometric deformation processing on the piece of first image data, the piece of second image data, and the piece of third image data on the basis of a result of detection by the first sensor; and driving a display section on the basis of the piece of display image data, the display section being configured to display an image having a same image range as the image range of the entire image.

In the display device, the display system, and the display method according to the embodiments of the present disclosure, the piece of first image data representing the entire image having the first resolution, the piece of second image data representing the peripheral image having the second resolution less than or equal to the first resolution, the piece of third image data representing the first partial image having the third resolution higher than the first resolution are received. The peripheral image includes an image outside the entire image. The first partial image includes an image having the image range narrower than the image range of the entire image. In addition, the first sensor detects a change in orientation of the display device. The first image processing for generating the piece of display image data is performed by performing the geometric deformation processing on the piece of first image data, the piece of second image data, and the piece of third image data on the basis of the result of detection by the first sensor. Thereafter, the display section that is configured to display an image having the same image range as the image range of the entire image is driven on the basis of the piece of display image data generated.

### BRIEF DESCRIPTION OF THE DRAWINGS

FIG. 1 is a block diagram illustrating a configuration example of a display system according to a first embodiment of the present disclosure.

FIG. 2 is an explanatory diagram illustrating an example of an image generated by an image generation circuit illustrated in FIG. 1.

FIGS. 3A, 3B, and 3C are explanatory diagrams illustrating an operation example of the display system illustrated in FIG. 1.

FIG. 4 is an explanatory diagram illustrating a transmission band of the display system illustrated in FIG. 1.

FIG. 5 is an explanatory diagram illustrating a change in orientation of a head-mounted display illustrated in FIG. 1.

FIG. 6 is an explanatory diagram illustrating an example of an image processing in a predictive processing circuit illustrated in FIG. 1.

FIG. 7 is an explanatory diagram illustrating another example of the image processing in the predictive processing circuit illustrated in FIG. 1.

FIG. 8 is an explanatory diagram illustrating another example of the image processing in the predictive processing circuit illustrated in FIG. 1.

FIG. 9 is an explanatory diagram illustrating another example of the image processing in the predictive processing circuit illustrated in FIG. 1.

FIG. 10 is a block diagram illustrating a configuration example of a display panel illustrated in FIG. 1.

FIGS. 11A, 11B, 11C, and 11D are timing charts illustrating an example of input signals of a display controller illustrated in FIG. 1.

FIG. 12 is another timing chart illustrating an example of input signals of the display controller illustrated in FIG. 1.

FIGS. 13A, 13B, 13C, and 13D are timing charts illustrating an example of output signals of the display controller illustrated in FIG. 1.

FIG. 14 is another timing chart illustrating an example of output signals of the display controller illustrated in FIG. 1.

FIG. 15 is an explanatory diagram illustrating an example of a pixel driving operation.

FIG. 16 is an explanatory diagram illustrating another example of the pixel driving operation.

FIGS. 17A, 17B, and 17C are explanatory diagrams illustrating an example of a pixel driving operation in the head-mounted display illustrated in FIG. 1.

FIGS. 18A and 18B are explanatory diagrams illustrating an operation example of the predictive processing circuit illustrated in FIG. 1.

FIGS. 19A and 19B are explanatory diagrams illustrating an operation example of the predictive processing circuit illustrated in FIG. 1.

FIGS. 20A and 20B are explanatory diagrams illustrating an operation example of the predictive processing circuit illustrated in FIG. 1.

FIG. 21 is a timing chart illustrating an example of a display operation in the display system illustrated in FIG. 1.

FIG. 22 is a timing chart illustrating another example of the display operation in the display system illustrated in FIG. 1.

FIGS. 23A, 23B, and 23C are explanatory diagrams illustrating an example of an image signal in the display system illustrated in FIG. 1.

FIGS. 24A, 24B, and 24C are explanatory diagrams illustrating another example of the image signal in the display system illustrated in FIG. 1.

FIGS. 25A, 25B, and 25C are explanatory diagrams illustrating another example of the image signal in the display system illustrated in FIG. 1.

FIGS. 26A, 26B, and 26C are explanatory diagrams illustrating another example of the image signal in the display system illustrated in FIG. 1.

FIGS. 27A, 27B, 27C, and 27D are timing charts illustrating an operation example of the display system illustrated in FIG. 1.

FIGS. 28A, 28B, 28C, and 28D are timing charts illustrating another operation example of the display system illustrated in FIG. 1.

FIGS. 29A, 29B, 29C, and 29D are timing charts illustrating another operation example of the display system illustrated in FIG. 1.

FIG. 30 is an explanatory diagram illustrating an example of a peripheral image according to a modification example of the first embodiment.

FIG. 31 is a table illustrating an example of the peripheral image according to the modification example of the first embodiment.

FIG. 32 is an explanatory diagram illustrating an operation example of a predictive processing circuit according to another modification example of the first embodiment.

FIG. 33 is an explanatory diagram illustrating an example of an image generated by an image generation circuit according to another modification example of the first embodiment.

FIGS. 34A, 34B, and 34C are tables illustrating an operation example of a display system according to another modification example of the first embodiment.

FIG. 35 is an explanatory diagram illustrating a transmission band of a display system according to another modification example of the first embodiment.

FIGS. 36A, 36B, 36C, and 36D is a timing chart illustrating an example of output signals of a display controller according to another modification example of the first embodiment.

FIG. 37 is another timing chart illustrating an example of output signals of a display controller according to another modification example of the first embodiment.

FIGS. 38A, 38B, and 38C are explanatory diagrams illustrating an example of a pixel driving operation according to another modification example of the first embodiment.

FIGS. 39A, 39B, 39C, 39D, 39E, 39F, and 39G are explanatory diagrams illustrating another example of the pixel driving operation according to another modification example of the first embodiment.

FIG. 40 is a block diagram illustrating a configuration example of a display system according to a second embodiment.

FIGS. 41A, 41B, and 41C are explanatory diagrams illustrating an operation example of the display system illustrated in FIG. 40.

FIG. 42 is an explanatory diagram illustrating a transmission band of the display system illustrated in FIG. 40.

FIGS. 43A, 43B, 43C, and 43D are timing charts illustrating an example of input signals of a display controller illustrated in FIG. 40.

FIG. 44 is another timing chart illustrating an example of input signals of the display controller illustrated in FIG. 40.

FIGS. 45A, 45B, 45C, and 45D are timing charts illustrating an example of output signals of the display controller illustrated in FIG. 40.

FIG. 46 is another timing chart illustrating an example of output signals of the display controller illustrated in FIG. 40.

FIGS. 47A and 47B are explanatory diagrams illustrating an example of a pixel driving operation in a head-mounted display illustrated in FIG. 40.

FIG. 48 is a block diagram illustrating a configuration example of a display system according to a third embodiment.

FIG. 49 is an explanatory diagram illustrating an example of an image generated by an image generation circuit illustrated in FIG. 48.

FIG. 50 is an explanatory diagram illustrating a transmission band of the display system illustrated in FIG. 48.

FIGS. 51A and 51B are explanatory diagrams illustrating an operation example of a head-mounted display illustrated in FIG. 48.

FIGS. 52A, 52B, and 52C are timing charts illustrating an operation example of the display system illustrated in FIG. 48.

FIG. 53 is a block diagram illustrating a configuration example of a display system according to a fourth embodiment.

FIGS. 54A and 54B are explanatory diagrams illustrating an example of an image generated by an image generation circuit illustrated in FIG. 53.

FIG. 55 is an explanatory diagram illustrating an example of an image signal illustrated in FIG. 53.

FIG. 56 is an explanatory diagram illustrating an operation example of a head-mounted display illustrated in FIG. 53.

FIGS. 57A, 57B, and 57C are timing charts illustrating an operation example of the display system illustrated in FIG. 53.

FIG. 58 is a perspective view of an appearance configuration of a head-mounted display according to an application example.

FIG. 59 is a perspective view of an appearance configuration of another head-mounted display according to the application example.

FIG. 60A is a front view of an appearance configuration of a digital still camera according to another application example.

FIG. 60B is a rear view of an appearance configuration of the digital still camera according to another application example.

FIG. 61 is a rear view of an appearance configuration of a television apparatus according to another application example.

FIG. 62 is a rear view of an appearance configuration of a smartphone according to another application example.

FIG. 63A is an explanatory diagram illustrating a configuration example of a vehicle according to another application example.

FIG. 63B is another explanatory diagram illustrating a configuration example of the vehicle according to another application example.

FIG. 64 is a block diagram illustrating a configuration example of a head-mounted display according to a modification example.

FIG. 65 is a block diagram illustrating a configuration example of a display panel according to another modification example.

FIG. 66 is a circuit diagram illustrating a configuration example of a pixel illustrated in FIG. 65.

FIG. 67 is a circuit diagram illustrating another configuration example of the pixel illustrated in FIG. 65.

FIG. 68 is a circuit diagram illustrating another configuration example of the pixel illustrated in FIG. 65.

FIG. 69 is a circuit diagram illustrating another configuration example of the pixel illustrated in FIG. 65.

FIG. 70 is a circuit diagram illustrating another configuration example of the pixel illustrated in FIG. 65.

FIG. 71 is a circuit diagram illustrating another configuration example of the pixel illustrated in FIG. 65.

FIG. 72 is a circuit diagram illustrating another configuration example of the pixel illustrated in FIG. 65.

FIG. 73 is a circuit diagram illustrating another configuration example of the pixel illustrated in FIG. 65.

### MODES FOR CARRYING OUT THE INVENTION

Some embodiments of the present disclosure are described below in detail with reference to the drawings. It is to be noted that description is given in the following order.
1. First Embodiment
2. Second Embodiment
3. Third Embodiment
4. Fourth Embodiment
5. Application Examples

### 1. First Embodiment

### Configuration Example

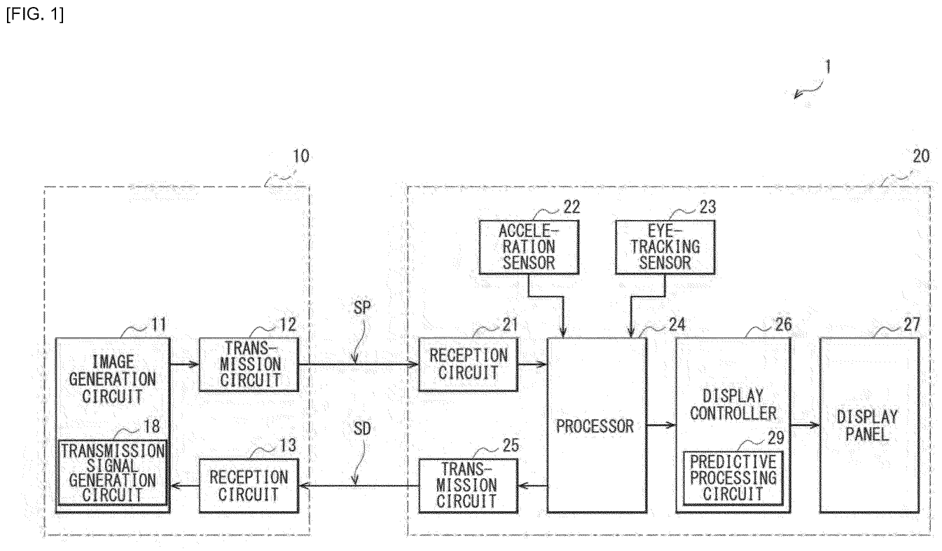

FIG. 1 illustrates a configuration example of a display system (a display system 1) according to an embodiment. It is to be noted that a display device and a display method according to embodiments of the present disclosure are embodied by the present embodiment, and are therefore described together.

The display system 1 includes an image generation device 10 and a head-mounted display 20. The display system 1 is used for augmented reality or virtual reality. The display system 1 is configured to perform foveated rendering (Foveated Rendering) in which, in generating an image, a region being gazed at is rendered with a high resolution and another region is rendered with a low resolution. Communication between the image generation device 10 and the head-mounted display 20 is performed with use of an interface such as HDMI (registered trademark) (High-Definition Multimedia Interface) or MIPI (registered trademark) (Mobile Industry Processor Interface) in this example. It is to be noted that, in this example, this communication is performed by wired communication; however, this communication is not limited thereto, and may be performed by wireless communication.

In the display system 1, the head-mounted display 20 displays an image on the basis of an image signal SP transmitted from the image generation device 10. An acceleration sensor 22 (to be described later) of the head-mounted display 20 detects a motion such as a direction of the head-mounted display 20. In addition, an eye-tracking sensor 23 of the head-mounted display 20 detects the direction of an eye of a user wearing the head-mounted display 20 to thereby detect which portion of a display image the user is looking at. The head-mounted display 20 supplies a detection signal SD including results of such detection to the image generation device 10. The image generation device 10 generates an image (an entire image P11) corresponding to the direction of the head-mounted display 20 on the basis of the result of detection by the acceleration sensor 22. In addition, the image generation device 10 generates an image (a peripheral image P12) outside the entire image P11. In addition, the image generation device 10 specifies an image (a partial image P2) including a portion at which the user is looking of the entire image P11 on the basis of the result of detection by the eye-tracking sensor 23. Thereafter, the image generation device 10 generates the image signal SP including pieces of image data that have a low resolution and represent the entire image P11 and the peripheral image P12, and a piece of image data that has a high resolution and represents the partial image P2, and transmits the generated image signal SP to the head-mounted display 20.

### (Image Generation Device 10)

The image generation device 10 is configured to generate an image to be displayed on the head-mounted display 20. The image generation device 10 includes an image generation circuit 11, a transmission circuit 12, and a reception circuit 13.

The image generation circuit 11 is configured to generate an image to be displayed on the head-mounted display 20, for example, by performing a predetermined processing such as a rendering processing. The image generation circuit 11 includes a transmission signal generation circuit 18. The transmission signal generation circuit 18 is configured to generate the image signal SP to be transmitted, on the basis of the image generated by the image generation circuit 11.

The image generation circuit 11 generates the entire image P11 representing a scenery corresponding to the direction of the head-mounted display 20 in a virtual space on the basis of the result of detection by the acceleration sensor 22 included in a piece of data supplied from the reception circuit 13. For example, an image range of the entire image P11 is the same as an image range of a display image of the head-mounted display 20. In addition, the image generation circuit 11 generates the peripheral image P12 that is an image outside the entire image P11. The entire image P11 and the peripheral image P12 configure an image P1. In addition, the image generation circuit 11 specifies the partial image P2 representing a portion at which the user is looking of the scenery corresponding to the direction of the head-mounted display 20 in the virtual space on the basis of the result of detection by the eye-tracking sensor 23 included in the piece of data supplied from the reception circuit 13. The partial image P2 is a portion of the entire image P11.

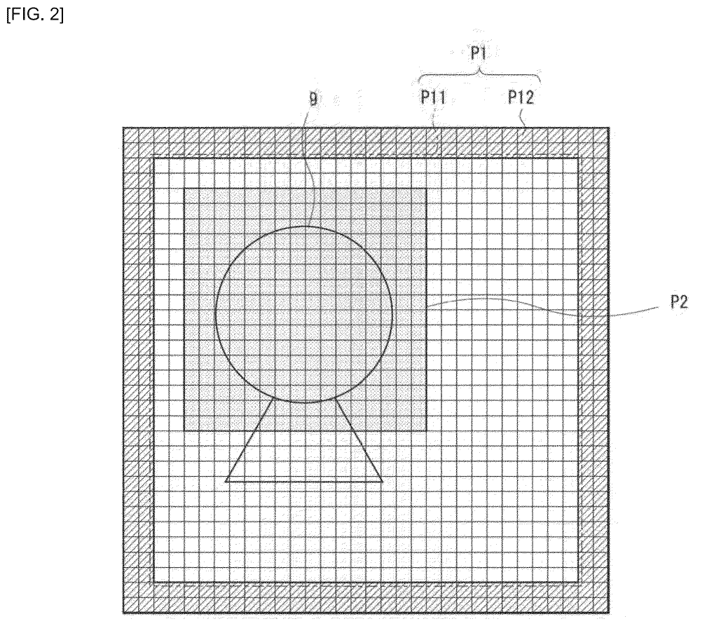

FIG. 2 illustrates an example of an image generated by the image generation circuit 11. In FIG. 2, squares indicate a plurality of pixels in the head-mounted display 20. In this example, for explanatory convenience, 32 pixels are provided side by side in a lateral direction, and 32 pixels are provided side by side in a longitudinal direction similarly. The entire image P11 includes 28 pixel values in the lateral direction, and 28 pixel values in the longitudinal direction. The peripheral image P12 in this example is an image having a width corresponding to two pixels in a ring-shaped image region outside the entire image P11. In this example, the entire image P11 includes an image of a person 9. The image generation circuit 11 specifies the partial image P2 including a portion at which the user is looking of the entire image P11, on the basis of the result of detection by the eye-tracking sensor 23 included in the piece of data supplied from the reception circuit 13. In this example, the partial image P2 includes an image of the face of the person 9. In this example, a size in a horizontal direction (a lateral direction in FIG. 2) of the partial image P2 is a half of a size in the horizontal direction of the image P1, and a size in a vertical direction (a longitudinal direction in FIG. 2) of the partial image P2 is a half of a size in the vertical direction of the image P1. In other words, an area of the partial image P2 is ¼ of an area of the image P1.

The head-mounted display 20 generates a display image on the basis of such an image generated by the image generation circuit 11. For example, in a case where the direction of the head-mounted display 20 does not change, the head-mounted display 20 generates a display image on the basis of the entire image P11 and the partial image P2. In addition, for example, in a case where the direction of the head-mounted display 20 changes, the head-mounted display 20 generates a display image on the basis of the entire image P11, the peripheral image P12, and the partial image P2. In other words, in the case where the direction of the head-mounted display 20 has changed, the head-mounted display 20 generates a display image in consideration of the peripheral image P12 that is an image outside the entire image P11.

The transmission signal generation circuit 18 generates the image signal SP to be transmitted, on the basis of such an image generated by the image generation circuit 11.

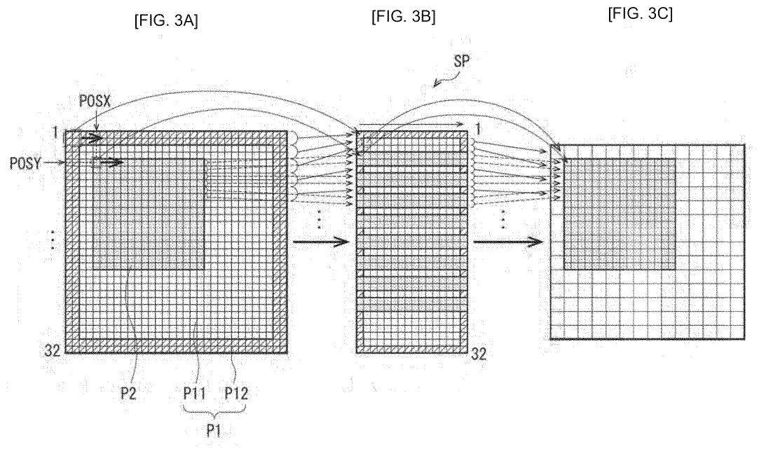

FIGS. 3A, 3B, and 3C illustrate an operation example of the display system 1, where FIG. 3A indicates an image generated by the image generation circuit 11, FIG. 3B indicates pieces of image data included in the image signal SP, and FIG. 3C indicates a display driving operation in the head-mounted display 20. In FIGS. 3A, 3B, and 3C, a portion shaded with diagonal lines indicates the peripheral image P12, and a portion shaded with dots indicates the partial image P2. In FIG. 3A, the position of an upper left pixel of the partial image P2 in the image P1 is the fifth from the left (POSX=5) and the fifth from the top (POSY=5) in this example.

As illustrated in FIGS. 3A and 3B, the transmission signal generation circuit 18 performs left-to-right scanning from top to bottom sequentially on the image P1 generated by the image generation circuit 11 to thereby generate the image signal SP. The transmission signal generation circuit 18 converts four pixel values disposed in two rows and two columns in the image P1 into one pixel value, and outputs one pixel value as it is in a portion overlapping the partial image P2 of the image P1, thereby generating pieces of image data in the image signal SP.

Specifically, in this example, the transmission signal generation circuit 18 converts four pixel values disposed in two rows and two columns into one pixel value on the basis of 64 pixel values included in a first row and a second row of the image P1 to thereby generate sixteen pixel values related to the peripheral image P12. Thus, the transmission signal generation circuit 18 generates a piece of image data in a first row in the image signal SP.

In addition, the transmission signal generation circuit 18 converts four pixel values disposed in two rows and two columns into one pixel value on the basis of 64 pixel values included in a third row and a fourth row of the image P1 to thereby generate one pixel value related to the peripheral image P12, fourteen pixel values related to the entire image P11, and one pixel value related to the peripheral image P12. Thus, the transmission signal generation circuit 18 generates a piece of image data in a second row in the image signal SP.

In addition, the transmission signal generation circuit 18 converts four pixel values disposed in two rows and two columns into one pixel value on the basis of 64 pixel values included in a fifth row and a sixth row of the image P1 to thereby generate one pixel value related to the peripheral image P12, fourteen pixel values related to the entire image P11, and one pixel value related to the peripheral image P12. Thus, the transmission signal generation circuit 18 generates a piece of image data in a third row in the image signal SP.

In addition, the transmission signal generation circuit 18 outputs sixteen pixel values related to the partial image P2 of 32 pixel values included in the fifth row of the image P1 as they are, and outputs sixteen pixel values related to the partial image P2 of 32 pixel values included in the sixth row of the image P1 as they are. Thus, the transmission signal generation circuit 18 generates pieces of image data in fourth and fifth rows in the image signal SP.

As described above, the transmission signal generation circuit 18 converts four pixel values disposed in two rows and two columns in the image P1 into one pixel value, and outputs pixel values as they are in the portion overlapping the partial image P2 of the image P1. Accordingly, the transmission signal generation circuit 18 converts the image P1 into the image P1 having a lower resolution. Meanwhile, the resolution of the partial image P2 is not changed. As a result, the resolution of the converted image P1 becomes lower than the resolution of the partial image P2. The transmission signal generation circuit 18 converts four pixel values disposed in two rows and two columns in an entire image of the image P1 into one pixel value; therefore, the converted image P1 includes an image corresponding to the partial image P2. In addition, in the example in FIGS. 3A, 3B, and 3C, the transmission signal generation circuit 18 performs a processing sequentially from top to bottom to thereby generate the image signal SP; therefore, as illustrated in FIG. 3B, for example, in the image signal SP, a portion is generated in which pixel values in one line image included in the image P1 and pixel values in two line images included in the partial image P2 are alternately disposed in the longitudinal direction.

Thus, the transmission signal generation circuit 18 generates pieces of image data including a plurality of pixel values as illustrated in FIG. 3B, on the basis of the image generated by the image generation circuit 11. Thereafter, the transmission signal generation circuit 18 generates the image signal SP including the pieces of image data and a piece of image position data representing the position (parameters POSX and POSY) of the partial image P2 in the image P1.

The transmission circuit 12 (FIG. 1) is configured to transmit the image signal SP supplied from the image generation circuit 11 to the head-mounted display 20. The transmission circuit 12 is configured to transmit the piece of image position data with use of a data format of the piece of image data, for example, in a blanking period in which the piece of image data is not transmitted of a vertical period V. In addition, the transmission circuit 12 may transmit the piece of image position data as a piece of control data, for example, in the blanking period. In addition, the transmission circuit 12 may transmit the piece of image position data with use of a general interface such as an 12C or a SPI (Serial Peripheral Interface) different from an interface for transmitting the piece of image data.

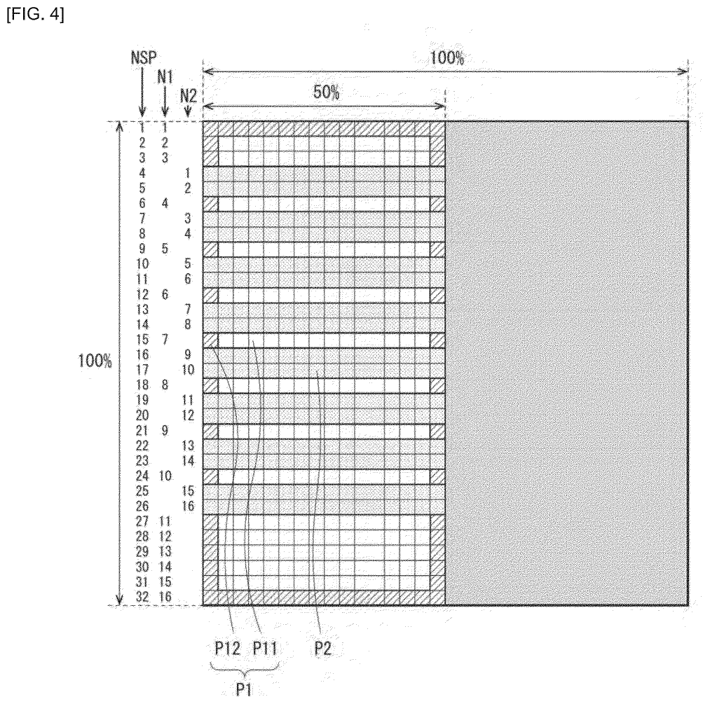

FIG. 4 illustrates a transmission band in the display system 1. In FIG. 4, an unshaded portion indicates to the entire image P11, a portion shaded with diagonal lines indicates the peripheral image P12, and a portion shaped with dots indicates the partial image P2. The pieces of image data included in the image signal SP in this example include pieces of image data for 32 rows. For explanatory convenience, each of the pieces of image data for 32 rows is attached with a data number NSP. A piece of image data in each row includes a piece of image data related to the image P1 (the entire image P11 and the peripheral image P12), and a piece of image data related to the partial image P2. For explanatory convenience, each of pieces of image data for sixteen rows related to the image P1 is attached with a data number N1, and each of pieces of image data for sixteen rows related to the partial image P2 is attached with a data number N2.

The number of pixel values in the pieces of image data included in the image signal SP is a half of the number of pixel values included in the image P1 before conversion. Thus, it is possible for the display system 1 to reduce an image data amount to a half, as compared with a case where the image P1 before conversion is transmitted as it is.

The reception circuit 13 (FIG. 1) is configured to receive a detection signal SD transmitted from the head-mounted display 20. The reception circuit 13 then supplies, to the image generation circuit 11, a piece of data about the result of detection by the acceleration sensor 22 and the result of detection by the eye-tracking sensor 23. The piece of data is included in this detection signal SD.

### (Head-Mounted Display 20)

The head-mounted display 20 includes a reception circuit 21, the acceleration sensor 22, the eye-tracking sensor 23, a processor 24, a transmission circuit 25, a display controller 26, and a display panel 27.

The reception circuit 21 is configured to receive the image signal SP transmitted from the image generation device 10. The reception circuit 21 then supplies, to the processor 24, the pieces of image data and the piece of image position data included in the image signal SP.

The acceleration sensor 22 is configured to detect a motion such as the direction of the head-mounted display 20. It is possible for the acceleration sensor 22 to use, for example, a 6-axis inertial sensor. Accordingly, in the display system 1, it is possible to generate the image P1 corresponding to the direction of the head-mounted display 20 in the virtual space.

The eye-tracking sensor 23 is configured to detect the direction of the eye of the user wearing the head-mounted display 20. Accordingly, in the display system 1, it is possible to detect which portion of the display image the user is looking at, and it is possible to specify the partial image P2 including the portion at which the user is looking of the entire image P11.

The processor 24 is configured to control an operation of the head-mounted display 20, and includes, for example, a CPU (Central Processing Unit), a GPU (Graphics Processing Unit), and the like. The processor 24 performs, for example, a predetermined image processing on the basis of the pieces of image data supplied from the reception circuit 21, and supplies, to the display controller 26, the pieces of image data having been subjected to the image processing together with the piece of image position data, the result of detection by the acceleration sensor 22, and the result of detection by the eye-tracking sensor 23. In addition, the processor 24 supplies the result of detection by the acceleration sensor 22 and the result of detection by the eye-tracking sensor 23 to the transmission circuit 25, and causes the transmission circuit 25 to transmit these results of detection.

The transmission circuit 25 is configured to transmit, to the image generation device 10, the detection signal SD including the result of detection by the acceleration sensor 22 and the result of detection by the eye-tracking sensor 23 supplied from the processor 24.

The display controller 26 is configured to control an operation of the display panel 27 on the basis of the pieces of image data and the piece of image position data supplied from the processor 24. The display controller 26 includes a predictive processing circuit 29.

The predictive processing circuit 29 is configured to generate a piece of display image data by performing a geometric deformation processing on the pieces of image data supplied from the processor 24 on the basis of the result of detection by the acceleration sensor 22 and the result of detection by the eye-tracking sensor 23. In other words, in the display system 1, the head-mounted display 20 supplies, to the image generation device 10, the result of detection by the acceleration sensor 22 and the result of detection by the eye-tracking sensor 23, and the image generation device 10 generates the image P1 and the partial image P2 on the basis of these results of detection, and supplies the generated images to the head-mounted display 20. However, in this case, in the display system 1, it may take time from when the user changes the direction of the head-mounded display 20 to when the head-mounted display 20 displays an image corresponding to the direction of the head-mounted display 20. Accordingly, the predictive processing circuit 29 of the head-mounted display 20 performs the geometric deformation processing on the pieces of image data supplied from the processor 24 on the basis of the result of detection by the acceleration sensor 22 and the result of detection by the eye-tracking sensor 23. In other words, before the image generation device 10 generates the images, the predictive processing circuit 29 generates an image on the basis of the latest result of detection by the acceleration sensor 22 and the latest result of detection by the eye-tracking sensor 23. Such a predictive processing makes it possible for the display system 1 to immediately display an image corresponding to the direction of the head-mounted display 20, and makes it possible to reduce a latency.

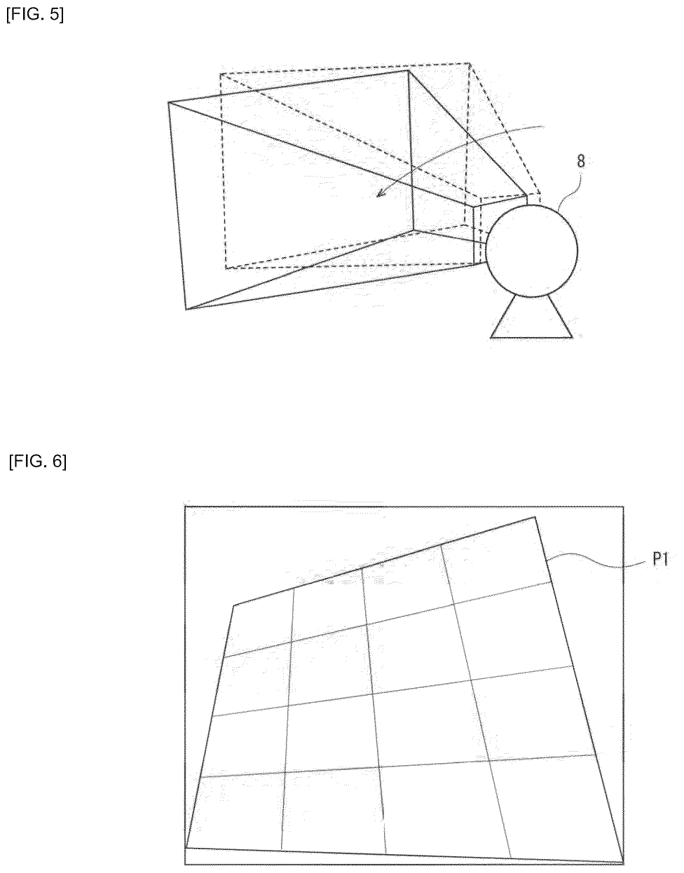

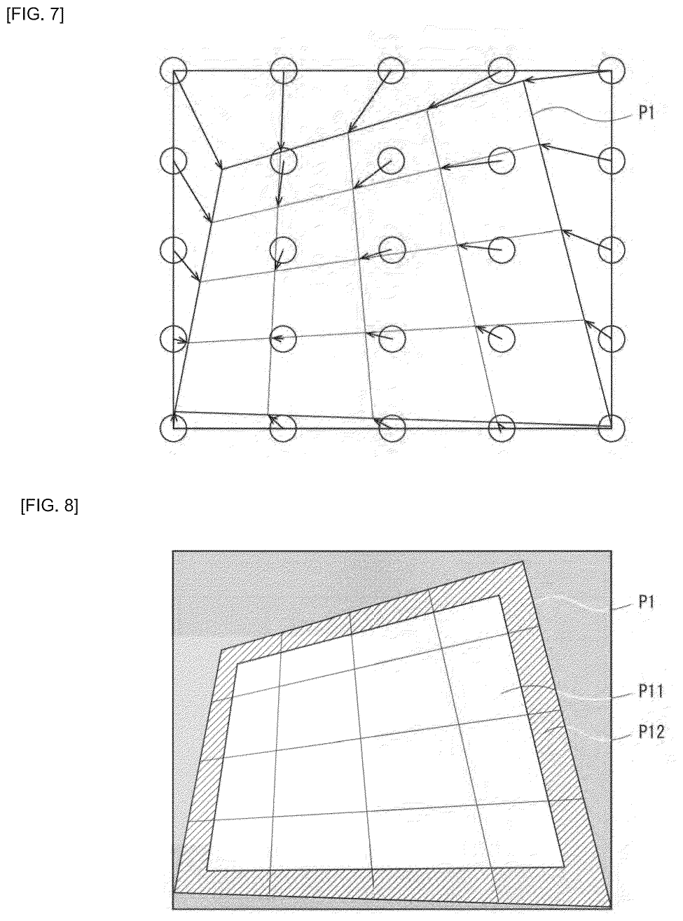

FIG. 5 illustrates a change in direction of the head-mounted display 20. FIGS. 6 and 7 each illustrate an example of an image processing in the predictive processing circuit 29. In an example in FIG. 5, a user 8 wearing the head-mounted display 20 turns his head slightly to the lower left. The acceleration sensor 22 detects a change in direction of the head-mounted display 20. As illustrated in FIG. 6 or 7, the predictive processing circuit 29 performs the geometric deformation processing on the pieces of image data supplied from the processor 24 on the basis of the result of detection by the acceleration sensor 22. The geometric deformation processing may be, for example, a projective geometric deformation processing as illustrated in FIG. 6, or a geometric deformation processing using a vector as illustrated in FIG. 7. In this example, the predictive processing circuit 29 performs the geometric deformation processing in accordance with changing the direction of the head-mounted display 20 slightly to the lower left so as to cause a left side of the image P1 to appear slightly farther than a right side of the image P1.

In a case where the predictive processing circuit 29 performs the geometric deformation processing on the image P1 in such a manner, the predictive processing circuit 29 performs the geometric deformation processing also on the partial image P2 included in the image P1. In a case where the eye-tracking sensor 23 detects a change in direction of the eye of the user 8, the predictive processing circuit 29 performs the geometric deformation processing while changing the position of the partial image P2 in the image P1 and performing a super-resolution processing for increasing a resolution, on the basis of the result of detection by the eye-tracking sensor 23.

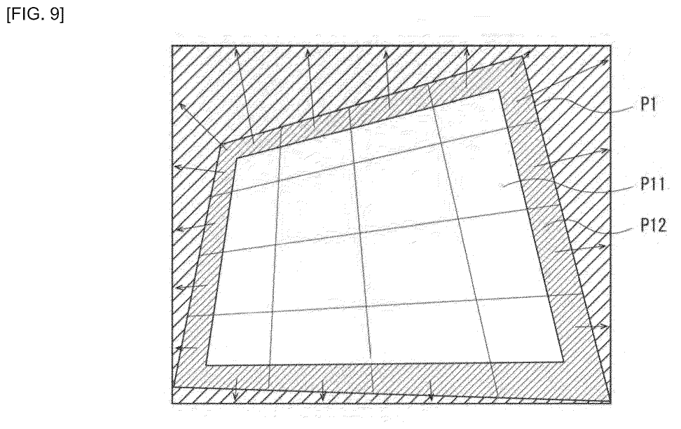

As illustrated in FIG. 6 or 7, in a case where the image P1 becomes small by the geometric deformation processing, for example, as illustrated in FIG. 8, the predictive processing circuit 29 is configured to set a pixel value outside the image P1 to a black pixel value. It is to be noted that this is not limitative, and, for example, as illustrated in FIG. 9, the predictive processing circuit 29 may set the pixel value outside the image P1 by performing an image processing for extending an image on the basis of images of the peripheral image P12 and the entire image P11 included in the image P1.

In such a manner, the predictive processing circuit 29 generates the piece of display image data by performing the geometric deformation processing on the pieces of image data supplied from the processor 24 on the basis of the result of detection by the acceleration sensor 22 and the result of detection by the eye-tracking sensor 23. The display controller 26 controls the operation of the display panel 27 on the basis of the piece of display image data.

The display panel 27 (FIG. 1) is configured to display an image on the basis of control by the display controller 26. The display panel 27 displays an image having the same image range as the image range of the entire image P11. The display panel 27 in this example is an organic EL (Electro Luminescence) display panel. It is to be noted that the display panel 27 is not limited thereto, and may be, for example, a liquid crystal display panel.

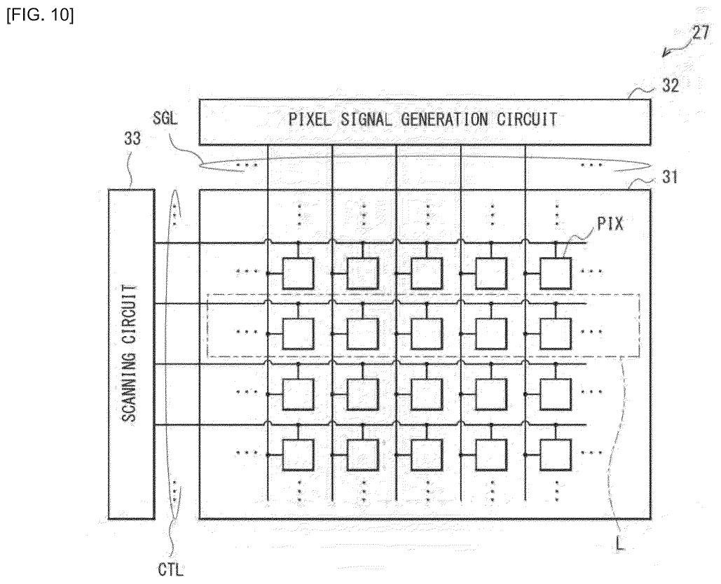

FIG. 10 illustrates a configuration example of the display panel 27. The display panel 27 includes a pixel array 31, a pixel signal generation circuit 32, and a scanning circuit 33.

The pixel array 31 includes a plurality of signal lines SGL, a plurality of control lines CTL, and a plurality of pixels PIX.

The plurality of signal lines SGL extends in the vertical direction (the longitudinal direction in FIG. 10) and is provided side by side in the horizontal direction (the lateral direction in FIG. 10). The plurality of signal lines SGL each supplies a pixel signal generated by the pixel signal generation circuit 32 to the pixels PIX.

The plurality of control lines CTL extends in the horizontal direction (the lateral direction in FIG. 10), and is provided side by side in the vertical direction (the longitudinal direction in FIG. 10). The plurality of control lines CTL each supplies a control signal generated by the scanning circuit 33 to the pixels PIX.

The plurality of pixels PIX is arranged in a matrix in the pixel array 31. Each of the plurality of pixels PIX is controlled on the basis of the control signal supplied through the control line CTL, and the pixel signal supplied through the signal line SGL is written to each of the plurality of the pixels PIX. Accordingly, each of the plurality of pixels PIX is configured to emit light with luminance corresponding to the written pixel signal. The pixels PIX for one row provided side by side in the horizontal direction configure a pixel line L.

The pixel signal generation circuit 32 is configured to generate the pixel signal on the basis of a piece of image data to be displayed, and apply the generated pixel signal to each of the plurality of signal lines SGL.

The scanning circuit 33 scans the plurality of pixels PIX in units of one or a plurality of pixel lines L as scanning units by generating the control signal and applying the generated control signal to each of the plurality of control lines CTL.

Herein, the reception circuit 21 corresponds to a specific example of a “reception circuit” in the present disclosure. The converted entire image P11 corresponds to a specific example of an “entire image” in the present disclosure. The converted peripheral image P12 corresponds to a specific example of a “peripheral image” in the present disclosure. The partial image P2 corresponds to a specific example of a “first partial image” in the present disclosure. The pixel array 31 corresponds to a specific example of a “display section” in the present disclosure. The acceleration sensor 22 corresponds to a specific example of a “first sensor” in the present disclosure. The eye-tracking sensor 23 corresponds to a specific example of a “second sensor” in the present disclosure. The display controller 26 corresponds to a specific example of an “image processing circuit” in the present disclosure. The pixel signal generation circuit 32 and the scanning circuit 33 correspond to specific examples of a “display drive circuit” in the present disclosure. The transmission circuit 25 corresponds to a specific example of a “transmission circuit” int the present disclosure.

### [Operation and Workings]

Next, description is given of an operation and workings of the display system 1 according to the present embodiment.

### (Overview of Entire Operation)

First, description is given of an overview of an entire operation of the display system 1 with reference to FIG. 1. The reception circuit 13 of the image generation device 10 receives the detection signal SD transmitted from the head-mounted display 20, and supplies, to the image generation circuit 11, the piece of data about the result of detection by the acceleration sensor 22 and the result of detection by the eye-tracking sensor 23. The piece of data is included in this detection signal SD. The image generation circuit 11 generates the entire image P11 representing the scenery corresponding to the direction of the head-mounted display 20 in the virtual space on the basis of the result of detection by the acceleration sensor 22 included in the piece of data supplied from the reception circuit 13. In addition, the image generation circuit 11 generates the peripheral image P12 that is an image outside the entire image P11. The entire image P11 and the peripheral image P12 configure the image P1. In addition, the image generation circuit 11 specifies the partial image P2 including a portion at which the user is looking of the entire image P11 on the basis of the result of detection by the eye-tracking sensor 23 included in the piece of data supplied from the reception circuit 13. The transmission signal generation circuit 18 generates the image signal SP to be transmitted, on the basis of the image generated by the image generation circuit 11. The image signal SP includes the pieces of image data, and the piece of image position data representing the position of the partial image P2 in the image P1. The transmission circuit 12 transmits the image signal SP to the head-mounted display 20.

The reception circuit 21 of the head-mounted display 20 receives the image signal SP transmitted from the image generation device 10, and supplies, to the processor 24, the pieces of image data and the piece of image position data included in the image signal SP. The acceleration sensor 22 detects a motion such as the direction of the head-mounted display 20. The eye-tracking sensor 23 detects the direction of the eye of the user wearing the head-mounted display 20. The processor 24 supplies the result of detection by the acceleration sensor 22 and the result of detection by the eye-tracking sensor 23 to the transmission circuit 25. The transmission circuit 25 transmits, to the image generation device 10, the detection signal SD including the result of detection by the acceleration sensor 22 and the result of detection by the eye-tracking sensor 23 supplied from the processor 24.

In addition, the processor 24 performs a predetermined image processing on the basis of the pieces of image data supplied from the reception circuit 21, and supplies, to the display controller 26, the pieces of image data having been subjected to the image processing together with the piece of image position data, the result of detection by the acceleration sensor 22, and the result of detection by the eye-tracking sensor 23. The predictive processing circuit 29 of the display controller 26 generates the piece of display image data by performing the geometric deformation processing on the pieces of image data supplied from the processor 24 on the basis of the result of the detection by the acceleration sensor 22 and the result of detection by the eye-tracking sensor 23. The display controller 26 controls the operation of the display panel 27 on the basis of the piece of image position data supplied from the processor 24 and the piece of display image data generated by the predictive processing circuit 29. The display panel 27 displays an image on the basis of control by the display controller 26.

### (Detailed Operation)

In the image generation device 10, the image generation circuit 11 generates the entire image P11 representing the scenery corresponding to the direction of the head-mounted display 20 in the virtual space on the basis of the result of detection by the acceleration sensor 22 included in the piece of data supplied from the reception circuit 13. In addition, the image generation circuit 11 generates the peripheral mage P12 that is an image outside the entire image P11. In addition, the image generation circuit 11 specifies the partial image P2 including the portion at which the user is looking of the entire image P11 on the basis of the result of detection by the eye-tracking sensor 23 included in the piece of data supplied from the reception circuit 13.

The transmission signal generation circuit 18 generates the image signal SP to be transmitted, on the basis of the image generated by the image generation circuit 11. Specifically, the transmission signal generation circuit 18 converts four pixel values disposed in two rows and two columns in the image P1 (the entire image P11 and the peripheral image P12) into one pixel value. In addition, the transmission signal generation circuit 18 outputs a pixel value as it is in a portion overlapping the partial image P2 of the image P1. Thus, the transmission signal generation circuit 18 generates pieces of image data including a plurality of pixel values as illustrated in FIG. 3B on the basis of the image generated by the image generation circuit 11. The transmission signal generation circuit 18 then generates the image signal SP including the pieces of image data and the piece of image position data representing the position (parameters POSX and POSY) of the partial image P2 in the image P1.

Thereafter, the transmission circuit 12 transmits the image signal SP supplied from the image generation circuit 11 to the head-mounted display 20.

In the head-mounted display 20, the reception circuit 21 receives the image signal SP transmitted from the image generation device 10, and supplies, to the processor 24, the pieces of image data and the piece of image position data included in the image signal SP. The processor 24 performs a predetermined image processing on the basis of the pieces of image data supplied from the reception circuit 21, and supplies, to the display controller 26, the pieces of image data having been subjected to the image processing together with the piece of image position data, the result of detection by the acceleration sensor 22, and the result of detection by the eye-tracking sensor 23.

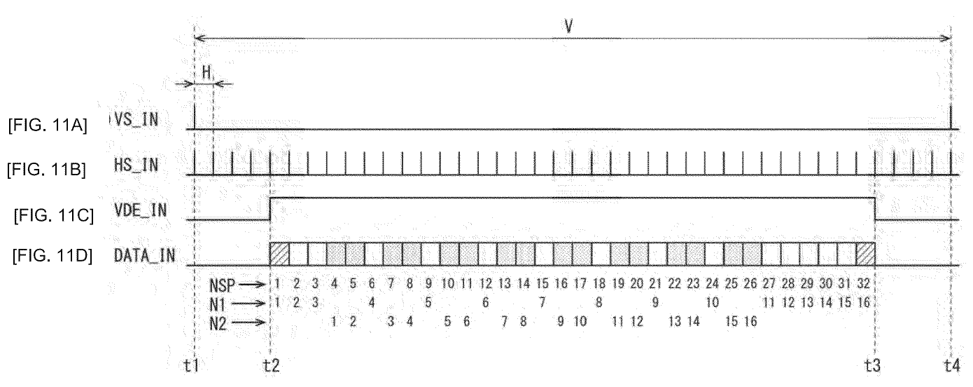

FIGS. 11A, 11B, 11C, and 11D illustrate an example of signals to be inputted to the display controller 26, where FIG. 11A indicates a waveform of a vertical synchronization signal VS_IN, FIG. 11B indicates a waveform of a horizontal synchronization signal HS_IN, FIG. 11C indicates a waveform of a vertical data enable signal VDE_IN, and FIG. 11D indicates a data signal DATA_IN.

At a timing t1, a pulse of the vertical synchronization signal VS_IN is generated, and the vertical period V starts (FIG. 11A). In addition, a pulse of the horizontal synchronization signal HS_IN is generated every time the horizontal period H starts (FIG. 11B).

Thereafter, at a timing t2, the vertical data enable signal VDE_IN changes from a low level to a high level (FIG. 11C). The data signal DATA_IN in a period in which the vertical data enable signal VDE_IN is in the high level represents a piece of image data (FIG. 11D). In this example, the data signal DATA_IN is supplied over 32 horizontal periods H. The data signal DATA_IN includes 32 pieces of image data corresponding to 32 horizontal periods H. The 32 pieces of image data each correspond to a corresponding one of pieces of image data (with the data number NSP=1 to 32) for 32 rows included in the image signal SP illustrated in FIG. 4. FIGS. 11A, 11B, 11C, and 11D also illustrate the data numbers N1 and N2 in addition to the data number NSP.

FIG. 12 illustrates an example of the data signal DATA_IN. For example, the piece of image data in the first row included in the image signal SP corresponds to a first piece of image data of the 32 pieces of image data included in the data signal DATA_IN. This piece of image data includes sixteen pixel values related to the peripheral image P12. In addition, the piece of image data in the second row included in the image signal SP corresponds to a second piece of image data of the 32 pieces of image data included in the data signal DATA_IN. This piece of image data includes one pixel value related to the peripheral image P12, fourteen pixel values related to the entire image P11, and one pixel value related to the peripheral image P12. In addition, for example, the piece of image data in the fourth row included in the image signal SP corresponds to a fourth piece of image data of the 32 pieces of image data included in the data signal DATA_IN. This piece of image data includes sixteen pixel values related to the partial image P2.

Thereafter, at a timing t3, the vertical data enable signal VDE_IN changes from the high level to the low level (FIG. 11C). Thereafter, at a timing t4, this vertical period V ends, and the next vertical period V starts.

The predictive processing circuit 29 of the display controller 26 generates a piece of display image data by performing the geometric deformation processing on the pieces of image data supplied from the processor 24 on the basis of the result of detection by the acceleration sensor 22 and the result of detection by the eye-tracking sensor 23. Thereafter, the display controller 26 generates a vertical synchronization signal VS_OUT, a horizontal synchronization signal HS_OUT, a vertical data enable signal VDE_OUT, and a data signal DATA_OUT on the basis of the piece of display image data.

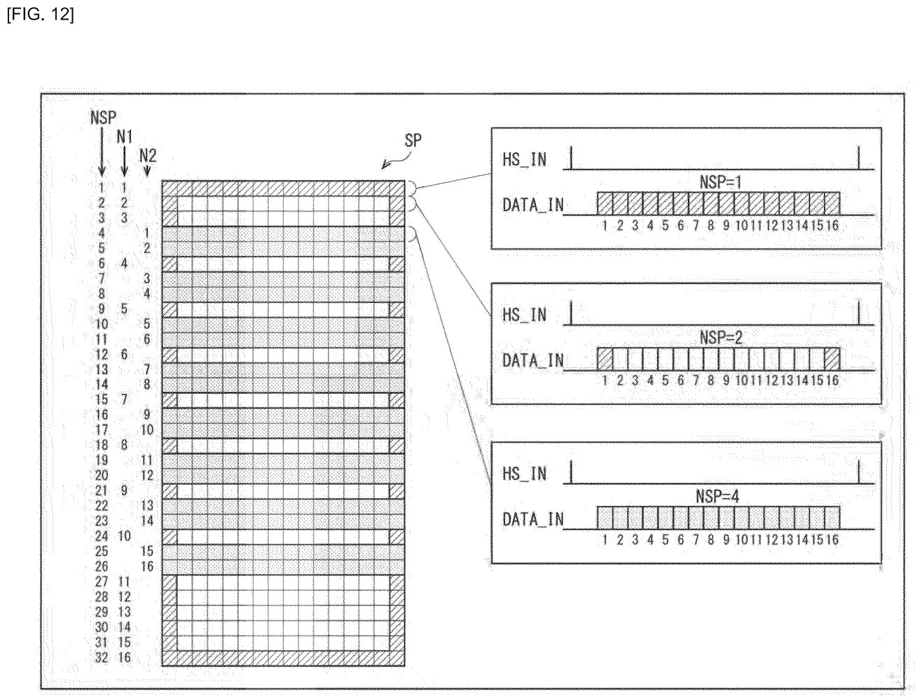

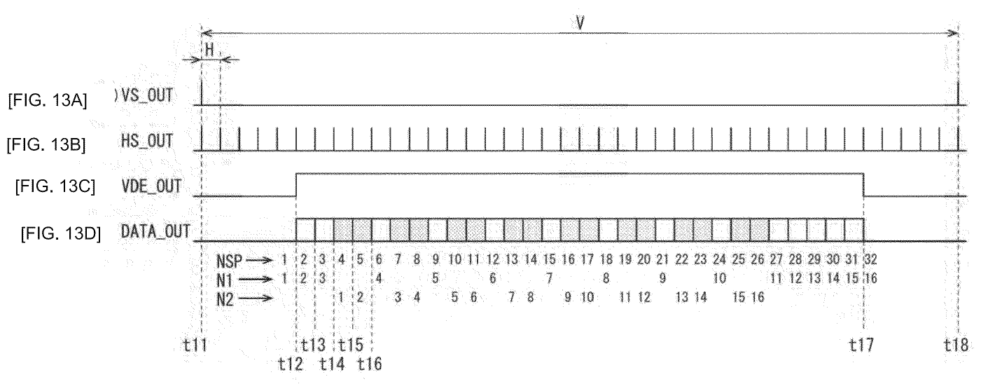

FIGS. 13A, 13B, 13C, and 13D illustrate an example of signals to be outputted from the display controller 26 in a case where the direction of the head-mounted display 20 does not change and the direction of the eye of the user does not change, where FIG. 13A indicates a waveform of the vertical synchronization signal VS_OUT, FIG. 13B indicates a waveform of the horizontal synchronization signal HS_OUT, FIG. 13C indicates a waveform of the vertical data enable signal VDE_OUT, and FIG. 13D indicates the data signal DATA_OUT. In FIG. 13D, an unshaded portion indicates the entire image P11, and a portion shaded with dots indicates the partial image P2. In other words, in this example, the direction of the head-mounted display 20 does not change, and the direction of the eye of the user does not change; therefore, the predictive processing circuit 29 does not perform the geometric deformation processing as illustrated in FIG. 6 or 7. Accordingly, the data signal DATA_OUT includes the pieces of image data related to the entire image P11 and the partial image P2, and does not include pieces of image data related to the peripheral image P12.

As with a case in FIGS. 11A, 11B, 11C, and 11D, at a timing t11, a pulse of the vertical synchronization signal VS_OUT is generated, and the vertical period V starts (FIG. 13A). In addition, a pulse of the horizontal synchronization signal HS_OUT is generated every time the horizontal period H starts (FIG. 13B).

Thereafter, at a timing t12, the vertical data enable signal VDE_OUT changes from the low level to the high level (FIG. 13C). In this example, the display controller 26 outputs thirty pieces of image data as the data signal DATA_OUT over thirty horizontal periods H (FIG. 13D). In a case where the direction of the head-mounted display 20 does not change and the direction of the eye of the user does not change as with this example, the display controller 26 outputs the pieces of image data related to the entire image P11 and the pieces of image data related to the partial image P2 as the data signal DATA_OUT. The thirty pieces of image data included in the data signal DATA_OUT each correspond to a corresponding one of thirty pieces from second to 31st pieces of image data included in the data signal DATA_IN (FIGS. 11A, 11B, 11C, and 11D). In other words, the thirty pieces of image data included in the data signal DATA_OUT each correspond to a corresponding one of pieces of image data in second to 31st rows included in the image signal SP illustrated in FIGS. 3B and 4. In FIGS. 13A, 13B, 13C, and 13D, for explanatory convenience, pieces of image data are attached with the data numbers NSP, N1, and N2. It is to be noted that, for example, in a case where the direction of the head-mounted display 20 has changed, the predictive processing circuit 29 performs the geometric deformation processing as illustrated in FIG. 6 or 7; therefore, thirty pieces of image data included in the data signal DATA_OUT do not necessarily correspond to the second to 31st pieces of image data included in the data signal DATA_IN (FIGS. 11A, 11B, 11C, and 11D).

The display controller 26 performs control to drive the plurality of pixels PIX in the display panel 27 in units of four pixels PIX disposed in two rows and two columns on the basis of the pieces of image data related to the entire image P11 included in the data signal DATA_OUT. In addition, the display controller 26 performs control to drive the plurality of pixels PIX in the display panel 27 in units of one pixel PIX on the basis of the pieces of data related to the partial image P2 included in the data signal DATA_OUT.

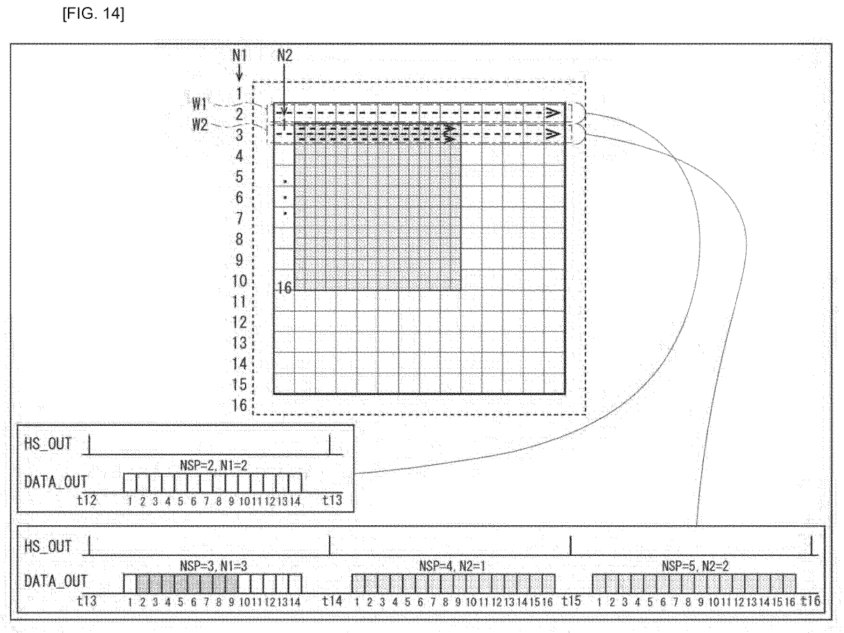

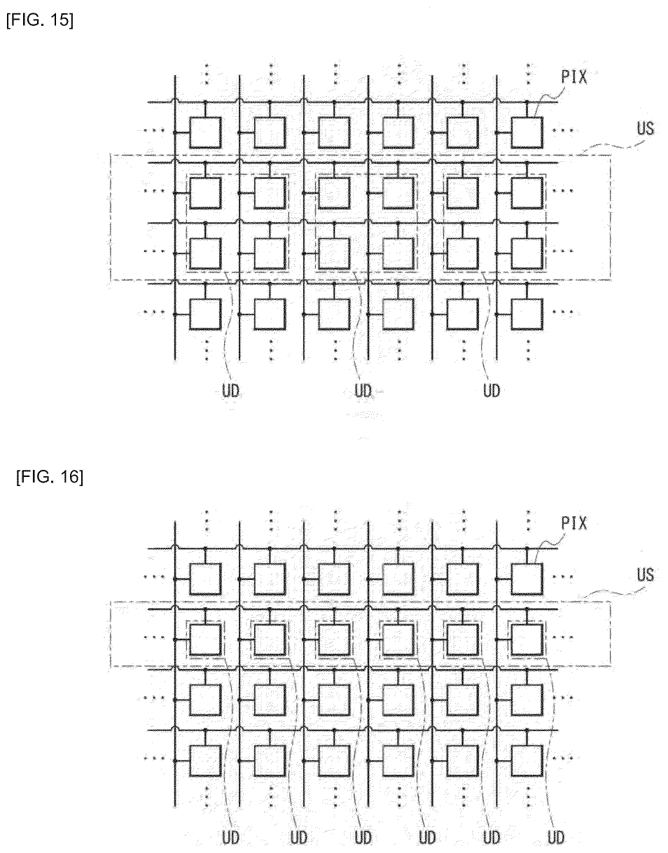

FIG. 14 illustrates an example of the data signal DATA_OUT from a timing t12 to a timing t16 in FIGS. 13A, 13B, 13C, and 13D and a display driving operation based on the data signal DATA_OUT. FIGS. 15 and 16 each illustrate an example of an operation of the display panel 27.

The display panel 27 performs a display driving operation on two pixel lines L indicated by a sign W1 in FIG. 14 in a period from the timing t12 to a timing t13.

In this period from the timing t12 to the timing t13, as illustrated in FIG. 14, the display controller 26 outputs, as the data signal DATA_OUT, a piece of image data including fourteen pixel values related to the entire image P11. The data number NSP of this piece of image data is “2”, and the data number N1 thereof is “2”. In other words, as illustrated in FIG. 12, the piece of image data with the data number NSP of “2” included in the image signal SP includes one pixel value related to the peripheral image P12, fourteen pixel values related to the entire image P11, and one pixel value related to the peripheral image P12; therefore, the display controller 26 outputs, as the data signal DATA_OUT, the piece of image data including fourteen pixel values corresponding to the fourteen pixel values related to the entire image P11 of these pixel values. The display controller 26 performs control to drive two pixel lines L corresponding to the data number N1=2 in units of four pixels PIX on the basis of this piece of image data, as illustrated in FIG. 15.

In this case, as illustrated in FIG. 15, the scanning circuit 33 scans the plurality of pixels PIX in scanning units US of two pixel lines L. In addition, the pixel signal generation circuit 32 applies the same pixel signal to two signal lines SGL adjacent to each other. Accordingly, the same pixel signal is written to four pixels PIX in selected two pixel lines L. Thus, the display panel 27 drives the plurality of pixels PIX in units UD of four pixels PIX.

Thus, the pixel signal generation circuit 32 writes a pixel signal related to the entire image P1 to two pixel lines L indicated by the sign W1 in FIG. 14.

Next, the display panel 27 performs the display driving operation on two pixel lines L indicated by a sign W2 in FIG. 14 in a period from the timing t13 to a timing t14.

First, in a period from the timing t13 to the timing t14, as illustrated in FIG. 14, the display controller 26 outputs, as the data signal DATA_OUT, a piece of image data including fourteen pixel values related to the entire image P11. The data number NSP of this piece of image data is “3”, and the data number N1 thereof is “3”. In other words, as illustrated in FIG. 12, the piece of image data with the data number NSP of “3” included in the image signal SP incudes one pixel values related to the peripheral image P12, fourteen pixel values related to the entire image P11, and one pixel value related to the peripheral image P12; therefore, the display controller 26 outputs, as the data signal DATA_OUT, the piece of image data including fourteen pixel values corresponding to the fourteen pixel values related to the entire image P11 of these pixel values. The display controller 26 performs control to drive two pixel lines L corresponding to the data number N1=3 in units of four pixels PIX on the basis of this piece of image data, as illustrated in FIG. 15.

In this example, as illustrated in FIG. 14, the display controller 26 sets second to ninth pixel values of the fourteen pixel values to a pixel value representing black. The display panel 27 performs control not to write the pixel signal to the pixels PIX corresponding to the second to ninth pixel values. It is to be noted that this is not limitative, and the display controller 26 may write the pixel signal to the pixels PIX corresponding to the second to ninth pixel values on the basis of a pixel value having a value of 0. In addition, in this example, the display controller 26 sets the second to ninth pixel values of the fourteen pixel values to the pixel value representing black, but this is not limitative. The second to ninth pixel values may not be set to the pixel value representing black and may be maintained at their original pixel values.

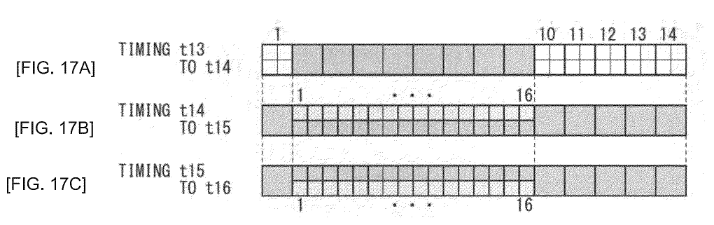

FIGS. 17A, 17B, and 17C illustrate an example of the display driving operation on two pixel lines L indicated by the sign W2 in FIG. 14, where FIG. 17A indicates an operation from the timing t13 to the timing t14, FIG. 17B indicates an operation from the timing t14 to a timing t15, and FIG. 17C indicates an operation from the timing t15 to the timing t16. As illustrated in FIG. 17A, from the timing t13 to the timing t14, the pixel signal generation circuit 32 writes the pixel signals corresponding to first, and tenth to fourteenth pixel values to the pixels PIX corresponding to these pixel values. In addition, the pixel signal generation circuit 32 does not write the pixel value to the pixels PIX other than these pixels PIX.

In the next period from the timing t14 to the timing t15, as illustrated in FIG. 14, the display controller 26 outputs, as the data signal DATA_OUT, a piece of image data including sixteen pixel values related to the partial image P2. The data number NSP of this piece of image data is “4”, and the data number N2 thereof is “1”. The display controller 26 knows that this piece of image data includes the pixel values related to the partial image P2, on the basis of the piece of image position data. Thereafter, the display controller 26 performs control to drive one pixel line L corresponding to the data number N2=1 in units of one pixel PIX on the basis of this piece of image data, as illustrated in FIG. 16.

In this case, as illustrated in FIG. 16, the scanning circuit 33 scans the plurality of pixels PIX in scanning units US of one pixel line L. In addition, the pixel signal generation circuit 32 applies each of a plurality of pixel signals to a corresponding one of the plurality of signal lines SGL. Accordingly, one pixel signal is written to one pixel PIX in selected one pixel line. Thus, the display panel 27 drives the plurality of pixel PIX in units UD of one pixel PIX.

As illustrated in FIG. 17B, from the timing t14 to the timing t15, the pixel signal generation circuit 32 writes the pixel signals corresponding to sixteen pixel values to the pixels PIX corresponding to these pixel values. In addition, the pixel signal generation circuit 32 does not write the pixel value to the pixels PIX other than these pixels PIX.

In the next period from the timing t15 to the timing t16, as illustrated in FIG. 14, the display controller 26 outputs, as the data signal DATA_OUT, a piece of image data including sixteen pixel values related to the partial image P2. The data number NSP of this piece of image data is “5”, and the data number N2 thereof is “2”. The display controller 26 knows that this piece of image data includes the pixel values related to the partial image P2, on the basis of the piece of image position data. Thereafter, the display controller 26 performs control to drive one pixel line L corresponding to the data number N2=2 in units of one pixel PIX on the basis of this piece of image data, as illustrated in FIG. 16.

As illustrated in FIG. 17C, from the timing t15 to the timing t16, the pixel signal generation circuit 32 writes the pixel signals corresponding to sixteen pixel values to the pixels PIX corresponding to these pixel values. In addition, the pixel signal generation circuit 32 does not write the pixel value to the pixels PIX other than these pixels PIX.

Thus, as illustrated in FIGS. 17A, 17B, and 17C, the pixel signal generation circuit 32 writes the pixel signals related to the entire image P11 or the pixel signals related to the partial image P2 to all the pixels PIX in two pixel lines L indicated by the sign W2 in FIG. 14 in the period from the timing t13 to the timing t16.

As illustrated in FIGS. 13A, 13B, 13C, and 13D, also after this, the display controller 26 and the display panel 27 operate similarly. Thereafter, at a timing t17, the vertical data enable signal VDE_OUT changes from the high level to the low level (FIG. 13C). Thereafter, at a timing t18, this vertical period V ends, and the next vertical period V starts.

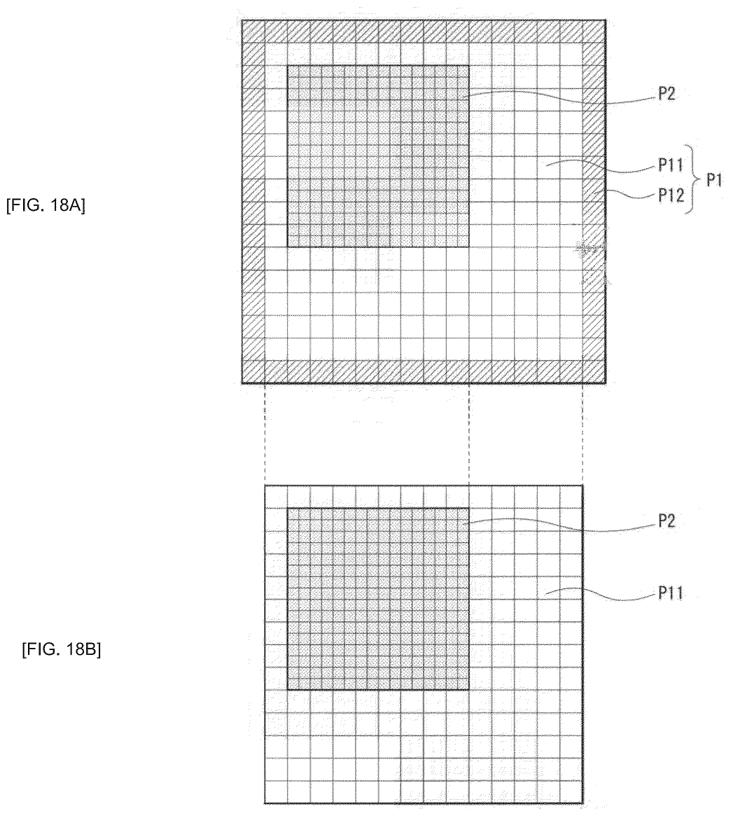

FIGS. 18A, 18B, 19A, 19B, 20A, and 20B schematically illustrate an operation of the display controller 26. In FIGS. 18A, 18B, 19A, 19B, 20A, and 20B, FIGS. 18A, 19A, and 20A indicates pieces of image data supplied to the display controller 26, and FIGS. 18B, 19B, and 20B indicates a piece of display image data to be outputted by the display controller 26.

In FIGS. 13A, 13B, 13C, 13D, and 14, a case where the direction of the head-mounted display 20 does not change and the direction of the eye of the user does not change has been described as an example. In this case, as illustrated in FIGS. 18A and 18B, the piece of display image data generated by the display controller 26 includes the pieces of image data related to the entire image P11 and the pieces of image data related to the partial image P2. In other words, the piece of display image data does not include the pieces of image data related to the peripheral image P12. The display controller 26 drives the plurality of pixels PIX in units of one pixel PIX on the basis of the pieces of image data related to the partial image P2 included in the piece of display image data, and drives the plurality of pixels PIX in units of one pixel PIX on the basis of the pieces of image data other than the pieces of image data related to the partial image P2.

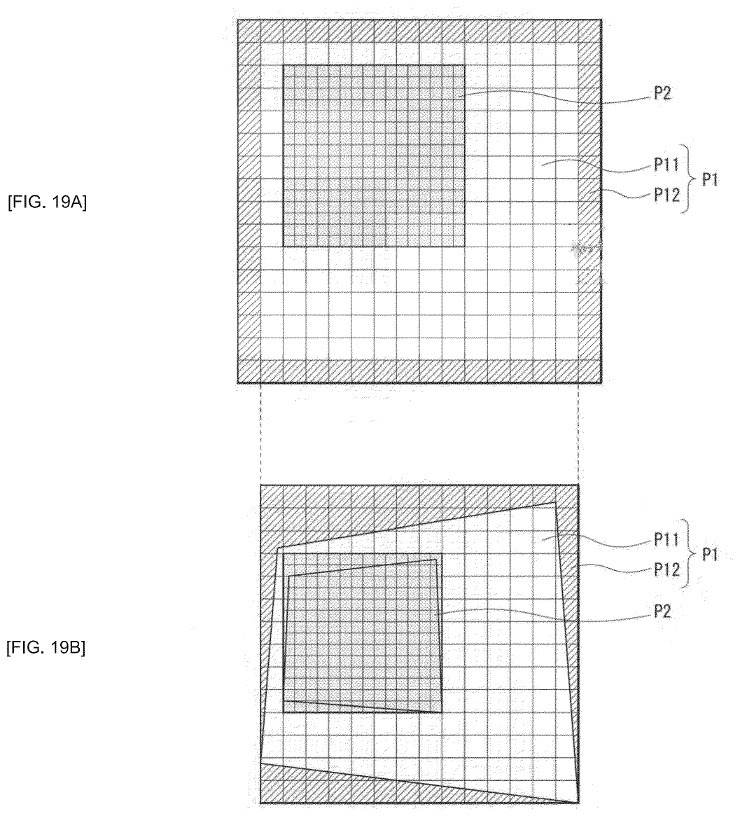

For example, in a case where the direction of the head-mounted display 20 has changed and the direction of the eye of the user has not changed, the acceleration sensor 22 detects that the direction of the head-mounted display 20 has changed. The predictive processing circuit 29 of the display controller 26 generates a piece of display image data by performing the geometric deformation processing as illustrated in FIGS. 19A and 19B on the basis of the result of detection by the acceleration sensor 22 and the result of detection by the eye-tracking sensor 23. The piece of display image data includes the pieces of image data related to peripheral image P12 in addition to the pieces of image data related to the entire image P11 and the pieces of image data related to the partial image P2. It is to be noted that the piece of display image data may further include a piece of image data of an outside image in addition to the pieces of image data related to the peripheral image P12, as illustrated in FIGS. 8 and 9. In this example, the image P1 becomes small by the geometric deformation processing, which causes the partial image P2 to also become small. The display controller 26 drives the plurality of pixels PIX in units of one pixel PIX on the basis of the pieces of image data related to the partial image P2 included in the piece of display image data, and drives the plurality of pixels PIX in units of one pixel PIX on the basis of the pieces of image data other than the pieces of image data related to the partial image P2.

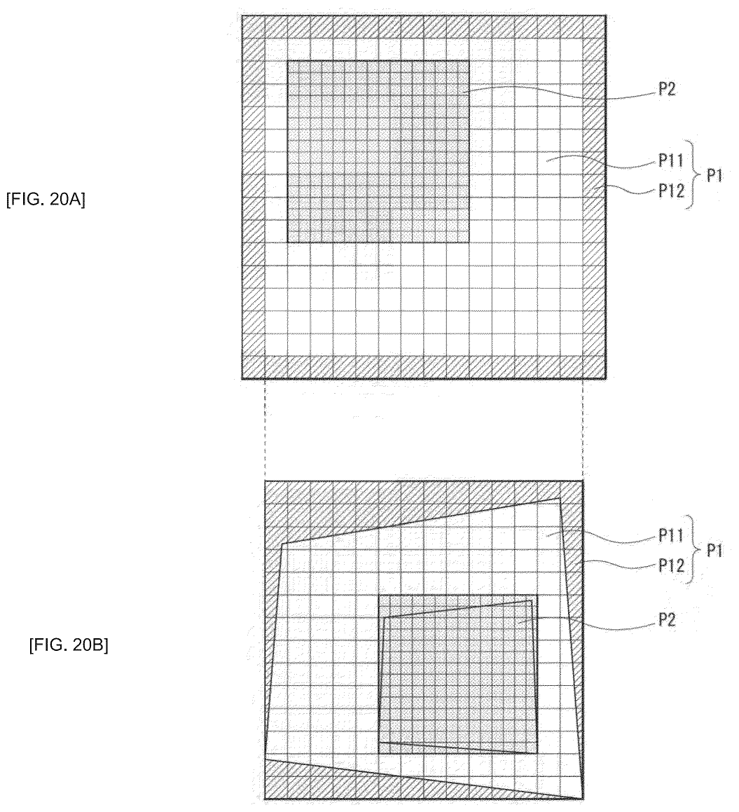

For example, in a case where the direction of the head-mounted display 20 has changed and the direction of the eye of the user also has changed, the acceleration sensor 22 detects that the direction of the head-mounted display 20 has changed, and the eye-tracking sensor 23 detects that the direction of the eye of the user has changed. The predictive processing circuit 29 of the display controller 26 generates a piece of display image data by performing the geometric deformation processing as illustrated in FIGS. 20A and 20B on the basis of the result of detection by the acceleration sensor 22 and the result of detection by the eye-tracking sensor 23. The piece of display image data includes the pieces of image data related to the peripheral image P12 in addition to the pieces of image data related to the entire image P11 and the pieces of image data related to the partial image P2. It is to be noted that the piece of display image data may further include a piece of image data of an outside image in addition to the pieces of image data related to the peripheral image P12, as illustrated in FIGS. 8 and 9. In this example, the direction of the eye of the user has changed; therefore, the predictive processing circuit 29 changes the position of the partial image P2 in the image P1 on the basis of the result of detection by the eye-tracking sensor 23, and generates a piece of image data of the partial image P2 by performing the super-resolution processing for increasing a resolution. The display controller 26 drives the plurality of pixels PIX in units of one pixel PIX on the basis of the pieces of image data related to the partial image P2 included in the piece of display image data, and drives the plurality of pixels PIX in units of one pixel PIX on the basis of the pieces of image data other than the pieces of image data related to the partial image P2.

Thus, the display controller 26 generates the piece of display image data, and controls the operation of the display panel 27 on the basis of the piece of display image data.

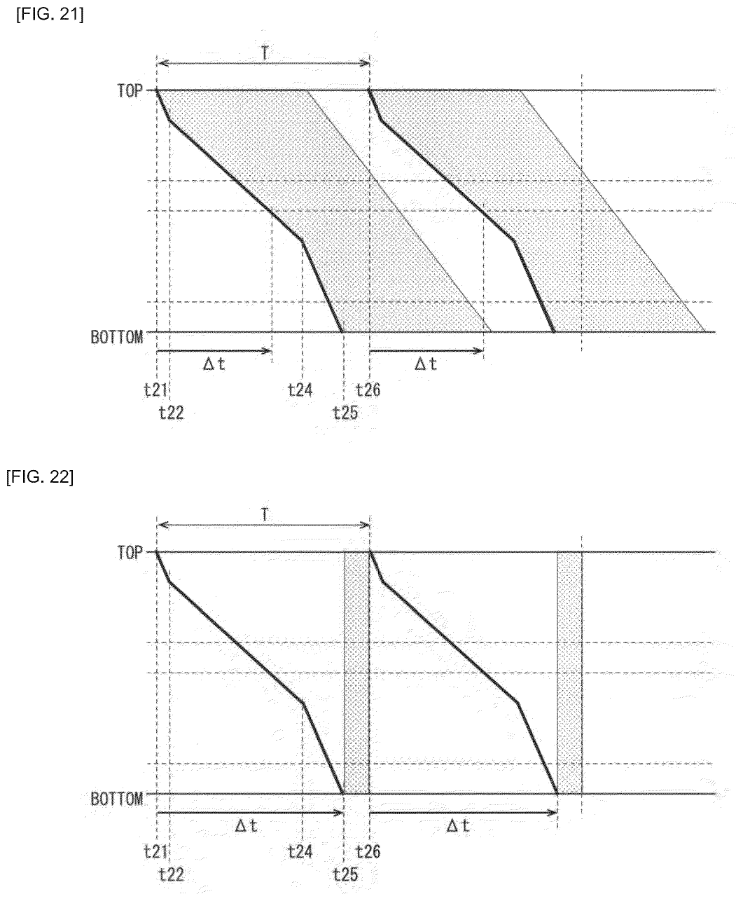

FIG. 21 illustrates an operation example of the display panel 27. In this example, a frame rate is 120 Hz. In this case, a cycle T of a display operation in the display panel 27 is 8.3 [msec.](= 1/120 [Hz]).

The scanning circuit 33 performs scanning in scanning units of one pixel line L or two pixel lines L from a top to a bottom of the pixel array 31 in this example. In this example, in a period from a timing t21 to a timing t22 and a period from a timing t24 to a timing t25, scanning speed is fast, and in a period from the timing t22 to the timing t24, the scanning speed is slow. In other words, in the period from the timing t22 to the timing t24, the scanning circuit 33 scans a plurality of pixel lines L corresponding to the position of the partial image P2. In this case, the pixel signal generation circuit 32 writes the pixel signals to a plurality of pixels PIX related to two pixel lines L in three horizontal periods as with an operation in the period from the timing t13 to the timing t16; therefore, the scanning speed is slow. In contrast, in the period from the timing t21 to the timing t22 and the period from the timing t24 to the timing t25, the pixel signal generation circuit 32 writes the pixel signals to a plurality of pixels PIX related to two pixel lines L in one horizontal period as with an operation in the period from the timing t12 to the timing t13; therefore, the scanning speed is fast. Thus, in the display panel 27, scanning is performed in scanning units of one pixel line L or two pixel lines L, which makes it possible to decrease an operation frequency and reduce power consumption, as compared with, for example, a case where scanning is performed in scanning units of one pixel line L.

Thereafter, as indicated by a shaded portion in FIG. 21, the pixel PIX to which the pixel signal is written emits light over a predetermined period after the pixel signal is written in this example. Thus, the display panel 27 displays an image.

Thus, the head-mounted display 20 displays an image on the basis of the image P1 and the partial image P2. In this example, time Δt from the timing t21 at which inputting of the piece of image data starts until the pixel PIX at a middle position in an up/down direction of the display panel 27 starts emitting light is about a half of time corresponding to the cycle T. Specifically, for example, in a case where the cycle T is 8.3 [msec.], it is possible to set the time Δt to about 4.1 [msec.].

FIG. 22 illustrates another operation example of the display panel 27. In this example, a light emission operation of the pixels PIX is different from the example in FIG. 21. In other words, in the example in FIG. 21, the display panel 27 emits light in accordance with a scanning timing; however, in this example, the pixels PIX in an entire region emit light at the same timing. The time Δt in this example is substantially the same as the time corresponding to the cycle T. Specifically, for example, in a case where the cycle T is 8.3 [msec.], it is possible to set the time Δt to about 8 [msec.].

In the display system 1, the eye-tracking sensor 23 of the head-mounted display 20 detects the direction of the eye of the user wearing the head-mounted display 20 to thereby detect which portion of a display image the user is looking at. The image generation device 10 specifies an image (the partial image P2) including a portion at which the user is looking of the entire image P11 on the basis of a result of detection by the eye-tracking sensor 23. Thereafter, the image generation device 10 generates the image signal SP including a piece of image data that has a low resolution and represents the image P1 (the entire image P11 and the peripheral image P12) and a piece of image data that has a high resolution and represents the partial image P2. Accordingly, in the pieces of image data included in the image signal SP, positions of the piece of image data related to the image P1 and the piece of image data related to the partial image P2 may change depending on the result of detection by the eye-tracking sensor 23.

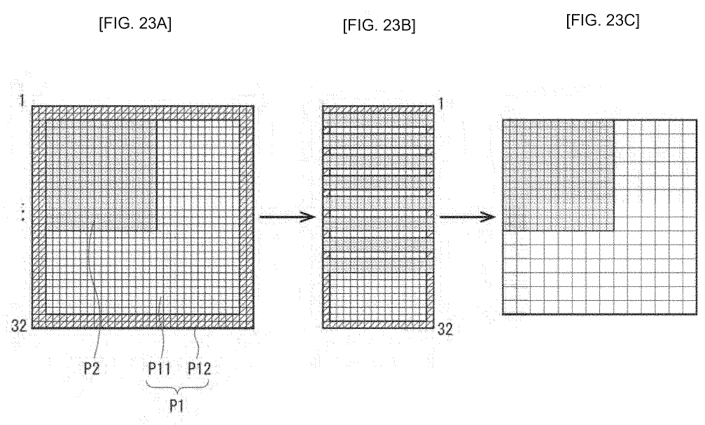

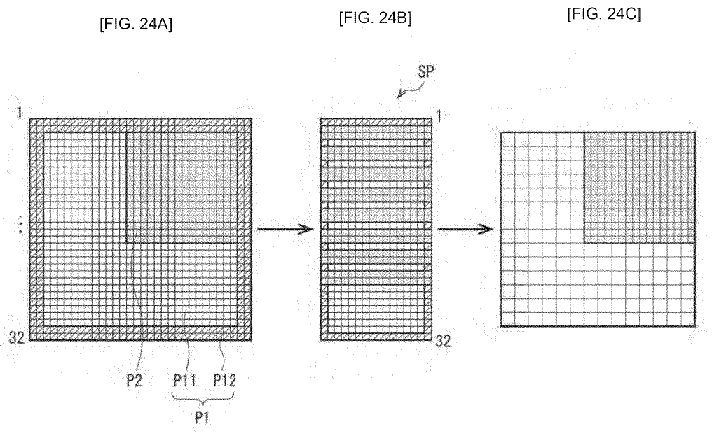

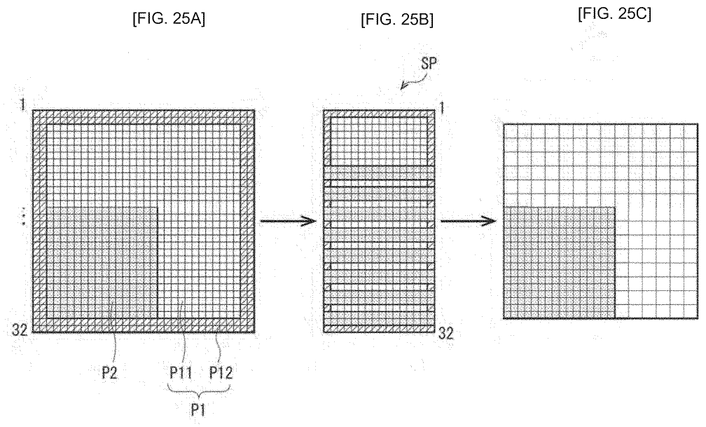

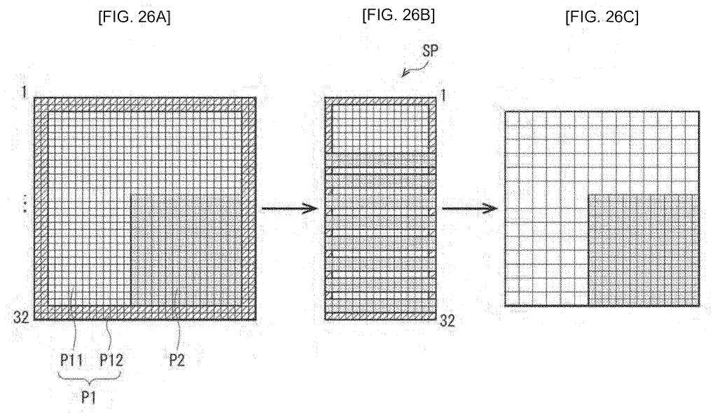

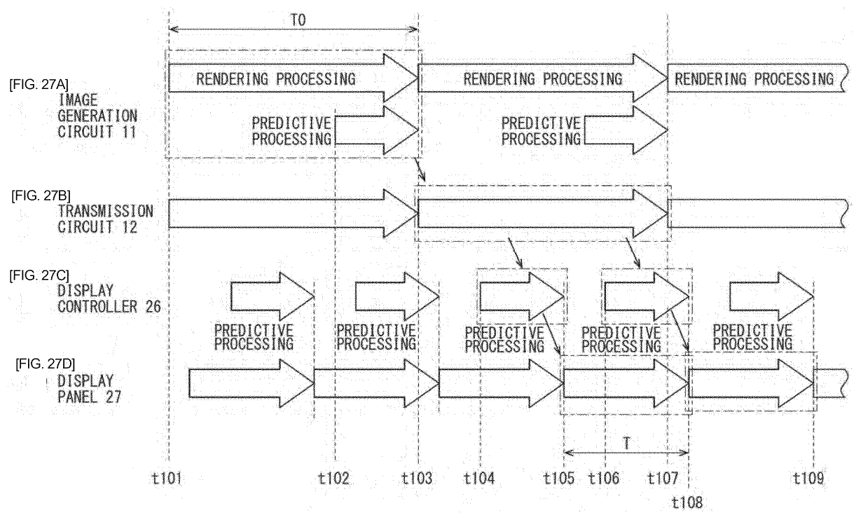

FIGS. 23A, 23B, 23C, 24A, 24B, 24C, 25A, 25B, 25C, 26A, 26B, and 26C each illustrate an operation example of the display system 1. FIGS. 23A, 23B, and 23C illustrate a case where the user is looking at an upper left portion in a display image of the display panel 27. FIGS. 24A, 24B, and 24C illustrate a case where the user is looking at an upper right portion in the display image of the display panel 27. FIGS. 25A, 25B, and 25C illustrate a case where the user is looking at a lower left portion in the display image of the display panel 27. FIGS. 26A, 26B, and 26C illustrate a case where the user is looking at a lower right portion in the display image of the display panel 27.

For example, in a case where the user is looking at the upper left or the upper right in the display image of the display panel 27 (FIG. 23A, 23B, and 23C or 24), in the pieces of image data in the image signal SP, the piece of image data related to the partial image P2 is located at an upper position as illustrated in FIG. 23B or FIG. 24B. In contrast, for example, in a case where the user is looking at the lower left or the lower right in the display image of the display panel 27 (FIGS. 25A, 25B, and 25C or FIGS. 26A, 26B, and 26C), in the pieces of image data in the image signal SP, the piece of image data related to the partial image P2 is located at a lower position as illustrated in FIG. 25B or FIG. 26B. The positions of the piece of image data related to the image P1 and the piece of image data related to the partial image P2 in the pieces of image data included in the image signal SP may change depending on the result of detection by the eye-tracking sensor 23 in such a manner.

FIGS. 27A, 27B, 27C, and 27D illustrate an example of the operation of the display system 1, where FIG. 27A indicates an operation of the image generation circuit 11, FIG. 27B indicates an operation of the transmission circuit 12, FIG. 27C indicates an operation of the display controller 26, and FIG. 27D indicates an operation of the display panel 27. In this example, the frame rate of the display panel 27 is 120 Hz. In this case, the cycle T is 8.3 [msec.](= 1/120 [Hz]). In addition, a cycle TO of a rendering processing in the image generation circuit 11 is 16.7 [msec.](= 1/60 [Hz]). In the display system 1, a piece of image data is generated in the cycle TO, and display based on the piece of image data is performed in the cycle T.

In a period from a timing t101 to a timing t103, the image generation circuit 11 of the image generation device 10 performs the rendering processing to thereby generate the entire image P11 corresponding to the direction of the head-mounted display 20 and generate the peripheral image P12 outside the entire image P11 on the basis of the result of detection by the acceleration sensor 22 (FIG. 27A). Thereafter, in a period from a timing t102 to the timing t103 of the period from the timing t101 to the t103, as with the predictive processing circuit 29 of the display controller 26, the image generation circuit 11 performs the geometric deformation processing on the basis of the latest result of detection by the acceleration sensor 22 to thereby update the entire image P11 and the peripheral image P12. In addition, the image generation circuit 11 specifies the partial mage P2 including a portion at which the user is looking of the entire image P11 on the basis of the result of detection by the eye-tracking sensor 23.

Next, in a period from the timing t103 to a timing t107, the transmission circuit 12 of the image generation device 10 generates the image signal SP on the basis of such an image generated by the image generation circuit 11, and transmits the image signal SP to the head-mounted display 20 (FIG. 27B).

Next, in a period from a timing t104 to a timing t105, the predictive processing circuit 29 of the display controller 26 performs the geometric deformation processing on the basis of the latest result of detection by the acceleration sensor 22 and the latest result of detection by the eye-tracking sensor 23 to thereby generate a piece of display image data (FIG. 27C). Thereafter, in a period from the timing t105 to a timing t108, the display panel 27 displays an image on the basis of the piece of display image data generated by the predictive processing circuit 29 (FIG. 27D).

In addition, in a period from a timing t106 to the timing t108, the predictive processing circuit 29 of the display controller 26 performs the geometric deformation processing on the basis of the latest result of detection by the acceleration sensor 22 and the latest result of detection by the eye-tracking sensor 23 to thereby generate a piece of display image data (FIG. 27C). Thereafter, in a period from the timing t108 to a timing t109, the display panel 27 displays an image on the basis of the piece of display image data generated by the predictive processing circuit 29 (FIG. 27D).

As illustrated in FIGS. 27A, 27B, 27C, and 27D, the predictive processing circuit 29 of the display controller 26 generates a piece of display image data by performing the geometric deformation processing on the basis of the latest result of detection by the acceleration sensor 22 and the latest result of detection by the eye-tracking sensor 23. Thereafter, the display panel 27 displays an image on the basis of the piece of display image data generated by the predictive processing circuit 29. Specifically, the predictive processing circuit 29 performs a predictive processing in the period from the timing t104 to the timing t105 on the basis of, for example, the latest result of detection by the acceleration sensor 22 and the latest result of detection by the eye-tracking sensor 23 that have not been reflected on the predictive processing in the image generation circuit 11 from the timing t102 to the timing t103. Thereafter, the display panel 27 displays an image on the basis of the piece of display image data generated by the predictive processing circuit 29 in the period from the timing t105 to the timing t108. In the display system 1, such a predictive processing by the predictive processing circuit 29 makes it possible to immediately display, for example, an image corresponding to a change in direction of the head-mounted display 20, and makes it possible to reduce the latency.

In addition, for example, the predictive processing circuit 29 performs the predictive processing in the period from the timing t106 to the timing t108, and the display panel 27 displays an image on the basis of the piece of display image data generated by the predictive processing circuit 29 in the period from the timing t108 to the timing t109. Accordingly, in the display system 1, even in a case where the transmission rate of the image signal SP is low, the predictive processing by the predictive processing circuit 29 makes it possible to immediately display, for example, an image corresponding to a change in direction of the head-mounted display 20, and makes it possible to reduce the latency.

In such a predictive processing, the predictive processing circuit 28 performs the geometric deformation processing also on the basis of a piece of image data of the peripheral image P12 in addition to a piece of image data of the entire image P11 and a piece of image data of the partial image P2. Accordingly, in the display system 1, as illustrated in FIGS. 19A, 19B, 20A, and 20B, in a case where the image P1 becomes small by the geometric deformation processing, the peripheral image P12 is effectively used to perform the geometric deformation processing, which makes it possible to generate a display image.

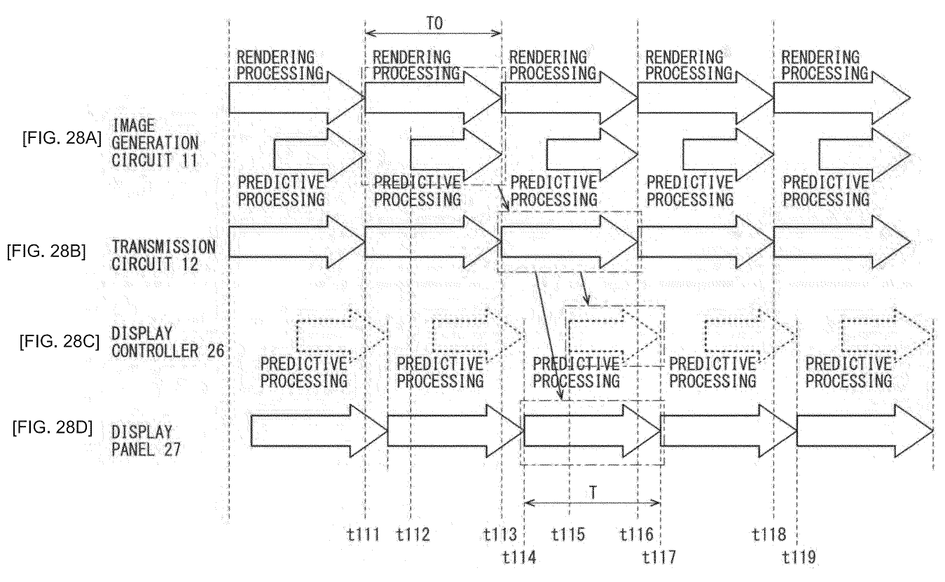

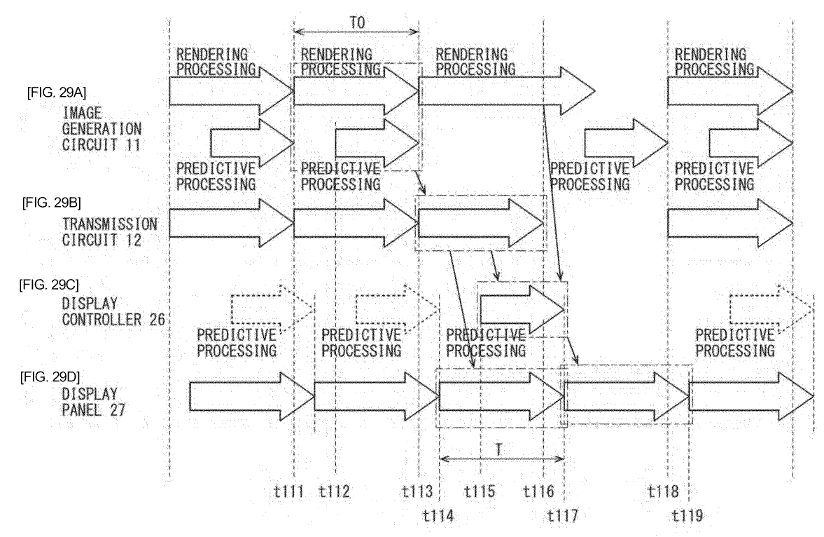

FIGS. 28A, 28B, 28C, 28D, 29A, 29B, 29C, and 29D illustrate another example of the operation of the display system 1. In this example, the cycle TO of the rendering processing in the image generation circuit 11 is equal to the cycle T of the display operation in the display panel 27, and is 8.3 [msec.](= 1/120 [Hz]).

In a period from a timing t111 to a timing t113, the image generation circuit 11 of the image generation device 10 performs the rendering processing to thereby generate the entire image P11 corresponding to the direction of the head-mounted display 20 and generates the peripheral image P12 outside the entire image P11 on the basis of the result of detection by the acceleration sensor 22 (FIG. 28A). Thereafter, in a period from a timing t112 to the timing t113 of the period from the timing t111 to the timing t113, as with the predictive processing circuit 29 of the display controller 26, the image generation circuit 11 performs the geometric deformation processing on the basis of the latest result of detection by the acceleration sensor 22 to thereby update the entire image P11 and the peripheral image P12. In addition, the image generation circuit 11 specifies the partial image P2 including a portion at which the user is looking of the entire image P11 on the basis of the result of detection by the eye-tracking sensor 23. Thereafter, at the timing t113, the image generation circuit 11 starts the next rendering processing.

Next, in a period from the timing t113 to a timing t116, the transmission circuit 12 of the image generation device 10 generates the image signal SP on the basis of such an image generated by the image generation circuit 11, and transmits the image signal SP to the head-mounted display 20 (FIG. 28B). Thereafter, in a period from a timing t114 to a timing t117, the display panel 27 displays an image on the basis of the piece of display image data generated by the display controller 26 on the basis of the pieces of image data transmitted from the transmission circuit 12 (FIG. 28D).

Next, in a period from a timing t115 to the timing t117, the predictive processing circuit 29 of the display controller 26 performs the geometric deformation processing on the basis of the latest result of detection by the acceleration sensor 22 and the latest result of detection by the eye-tracking sensor 23 to thereby generate a piece of display image data (FIG. 28C).

In an example in FIGS. 28A, 28B, 28C, and 28D, the rendering processing started by the image generation circuit 11 at the timing t113 ends within a period corresponding to the cycle TO (FIG. 28A). Accordingly, in a period from the timing t116 to a timing t118, the transmission circuit 12 of the image generation device 10 generates the image signal SP on the basis of the image generated by the image generation circuit 11, and transmits the image signal SP to the head-mounted display 20 (FIG. 28B). In this case, in the period from the timing t115 to the timing t117, the piece of display image data generated by the predictive processing circuit 29 are discarded. Thereafter, in a period from the timing t117 to a timing t119, the display panel 27 displays an image on the basis of the piece of display image data generated by the display controller 26 on the basis of the pieces of image data transmitted from the transmission circuit 12.

Meanwhile, in an example in FIGS. 29A, 29B, 29C, and 29D, it is not possible to end, within the period corresponding to the cycle TO, the rendering processing started by the image generation circuit 11 at the timing t113. In this case, it is not possible for the transmission circuit 12 to start transmitting the image signal SP at the timing t116. Accordingly, in the period from the timing t117 to the timing t119, the display panel 27 displays an image on the basis of the piece of display image data generated by the predictive processing circuit 29 in the period from the timing t115 to the timing t117 (FIG. 29D).

As illustrated in FIGS. 28A, 28B, 28C, 28D, 29A, 29B, 29C, and 29D, the predictive processing circuit 29 of the display controller 26 generates the piece of display image data by performing the geometric deformation processing on the basis of the latest result of detection by the acceleration sensor 22 and the latest result of detection by the eye-tracking sensor 23. Thereafter, the display panel 27 displays an image on the basis of the piece of display image data generated by the predictive processing circuit 29. Specifically, for example, as illustrated in FIGS. 29A, 29B, 29C, and 29D, in a case where the rendering processing started by the image generation circuit 11 at the timing t113 does not end within the period corresponding to the cycle TO, in a period from the timing t117 to the timing t118, the display panel 27 displays an image on the basis of the piece of display image data generated by the predictive processing circuit 29 in the period from the timing t115 to the timing t117. Accordingly, even in a case where the rendering processing is not done in time, in the display system 1, it is possible to display an image on the basis of the piece of display image data generated by the predictive processing circuit 29, which makes it possible to immediately display, for example, an image corresponding to a change in direction of the head-mounted display 20.

Thus, in the display system 1, the reception circuit 21 receives a piece of first image data representing the entire image P11 having a first resolution, a piece of second image data representing the peripheral image P12 having a second resolution lower than or equal to the first resolution, and a piece of third image data representing the partial image P2 having a third resolution higher than the first resolution. The peripheral image P12 is an image outside the entire image P11. The partial image P2 is an image having an image range narrower than that of the entire image P11. The acceleration sensor 22 detects a change in orientation of the head-mounted display 20. The display controller 26 performs the geometric deformation processing on the piece of first image data, the piece of second image data, and the piece of third image data on the basis of the result of detection by the acceleration sensor 22 to thereby perform a first image processing for generating a piece of display image data. Thereafter, the pixel signal generation circuit 32 and the scanning circuit 33 drive the pixel array 31 that is configured to display an image having the same image range as the image range of the entire image P11, on the basis of the piece of display image data. Accordingly, it is possible for the head-mounted display 20 to display an image on the basis of the piece of display image data generated by the predictive processing circuit 29, which makes it possible to immediately display, for example, an image corresponding to a change in direction of the head-mounted display 20. In addition, for example, as illustrated in FIGS. 28A, 28B, 28C, 28D, 29A, 29B, 29C, and 29D, even in a case where the transmission rate is reduced, it is possible to immediately display an image corresponding to a change in direction of the head-mounted display 20. As a result, in the head-mounted display 20, it is possible to reduce the latency.

### [Effects]

As described above, in the present embodiment, the piece of first image data, the piece of second image data, and the piece of third image data are received. The piece of first image data represents an entire image having the first resolution. The piece of second image data represents a peripheral image having the second resolution lower than or equal to the first resolution. The peripheral image is an image outside the entire image. The piece of third image data represents a partial image having the third resolution higher than the first resolution. The partial image is an image having an image range narrower than that of the entire image. An acceleration sensor detects a change in orientation of a head-mounted display. A predictive processing circuit performs the geometric deformation processing on the piece of first image data, the piece of second image data, and the piece of third image data on the basis of a result of detection by the acceleration sensor to thereby perform the first image processing for generating a piece of display image data. Thereafter, a pixel signal generation circuit and a scanning circuit drive a pixel array that is configured to display an image having the same image range as an image range of the entire image, on the basis of the piece of display image data. This makes it possible to reduce the latency.

### Modification Example 1-1

In the embodiment described above, the image generation circuit 11 generates the image P1 (the entire image P11 and the peripheral image P12), specifies a part of the entire image P11 as the partial image P2, and converts four pixel values disposed in two rows and two columns in the image P1 into one pixel value to thereby convert the image P1 having a high resolution into the image P1 having a low resolution, but the embodiment is not limited thereto. Instead of this, the image generation circuit 11 may individually generate the image P1 having a low resolution and the partial image P2 having a high resolution. In this case, the transmission signal generation circuit 18 generates pieces of image data included in the image signal SP on the basis of the image P1 having a low resolution and the partial image P2 having a high resolution.

### Modification Example 1-2

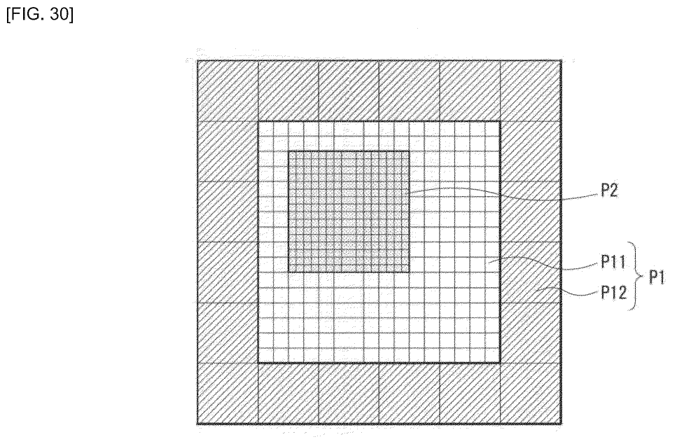

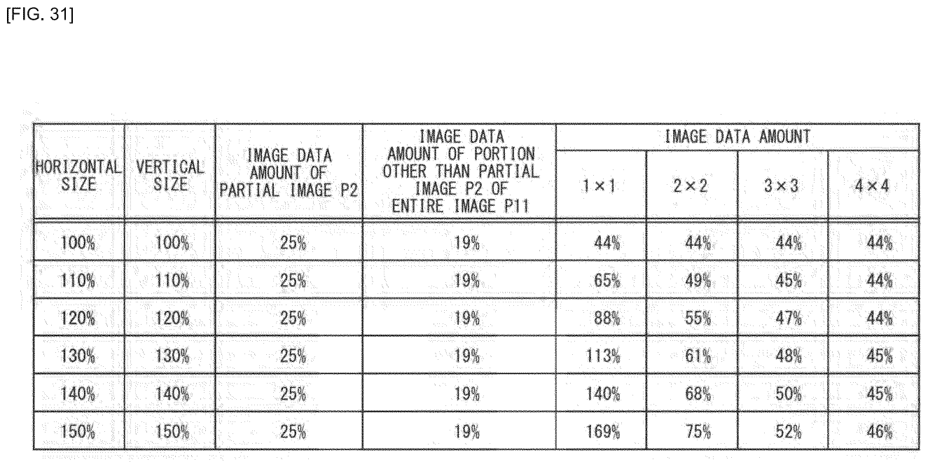

In the embodiment described above, as illustrated in FIG. 18A, and the like, the resolution of the peripheral image P12 is equal to the resolution of the entire image P11, but the embodiment is not limited thereto. Instead of this, for example, as illustrated in FIG. 30, the resolution of the peripheral image P12 may be lower than the resolution of the entire image P11. As illustrated in FIG. 31, the resolution of the peripheral image P12 is set to ¼ (2×2), 1/9 (3×3), or 1/16 (4×4), which makes it possible to reduce an image data amount, and makes it possible to reduce the transmission band.

### Modification Example 1-3

In the embodiment described above, the predictive processing circuit 29 generates a display image with use of the peripheral image P12, on the basis of the result of detection by the acceleration sensor 22. However, in a case where the display system 1 displays a stereo image including a left-eye image and a right-eye image, the predictive processing circuit 29 may generate a display image of the left-eye image and a display image of the right-eye image with use of both the left-eye image and the right-eye image. Specifically, the predictive processing circuit 29 may use the right-eye image when generating the display image of the left-eye image, and may use the left-eye image when generating the display image of the right-eye image. This operation is described in detail below.

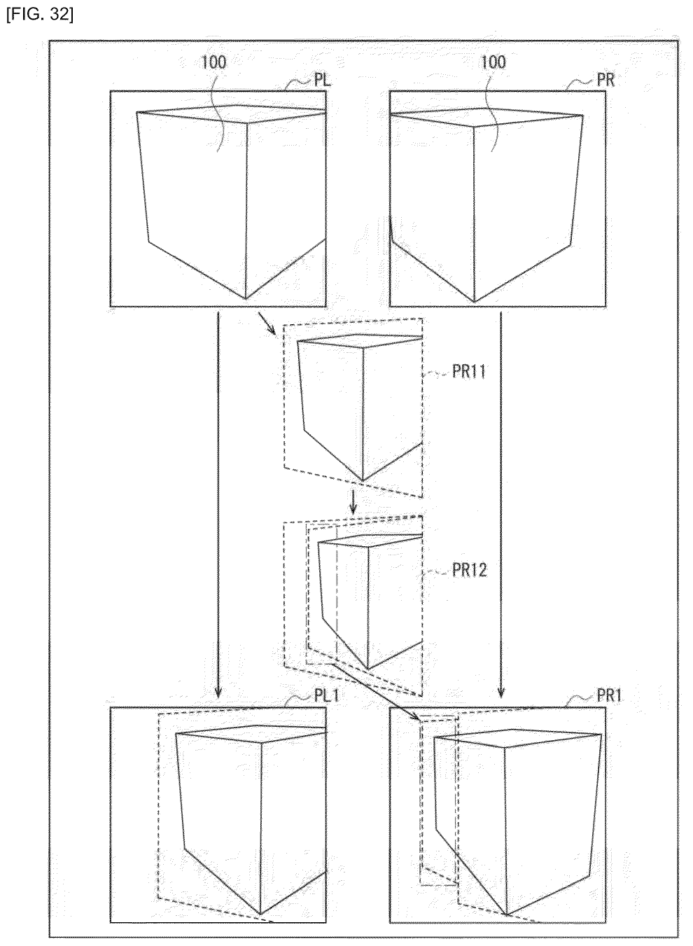

FIG. 32 illustrates an operation example of the predictive processing circuit 29 according to the present modification example. The predictive processing circuit 29 performs a processing on the basis of pieces of image data of a left-eye image PL and a right-eye image PR. In this example, each of the left-eye image PL and the right-eye image PR includes an image of a box 100. In this example, in the left-eye image PL, an image of a right-side end of the box 100 is missing, and in the right-eye image PR, an image of a left-side end of the box 100 is missing.

For example, when the user 8 wearing the head-mounted display 20 turns his head slightly to the lower left as illustrated in FIG. 5, the predictive processing circuit 29 respectively performs the geometric deformation processing on the left-eye image PL and the right-eye image PR on the basis of the latest result of detection by the acceleration sensor 22 to thereby generate a left-eye image PL1 and a right-eye image PR1, as illustrated in FIG. 32. In the right-eye image PR, the image of the left-side end of the box 100 is missing; therefore, even if the predictive processing circuit 29 performs the geometric deformation processing on the right-eye image PR, it is not possible to generate an image of this missing portion. Accordingly, the predictive processing circuit 29 generates the image of the missing portion in the right-eye image PR1 on the basis of the left-eye image PL. Specifically, the predictive processing circuit 29 first performs the geometric deformation processing on the left-eye image PL for a left eye to convert the left-eye image PL into an image PR11 for a right eye. In other words, the left-eye image PL is an image in a case of being observed by the user 8 with his left eye; therefore, the predictive processing circuit 29 performs the geometric deformation processing in consideration of a difference between the positions of the left eye and the right eye to thereby generate the image PR11 in a case of being observed by the user 8 with his left eye. Next, the predictive processing circuit 29 performs the geometric deformation processing on the image PR11 on the basis of the latest result of detection by the acceleration sensor 22 to thereby generate an image PR12. Thereafter, the predictive processing circuit 29 combines an image, corresponding to a missing portion of the right-eye image PR1, in the image PR12 with the right-eye image PR1. Thus, it is possible for the predictive processing circuit 29 to correct an image portion where the left-side end of the box 100 is missing in the right-eye image PR1.

### Modification Example 1-4

In the embodiment described above, the entire image P11 and the partial image P2 are used, but the embodiment is not limited thereto. Instead of this, for example, an image having another different resolution may be used. An example in a case where three images are used is described in detail below.

The image generation circuit 11 according to the present modification example generates the entire image P11 representing a scenery corresponding to the direction of the head-mounted display 20 in a virtual space on the basis of a result of detection by the acceleration sensor 22 included in a piece of data supplied from the reception circuit 13. In addition, the image generation circuit 11 generates the peripheral image P12 outside the entire image P11. In addition, the image generation circuit 11 specifies partial images P2 and P3 each representing a portion at which the user is looking of the scenery corresponding to the direction of the head-mounted display 20 in the virtual space on the basis of a result of detection by the eye-tracking sensor 23 included in the piece of data supplied from the reception circuit 13.

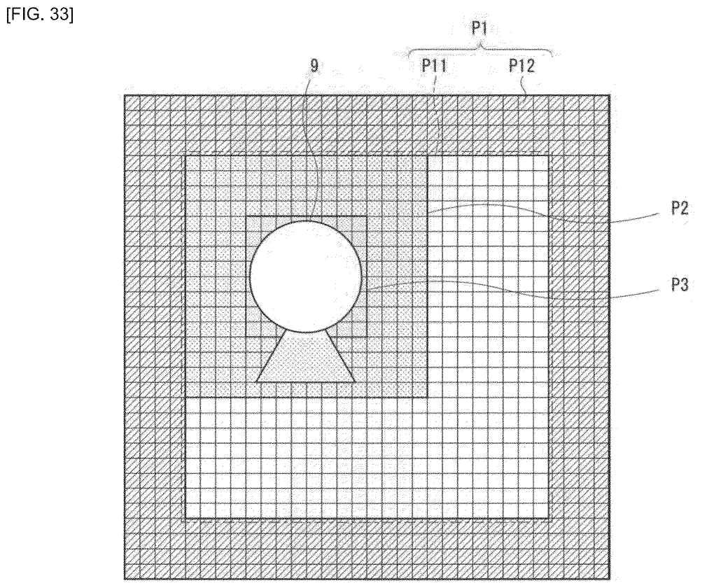

FIG. 33 illustrates an example of an image generated by the image generation circuit 11. The image generation circuit 11 specifies the partial images P2 and P3 including a portion at which the user is looking of the entire image P11 on the basis of a result of detection by the eye-tracking sensor 23 included in the piece of data supplied from the reception circuit 13. In this example, the size in the horizontal direction (the lateral direction in FIG. 33) of the partial image P2 is a half of the size in the horizontal direction of the image P1, and the size in the vertical direction (the longitudinal direction in FIG. 33) of the partial image P2 is a half of the size in the vertical direction of the image P1. In other words, the area of the partial image P2 is ¼ of the area of the image P1. In addition, a size in the horizontal direction of the partial image P3 is a half of the size in the horizonal direction of the partial image P2, and a size in the vertical direction of the partial image P3 is a half of the size in the vertical direction of the partial image P2. In other words, an area of the partial image P3 is ¼ of the area of the partial image P2. In this example, a center position of the partial image P3 is the same as a center position of the partial image P2.

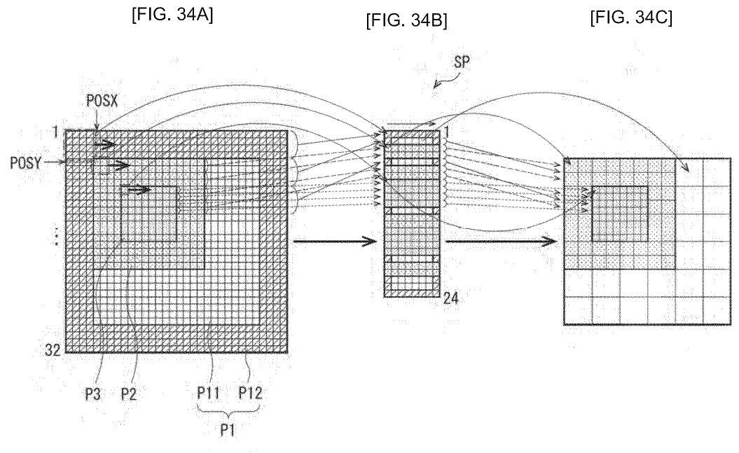

FIGS. 34A, 34B, and 34C illustrate an operation example of the display system 1 according to the present modification example, where FIG. 34A indicates an image generated by the image generation circuit 11, FIG. 34B indicates pieces of image data included in the image signal SP, and FIG. 34C indicates a display driving operation in the head-mounted display 20 according to the present modification example.

As illustrated in FIGS. 34A and 34B, the transmission signal generation circuit 18 according to the present modification example performs left-to-right scanning from top to bottom sequentially on the image P1 generated by the image generation circuit 11 to thereby generate the image signal SP. The transmission signal generation circuit 18 converts sixteen pixel values disposed in four rows and four columns in the image P1 into one pixel value, converts four pixel values disposed in two rows and two columns in a portion overlapping the partial image P2 of the image P1 into one pixel value, and outputs one pixel value as it is in a portion overlapping the partial image P3 of the image P1, thereby generating pieces of image data in the image signal SP.

Specifically, in this example, the transmission signal generation circuit 18 converts sixteen pixel values disposed in four rows and four columns into one pixel value on the basis of 128 pixel values included in the first to fourth rows of the image P1 to thereby generate eight pixel values related to the peripheral image P12. Thus, the transmission signal generation circuit 18 generates a piece of image data in the first row in the image signal SP.

In addition, the transmission signal generation circuit 18 converts sixteen pixel values disposed in four rows and four columns into one pixel value on the basis of 128 pixel values included in the fifth to eighth rows of the image P1 to thereby generate one pixel value related to the peripheral image P12, six pixel values related to the entire image P11, and one pixel value related to the peripheral image P12. Thus, the transmission signal generation circuit 18 generates a piece of image data in the second row in the image signal SP.

In addition, the transmission signal generation circuit 18 converts four pixel values disposed in two rows and two columns into one pixel value on the basis of 32 pixel values related to the partial image P2 of 64 pixel values included in the fifth and sixth rows of the image P1 to thereby generate eight pixel values related to the partial image P2. Thus, the transmission signal generation circuit 18 generates a piece of image data in the third row in the image signal SP.

In addition, the transmission signal generation circuit 18 converts four pixel values disposed in two rows and two columns into one pixel value on the basis of 32 pixel values related to the partial image P2 of 64 pixel values included in the seventh and eighth rows of the image P1 to thereby generate eight pixel values related to the partial image P2. Thus, the transmission signal generation circuit 18 generates a piece of image data in the fourth row in the image signal SP.

In addition, the transmission signal generation circuit 18 converts sixteen pixel values disposed in four rows and four columns into one pixel value on the basis of 128 pixel values included in the ninth to twelfth rows of the image P1 to thereby generate one pixel value related to the peripheral image P12, six pixel values related to the entire image P11, and one pixel value related to the peripheral image P12. Thus, the transmission signal generation circuit 18 generates a piece of image data in the fifth row in the image signal SP.

In addition, the transmission signal generation circuit 18 converts four pixel values disposed in two rows and two columns into one pixel value on the basis of 32 pixel values related to the partial image P2 of 64 pixel values included in the ninth and tenth rows of the image P1 to thereby generate eight pixel values related to the partial image P2. Thus, the transmission signal generation circuit 18 generates a piece of image data in the sixth row in the image signal SP.

In addition, the transmission signal generation circuit 18 converts four pixel values disposed in two rows and two columns into one pixel value on the basis of 32 pixel values related to the partial image P2 of 64 pixel values included in the eleventh and twelfth rows of the image P1 to thereby generate eight pixel values related to the partial image P2. Thus, the transmission signal generation circuit 18 generates a piece of image data in the seventh row in the image signal SP.

In addition, the transmission signal generation circuit 18 outputs eight pixel values related to the partial image P3 of 32 pixel values included in the ninth row of the image P1 as they are, outputs eight pixel values related to the partial image P3 of 32 pixel values included in the tenth row of the image P1 as they are, outputs eight pixel values related to the partial image P3 of 32 pixel values included in the eleventh row of the image P1 as they are, and outputs eight pixel values related to the partial image P3 of 32 pixel values included in the twelfth row of the entire image P1 as they are. Thus, the transmission signal generation circuit 18 generates pieces of image data in the eighth to eleventh rows in the image signal SP.

As described above, the transmission signal generation circuit 18 converts sixteen pixel values disposed in four rows and four columns in the image P1 into one pixel value. The transmission signal generation circuit 18 converts four pixel values disposed in two rows and two columns in the portion overlapping the partial image P2 of the image P1 into one pixel value. In addition, the transmission signal generation circuit 18 outputs pixel values as they are in the portion overlapping the partial image P3 of the image P1. As a result, in the image signal SP, the resolution of the image P1 becomes lower than the resolution of the partial image P2, and the resolution of the partial image P2 becomes lower than the resolution of the partial image P3.

Thus, the transmission signal generation circuit 18 generates pieces of image data including a plurality of pixel values as illustrated in FIG. 34B, on the basis of the image generated by the image generation circuit 11. Thereafter, the transmission signal generation circuit 18 generates the image signal SP including the pieces of image data and the piece of image position data representing the position (parameters POSX and POSY) of the partial image P2 in the image P1.

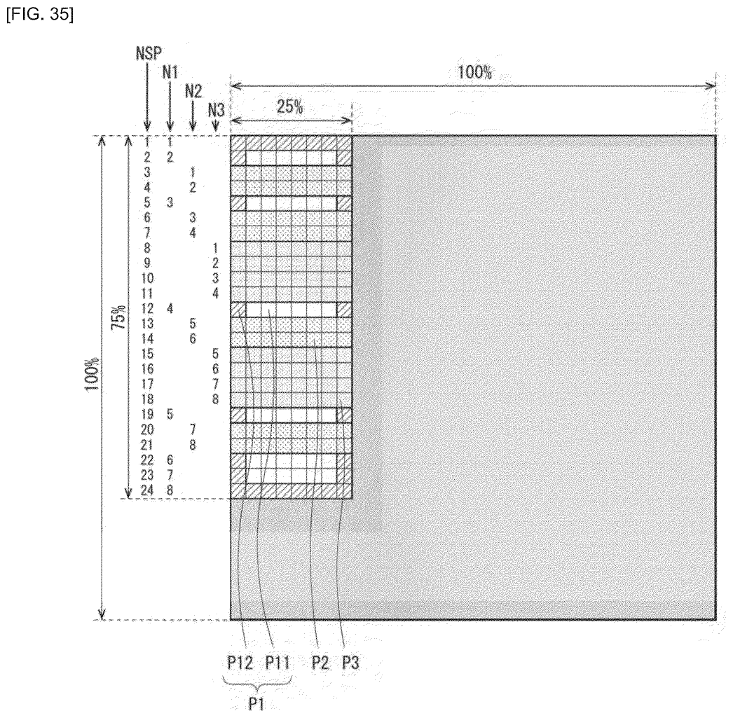

FIG. 35 illustrates a transmission band in the display system 1 according to the present modification example. The pieces of image data included in the image signal SP in this example include pieces of image data for 24 rows. For explanatory convenience, each of pieces of image data for eight rows related to the image P1 (the entire image P11 and the peripheral image P12) is attached with the data number N1, each of pieces of image data for eight rows related to the partial image P2 is attached with the data number N2, and each of pieces of image data for eight rows related to the partial image P3 is attached with a data number N3.

The number of pixel values in the pieces of image data included in the image signal SP is 18.75% (=0.75×0.25) of the number of pixel values included in the image P1. Thus, it is possible for the display system 1 to reduce an image data amount, as compared with a case where the image P1 before conversion is transmitted as it is.

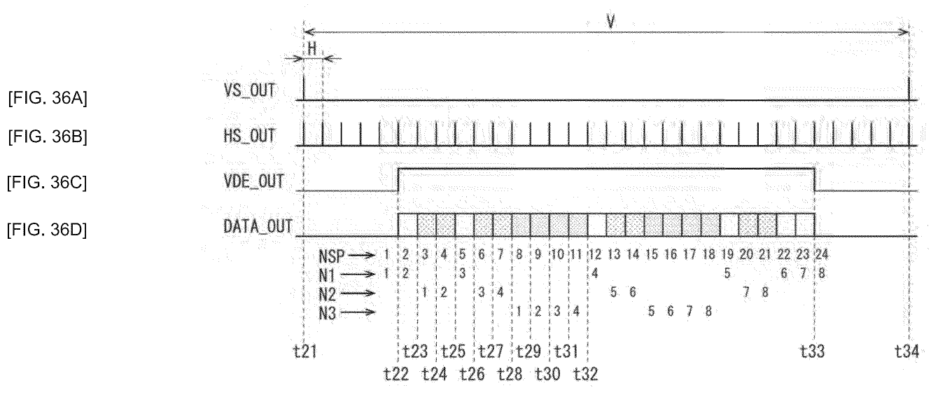

FIGS. 36A, 36B, 36C, and 36D illustrate an example of signals to be outputted from the display controller 26 according to the present modification example in a case where the direction of the head-mounted display 20 does not change and the direction of the eye of the user does not change, where FIG. 36A indicates the waveform of the vertical synchronization signal VS_OUT, FIG. 36B indicates the waveform of the horizontal synchronization signal HS_OUT, FIG. 36C indicates the waveform of the vertical data enable signal VDE_OUT, and FIG. 36D indicates the data signal DATA_OUT. In this example, the direction of the head-mounted display 20 does not change and the direction of the eye of the user does not change; therefore, the predictive processing circuit 29 does not perform the geometric deformation processing as illustrated in FIG. 6 or 7. Accordingly, the data signal DATA_OUT includes pieces of image data related to the entire image P11 and the partial images P2 and P3, and does not include pieces of image data related to the peripheral image P12.

At the timing t21, a pulse of the vertical synchronization signal VS_OUT is generated, and the vertical period V starts (FIG. 36A). In addition, a pulse of the horizontal synchronization signal HS_OUT is generated every time the horizontal period H starts (FIG. 36B).

Thereafter, at the timing t22, the vertical data enable signal VDE_OUT changes from the low level to the high level (FIG. 36C). In this example, the display controller 26 outputs 22 pieces of image data as the data signal DATA_OUT over 22 horizontal periods H (FIG. 36D). In a case where the direction of the head-mounted display 20 does not change and the direction of the eye of the user does not change as with this example, the display controller 26 outputs, as the data signal DATA_OUT, the pieces of image data related to the entire image P11 and the pieces of image data related to the partial images P2 and P3. The 22 pieces of image data included in the data signal DATA_OUT each correspond to a corresponding one of pieces of image data in second to 23rd rows included in the image signal SP illustrated in FIGS. 34B and 35. In FIGS. 36A, 36B, 36C, and 36D, for explanatory convenience, pieces of image data are attached with the data numbers NSP, and N1 to N3.

The display controller 26 performs control to drive the plurality of pixels PIX in the display panel 27 in units of sixteen pixels PIX disposed in four rows and four columns on the basis of the pieces of image data related to the entire image P11 included in the data signal DATA_OUT. In addition, the display controller 26 performs control to drive the plurality of pixels PIX in the display panel 27 in units of four pixels PIX disposed in two rows and two columns on the basis of pieces of data related to the partial image P2 included in the data signal DATA_OUT. In addition, the display controller 26 performs control to drive the plurality of pixels PIX in the display panel 27 in units of one pixel PIX on the basis of pieces of data related to the partial image P3 included in the data signal DATA_OUT.

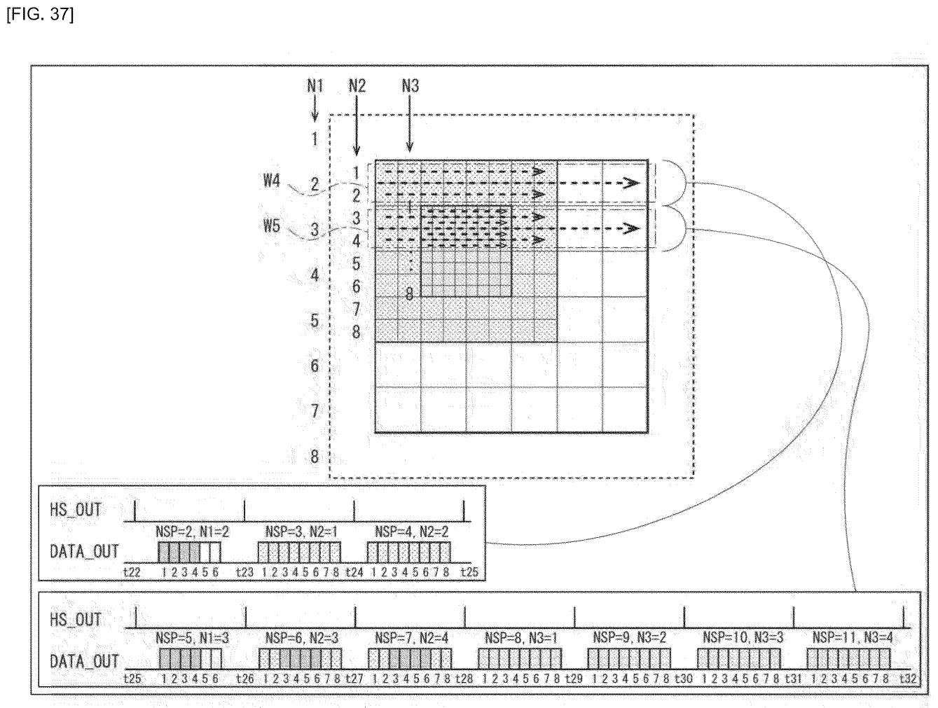

FIG. 37 illustrates an example of the data signal DATA_OUT from the timing t22 to a timing t32 in FIGS. 36A, 36B, 36C, and 36D and a display driving operation based on the data signal DATA_OUT.

The display panel 27 performs a display driving operation on four pixel lines L indicated by a sign W4 in FIG. 37 in a period from the timing t22 to the timing t23.

First, in a period from the timing t22 to the timing t23, as illustrated in FIG. 37, the display controller 26 outputs, as the data signal DATA_OUT, a piece of image data including sixth pixel values related to the entire image P11. The data number NSP of this piece of image data is “2”, and the data number N1 thereof is “2”. The display controller 26 performs control to drive four pixel lines L corresponding to the data number N1=2 in units of sixteen pixels PIX on the basis of this piece of image data.

In this example, as illustrated in FIG. 37, the display controller 26 sets first to fourth pixel values of the six pixel values to a pixel value representing black. The display panel 27 performs control not to write the pixel signal to the pixels PIX corresponding to the first to fourth pixel values.

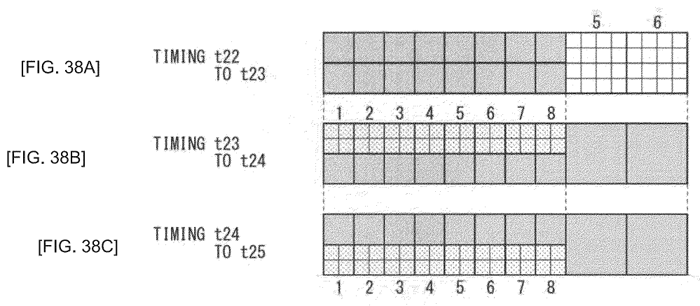

FIGS. 38A, 38B, and 38C illustrate an example of a display driving operation on four pixel lines L indicated by the sign W4 in FIG. 37, where FIG. 38A indicates an operation from the timing t22 to the timing t23, FIG. 38B indicates an operation from the timing t23 to the timing t24, and FIG. 38C indicates an operation from the timing t24 to the timing t25. As illustrated in FIG. 38A, from the timing t22 to the timing t23, the pixel signal generation circuit 32 writes the pixel signals corresponding to fifth and sixth pixel values to the pixels PIX corresponding to these pixel values. In addition, the pixel signal generation circuit 32 does not write the pixel value to the pixels PIX other than these pixels PIX.

In the next period from the timing t23 to the timing t24, as illustrated in FIG. 37, the display controller 26 outputs, as the data signal DATA_OUT, a piece of image data including eight pixel values related to the partial image P2. The data number NSP of this piece of image data is “3”, and the data number N2 thereof is “1”. The display controller 26 knows that this piece of image data includes the pixel values related to the partial image P2, on the basis of the piece of image position data. Thereafter, the display controller 26 performs control to drive two pixel lines L corresponding to the data number N1=2 in units of four pixels PIX on the basis of this piece of image data.

As illustrated in FIG. 38B, from the timing t23 to the timing t24, the pixel signal generation circuit 32 writes the pixel signals corresponding to eight pixel values to the pixels PIX corresponding to these pixel values. In addition, the pixel signal generation circuit 32 does not write the pixel value to the pixels PIX other than these pixels PIX.

An operation in the next period from the timing t24 to the timing t25 is similar to the operation in the period from the timing t23 to the timing t24. As illustrated in FIG. 38C, in the period from the timing t24 to the timing t25, the pixel signal generation circuit 32 writes the pixel signals corresponding to eight pixel values to the pixels PIX corresponding to these pixel values.

Thus, as illustrated in FIGS. 38A, 38B, and 38C, the pixel signal generation circuit 32 writes the pixel signals related to the entire image P11 or the pixel signals related to the partial image P2 to all the pixels PIX in four pixel lines L indicated by the sign W4 in FIG. 37 in the period from the timing t22 to the timing t25.

Next, the display panel 27 performs a display driving operation on four pixel lines L indicated by a sign W5 in FIG. 37 in a period from the timing t25 to the timing t32.

First, in a period from the timing t25 to a timing t26, as illustrated in FIG. 37, the display controller 26 outputs, as the data signal DATA_OUT, a piece of image data including six pixel values related to the entire image P11. The data number NSP of this piece of image data is “5”, and the data number N1 thereof is “3”. The display controller 26 performs control to drive four pixel lines L corresponding to the data number N1=3 in units of sixteen pixels PIX on the basis of this piece of image data.

In this example, as illustrated in FIG. 37, the display controller 26 sets first to fourth pixel values of the six pixel values to the pixel value representing black. The display panel 27 performs control not to write the pixel signal to the pixels PIX corresponding to the first to fourth pixel values.

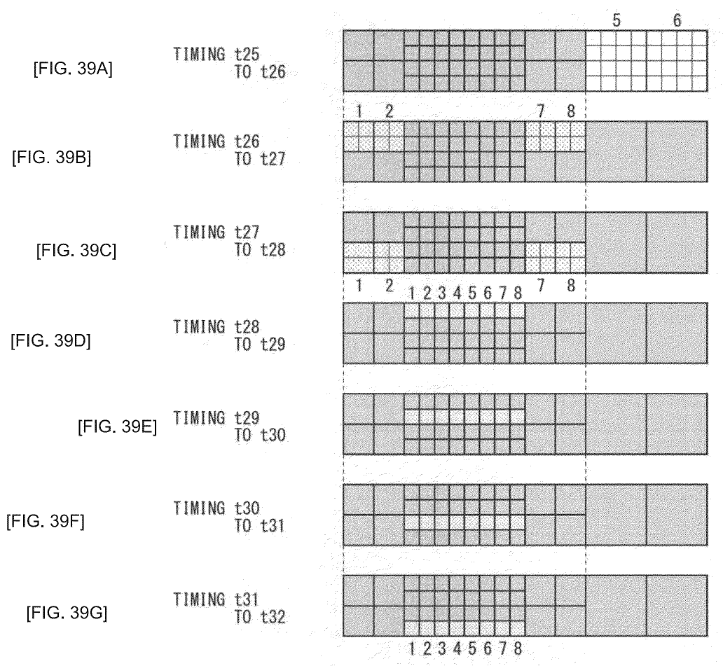

FIGS. 39A, 39B, 39C, 39D, 39E, 39F, and 39G illustrate an example of a display driving operation on four pixel lines L indicated by the sign W5 in FIG. 37, where FIG. 39A indicates an operation from the timing t25 to the timing t26, FIG. 39B indicates an operation from the timing t26 to a timing t27, FIG. 39C indicates an operation from the timing t27 to a timing t28, FIG. 39D indicates an operation from the timing t28 to a timing t29, FIG. 39E indicates an operation from the timing t29 to a timing t30, FIG. 39F indicates an operation from the timing t30 to a timing t31, and FIG. 39G indicates an operation from the timing t31 to the timing t32. As illustrated in FIG. 39A, from the timing t25 to the timing t26, the pixel signal generation circuit 32 writes the pixel signals corresponding to fifth and sixth pixel values to the pixels PIX corresponding to these pixel values. In addition, the pixel signal generation circuit 32 does not write the pixel value to the pixels PIX other than these pixels PIX.

In the next period from the timing t26 to the timing t27, as illustrated in FIG. 37, the display controller 26 outputs, as the data signal DATA_OUT, a piece of image data including eight pixel values related to the partial image P2. The data number NSP of this piece of image data is “6”, and the data number N2 thereof is “3”. The display controller 26 knows that this piece of image data includes the pixel values related to the partial image P2, on the basis of the piece of image position data. Thereafter, the display controller 26 performs control to drive two pixel lines L corresponding to the data number N2=3 in units of four pixels PIX on the basis of this piece of image data.

In this example, as illustrated in FIG. 37, the display controller 26 sets third to sixth pixel values of the eight pixel values to the pixel value representing black. The display panel 27 performs control not to write the pixel signal to the pixels PIX corresponding to the third to sixth pixel values.

As illustrated in FIG. 39B, from the timing t26 to the timing t27, the pixel signal generation circuit 32 writes the pixel signals corresponding to first, second, seventh, and eighth pixel values to the pixels PIX corresponding to these pixel values. In addition, the pixel signal generation circuit 32 does not write the pixel value to the pixels PIX other than these pixels PIX.

An operation in the next period from the timing t27 to the timing t28 is similar to the operation in the period from the timing t26 to the timing t27. As illustrated in FIG. 39C, in the period from the timing t27 to the timing t28, the pixel signal generation circuit 32 writes the pixel signals corresponding to first, second, seventh and eighth pixel values to the pixels PIX corresponding to these pixel values.

In a period from the timing t28 to the timing t29, as illustrated in FIG. 37, the display controller 26 outputs, as the data signal DATA_OUT, a piece of image data including eight pixel values related to the partial image P3. The data number NSP of this piece of image data is “8”, and the data number N3 thereof is “1”. The display controller 26 knows that this piece of image data includes the pixel values related to the partial image P3, on the basis of the piece of image position data. Thereafter, the display controller 26 performs control to drive one pixel line L corresponding to the data number N3=1 in units of one pixel PIX on the basis of this piece of image data.

As illustrated in FIG. 39D, from the timing t28 to the timing t29, the pixel signal generation circuit 32 writes the pixel signals corresponding to eight pixel values to the pixels PIX corresponding to these pixel values. In addition, the pixel signal generation circuit 32 does not write the pixel value to the pixels PIX other than these pixels PIX.

Operations in a period from the timing t29 to the timing t30, a period from the timing t30 to the timing t31, and a period from the timing t31 to the timing t32 are similar to the operation in the period from the timing t28 to the timing t29. As illustrated in FIGS. 39E, 39F, and 39G, in each of the period from the timing t29 to the timing t30, the period from the timing t30 to the timing t31, and the period from the timing t31 to the timing t32, the pixel signal generation circuit 32 writes the pixel signals corresponding to eight pixel values to the pixels PIX corresponding to these pixel values.

Thus, as illustrated in FIGS. 39A, 39B, 39C, 39D, 39E, 39F, and 39G, the pixel signal generation circuit 32 writes the pixel signals related to the entire image P11, the pixel signals related to the partial image P2, or the pixel signals related to the partial image P3 to all the pixels PIX in four pixel lines L indicated by the sign W5 in FIG. 37 in the period from the timing t25 to the timing t32.

As illustrated in FIGS. 36A, 36B, 36C, and 36D, also after this, the display controller 26 and the display panel 27 operate similarly. Thereafter, at a timing t33, the vertical data enable signal VDE_OUT changes from the high level to the low level (FIG. 36C). Thereafter, at a timing t35, this vertical period V ends, and the next vertical period V starts.

### Other Modification Examples

In addition, two or more of these modification examples may be combined.

### 2. Second Embodiment

Next, description is given of a display system 2 according to a second embodiment. The present embodiment differs from the first embodiment described above in the structure of pieces of image data in the image signal SP. It is to be noted that components substantially the same as those of the display system 1 according to the first embodiment described above are denoted by the same reference signs, and description thereof is omitted as appropriate.

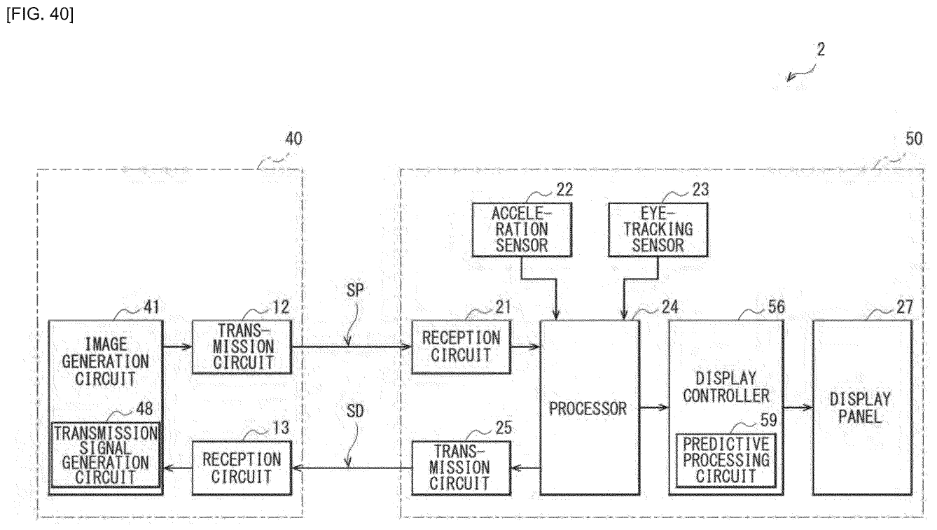

FIG. 40 illustrates a configuration example of the display system 2 according to the present embodiment. The display system 2 includes an image generation device 40 and a head-mounted display 50.

The image generation device 40 includes an image generation circuit 41. The image generation circuit 41 includes a transmission signal generation circuit 48. The transmission signal generation circuit 48 is configured to generate the image signal SP to be transmitted, on the basis of an image generated by the image generation circuit 41.

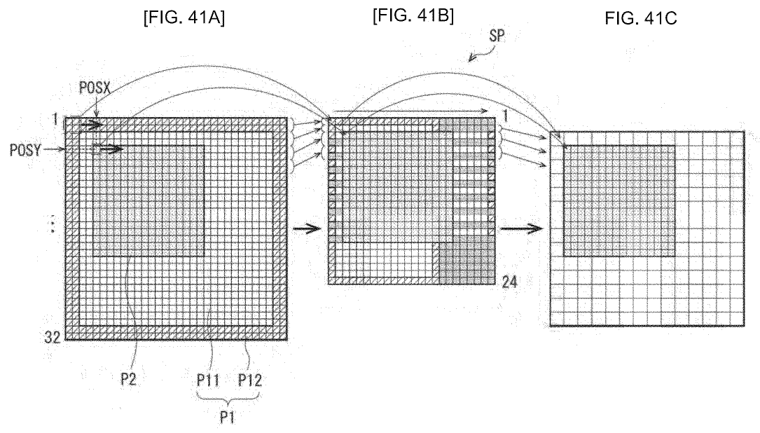

FIGS. 41A, 41B, and 41C illustrate an operation example of the display system 2, where FIG. 41A indicates an image generated by the image generation circuit 41, FIG. 41B indicates pieces of image data included in the image signal SP, and FIG. 41C indicates a display driving operation in the head-mounted display 50.

As illustrated in FIGS. 41A and 41B, the transmission signal generation circuit 48 performs left-to-right scanning from top to bottom sequentially on the image P1 generated by the image generation circuit 41 to thereby generate the image signal SP. The transmission signal generation circuit 48 converts four pixel values disposed in two rows and two columns in a portion not overlapping the partial image P2 of the image P1 into one pixel value, and outputs one pixel value as it is in a portion overlapping the partial image P2 of the image P1, thereby generating pieces of image data in the image signal SP.

Specifically, in this example, the transmission signal generation circuit 48 converts four pixel values disposed in two rows and two columns into one pixel value on the basis of 64 pixel values included in a first row and a second row of the image P1 to thereby generate sixteen pixel values related to the peripheral image P12. Thereafter, the transmission signal generation circuit 48 generates eight pixel values representing black. Thus, the transmission signal generation circuit 48 generates a piece of image data in a first row in the image signal SP.

In addition, the transmission signal generation circuit 48 converts four pixel values disposed in two rows and two columns into one pixel value on the basis of 64 pixel values included in third and fourth rows of the image P1 to thereby generate one pixel values related to the peripheral image P12, fourteen pixel values related to the entire image P11, and one pixel value related to the peripheral image P12. Thereafter, the transmission signal generation circuit 48 generates eight pixel values representing black. Thus, the transmission signal generation circuit 48 generates a piece of image data in a second row in the image signal SP.

In addition, the transmission signal generation circuit 48 converts four pixel values disposed in two rows and two columns into one pixel value on the basis of eight pixel values belonging to first to fourth columns of 64 pixel values included in fifth and sixth rows of the image P1 to thereby generate one pixel value related to the peripheral image P12 and one pixel value related to the entire image P11. The transmission signal generation circuit 48 outputs sixteen pixel values related to the partial image P2 of 32 pixel values included in the fifth row of the image P1 as they are. The transmission signal generation circuit 48 converts four pixel values disposed in two rows and two columns into one pixel value on the basis of 20 pixel values belonging to 21st to 32nd columns of the 64 pixel values included in the fifth and sixth rows of the image P1 to thereby generate five pixel values related to the entire image P11 and one pixel value related to the peripheral image P12. Thus, the transmission signal generation circuit 48 generates a piece of image data in a third row in the image signal SP.

In addition, the transmission signal generation circuit 48 generates two pixel values representing black. The transmission signal generation circuit 48 outputs sixteen pixel values related to the partial image P2 of 32 pixel values included in the sixth row of the image P1 as they are. Thereafter, the transmission signal generation circuit 48 generates six pixel values representing black. Thus, the transmission signal generation circuit 48 generates a piece of image data in a fourth row in the image signal SP.

In this example, the transmission signal generation circuit 48 converts four pixel values disposed in two rows and two columns in the portion not overlapping the partial image P2 of the image P1 into one pixel value. Accordingly, the converted image P1 does not include an image corresponding to the partial image P2. The transmission signal generation circuit 48 converts the portion not overlapping the partial image P2 of the image P1 into the image P1 having a lower resolution. Meanwhile, the resolution of the partial image P2 is not changed. As a result, the resolution of the converted image P1 becomes lower than the resolution of the partial image P2. In the example in FIGS. 41A, 41B, and 41C, the transmission signal generation circuit 48 performs left-to-right scanning from top to bottom sequentially to thereby generate the image signal SP; therefore, as illustrated in FIG. 41B, for example, in the image signal SP, one or a plurality of pixel values related to the image P1 and one or a plurality of pixel values related to the partial image P2 are alternately disposed.

Thus, the transmission signal generation circuit 48 generates pieces of image data including a plurality of pixel values as illustrated in FIG. 41B, on the basis of the image generated by the image generation circuit 41. The pieces of image data include pixel values representing black. Thereafter, the transmission signal generation circuit 48 generates the image signal SP including the pieces of image data and the piece of image position data representing the position (parameters POSX and POSY) of the partial image P2 in the image P1.

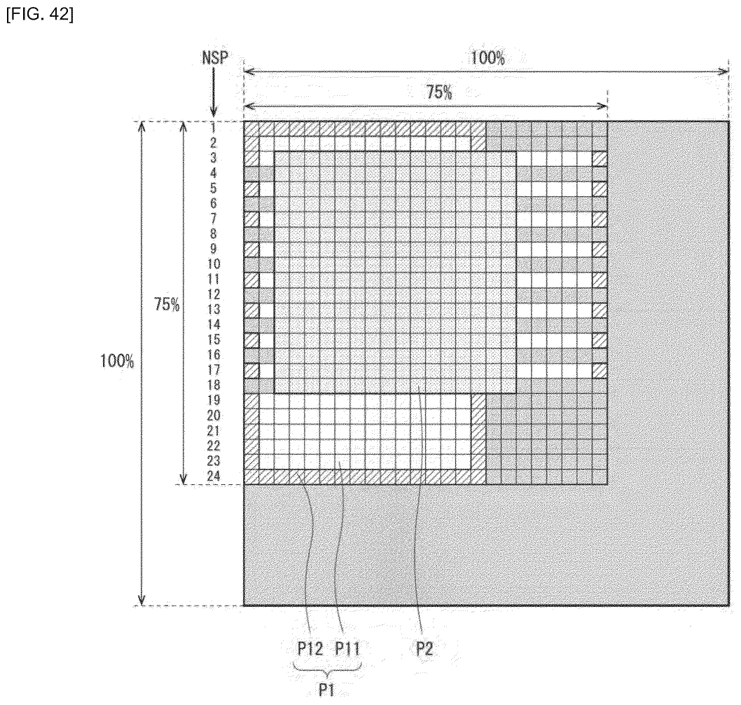

FIG. 42 illustrates a transmission band in the display system 2. In FIG. 42, an unshaded portion indicates the entire image P11, a portion shaded with diagonal lines indicates the peripheral image P12, and a portion shaded with dots indicates the partial image P2. In addition, a dark-shaded pixel value indicates a black pixel value. The pieces of image data included in the image signal SP in this example include pieces of image data for 24 rows. For explanatory convenience, each of the pieces of image data for 24 rows is attached with the data number NSP.

The number of pixel values in the pieces of image data included in the image signal SP is 56.25% (=0.75×0.75) of the number of pixel values included in the image P1. Thus, it is possible for the display system 2 to reduce an image data amount, as compared with a case where the image P1 before conversion is transmitted as it is.

The head-mounted display 50 (FIG. 40) includes a display controller 56. The display controller 56 is configured to control an operation of display panel 27 on the basis of the pieces of image data and the piece of image position data supplied from the processor 24. The display controller 56 includes a predictive processing circuit 59. The predictive processing circuit 59 is configured to generate a piece of display image data by performing the geometric deformation processing on the pieces of image data supplied from the processor 24, on the basis of a result of detection by the acceleration sensor 22 and a result of detection by the eye-tracking sensor 23.

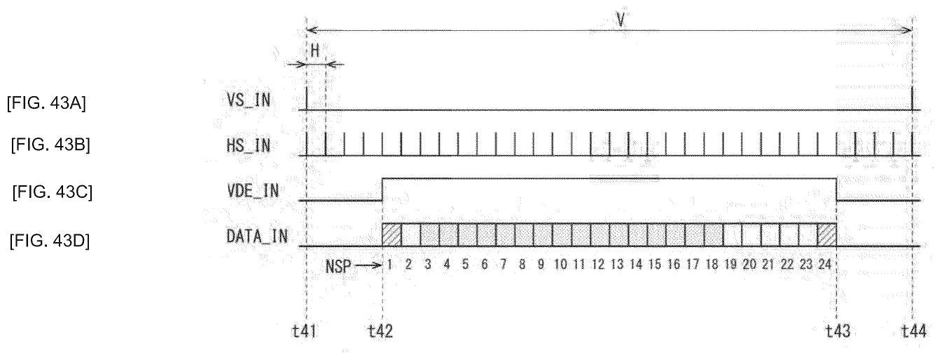

FIGS. 43A, 43B, 43C, and 43D illustrate an example of signals to be inputted to the display controller 56, where FIG. 43A indicates a waveform of the vertical synchronization signal VS_IN, FIG. 43B indicates a waveform of the horizontal synchronization signal HS_IN, FIG. 43C indicates a waveform of the vertical data enable signal VDE_IN, and FIG. 43D indicates the data signal DATA_IN.

At a timing t41, a pulse of the vertical synchronization signal VS_IN is generated, and the vertical period V starts (FIG. 43A). In addition, a pulse of the horizontal synchronization signal HS_IN is generated every time the horizontal period H starts (FIG. 43B).

Thereafter, at a timing t42, the vertical data enable signal VDE_IN changes from the low level to the high level (FIG. 43C). In this example, the data signal DATA_IN is supplied over 24 horizontal periods H. The data signal DATA_IN includes 24 pieces of image data corresponding to 24 horizontal periods H. The 24 pieces of image data each correspond to a corresponding one of pieces of image data (with the data number NSP=1 to 24) for 24 rows included in the image signal SP illustrated in FIG. 42.

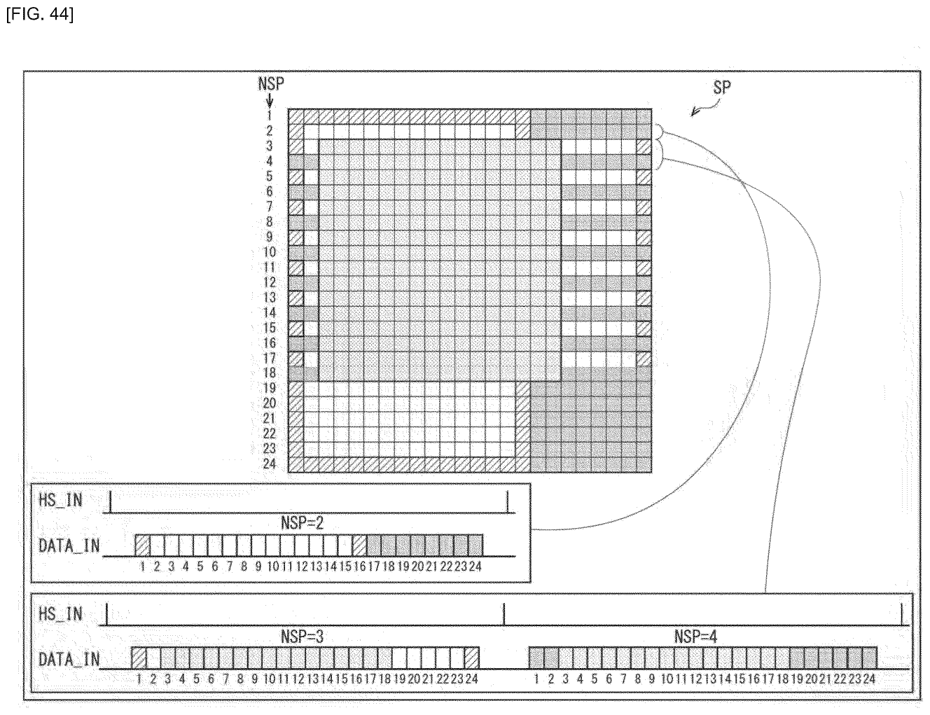

FIG. 44 illustrates an example of the data signal DATA_IN. For example, the piece of image data in the second row included in the image signal SP corresponds to a second piece of image data of the 24 pieces of image data included in the data signal DATA_IN. This piece of image data includes one pixel value related to the peripheral image P12, fourteen pixel values related to the entire image P11, one pixel value related to the peripheral image P12, and eight pixel values representing black. For example, the piece of image data in the third row included in the image signal SP corresponds to a third piece of image data of the 24 pieces of image data included in the data signal DATA_IN. This piece of image data includes one pixel value related to the peripheral image P12, one pixel value related to the entire image P11, sixteen pixel values related to the partial image P2, five pixel values related to the entire image P11, and one pixel value related to the peripheral image P12. For example, the piece of image data in the fourth row included in the image signal SP corresponds to a fourth piece of image data of the 24 pieces of image data included in the data signal DATA_IN. This piece of image data includes two pixel values representing black, sixteen pixel values related to the partial image P2, and six pixel values representing black.

Thereafter, at a timing t43, the vertical data enable signal VDE_IN changes from the high level to the low level (FIG. 43C). Thereafter, at a timing t44, this vertical period V ends, and the next vertical period V starts.

The predictive processing circuit 59 of the display controller 56 performs the geometric deformation processing on the pieces of image data supplied from the processor 24 on the basis of the result of detection by the acceleration sensor 22 and the result of detection by the eye-tracking sensor 23 to thereby generate a piece of display image data. Thereafter, the display controller 56 generates the vertical synchronization signal VS_OUT, the horizontal synchronization signal HS_OUT, the vertical data enable signal VDE_OUT, and the data signal DATA_OUT on the basis of the piece of display image data.

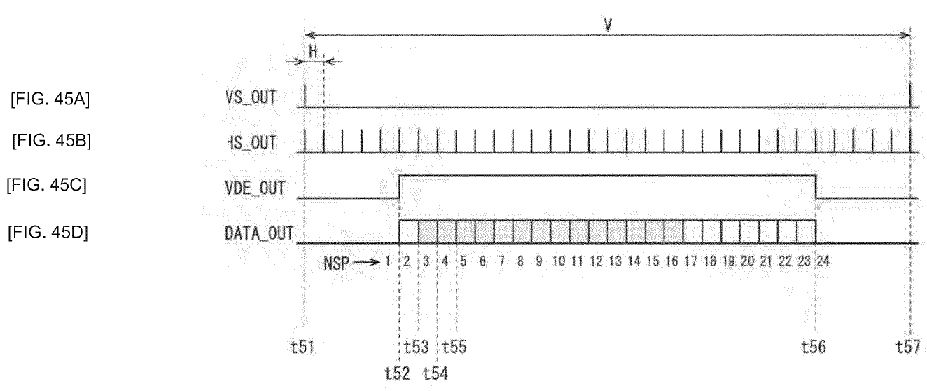

FIGS. 45A, 45B, 45C, and 45D illustrate an example of signals to be outputted from the display controller 56 in a case where the direction of the head-mounted display 50 does not change and the direction of the eye of the user does not change, where FIG. 45A indicates a waveform of the vertical synchronization signal VS_OUT, FIG. 45B indicates a waveform of the horizontal synchronization signal HS_OUT, FIG. 45C indicates a waveform of the vertical data enable signal VDE_OUT, and FIG. 45D indicates the data signal DATA_OUT. In FIG. 45D, an unshaded portion indicates the entire image P11, and a portion shaded with dots indicates the partial image P2. In other words, in this example, the direction of the head-mounted display 50 does not change, and the direction of the eye of the user does not change; therefore, the predictive processing circuit 59 does not perform the geometric deformation processing as illustrated in FIG. 6 or 7. Accordingly, the data signal DATA_OUT includes the pieces of image data related to the entire image P11 and the partial image P2, and does not include the pieces of image data related to the peripheral image P12.

As with a case in FIG. 44, at a timing t51, a pulse of the vertical synchronization signal VS_OUT is generated, and the vertical period V starts (FIG. 45A). In addition, a pulse of the horizontal synchronization signal HS_OUT is generated every time the horizontal period H starts (FIG. 45B).

Thereafter, at a timing t52, the vertical data enable signal VDE_OUT changes from the low level to the high level (FIG. 45C). In this example, the display controller 56 outputs 22 pieces of image data as the data signal DATA_OUT over 22 horizontal periods H (FIG. 45D). In a case where the direction of the head-mounted display 50 does not change and the direction of the eye of the user does not change as with this example, the display controller 56 outputs, as the data signal DATA_OUT, the pieces of image data related to the entire image P11 and the pieces of image data related to the partial image P2. The 22 pieces of image data included in the data signal DATA_OUT each correspond to a corresponding one of 22 pieces from second to 23rd pieces of image data in the data signal DATA_IN (FIGS. 43A, 43B, 43C, and 43D). In other words, the 22 pieces of image data each correspond to a corresponding one of the pieces of image data in second to 23rd rows included in the image signal SP illustrated in FIG. 41B and FIG. 42. In FIGS. 45A, 45B, 45C, and 45D, for explanatory convenience, each of pieces of image data is attached with the data number NSP.

The display controller 56 performs control to drive the plurality of pixels PIX in the display panel 27 in units of four pixels PIX disposed in two rows and two columns on the basis of the pieces of image data related to the entire image P1 included in the data signal DATA_OUT. In addition, the display controller 56 performs control to drive the plurality of pixels PIX in the display panel 27 in units of one pixel PIX on the basis of the pieces of data related to the partial image P2 included in the data signal DATA_OUT.

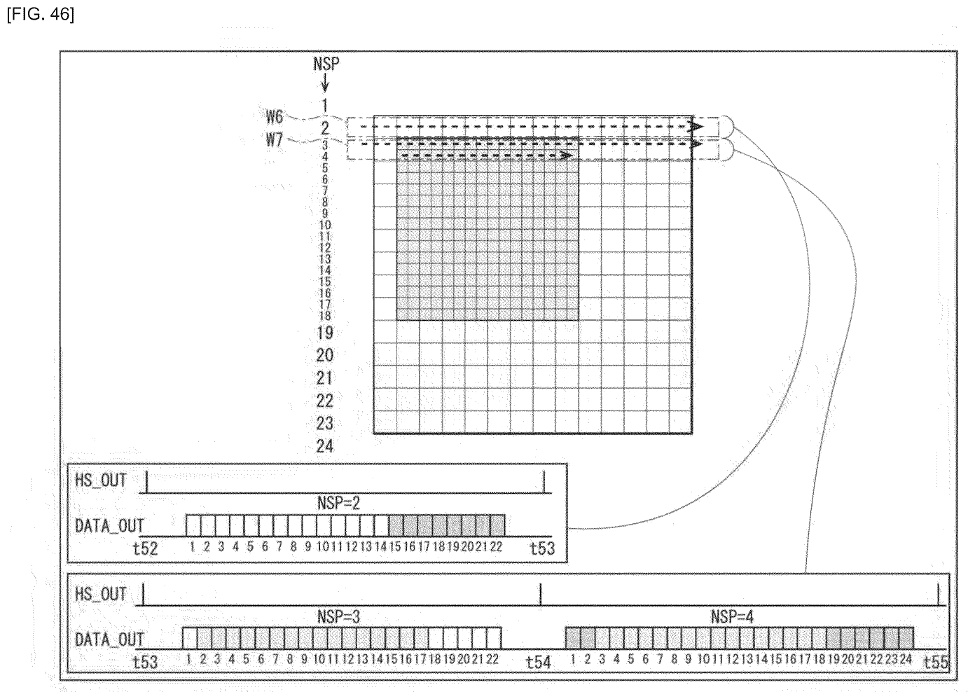

FIG. 46 illustrates an example of the data signal DATA_OUT from the timing t52 to a timing t55 in FIGS. 45A, 45B, 45C, and 45D, and a display driving operation based on the data signal DATA_OUT.

The display panel 27 performs a display driving operation on two pixel lines L indicated by a sign W6 in FIG. 46 in a period from the timing t52 to a timing t53.

In this period from the timing t52 to the timing t53, as illustrated in FIGS. 43A, 43B, 43C, and 43D, the display controller 56 outputs, as the data signal DATA_OUT, a piece of image data including fourteen pixel values related to the entire image P11 and eight pixel values representing black. The data number NSP of this piece of image data is “2”. In other words, as illustrated in FIG. 44, the piece of image data with the data number NSP of “2” included in the image signal SP includes one pixel value related to the peripheral image P12, fourteen pixel values related to the entire image P11, one pixel value related to the peripheral image P12, and eight pixel values representing black, therefore, the display controller 56 outputs, as the data signal DATA_OUT, a piece of image data including fourteen pixel values corresponding to the fourteen pixel values related to the entire image P11 and the eight pixel values representing black of these pixel values. The display controller 56 performs control to drive two pixel lines L corresponding to the data number NSP=2 in units of four pixels PIX on the basis of the fourteen pixel values.

Thus, the pixel signal generation circuit 32 writes a pixel signal related to the entire image P1 to two pixel lines L indicated by the sign W6 in FIG. 46

Next, the display panel 27 performs the display driving operation on two pixel lines L indicated by a sign W7 in FIG. 46 in a period from the timing t53 to the timing t55.

First, in a period from the timing t53 to a timing t54, as illustrated in FIG. 46, the display controller 56 outputs, as the data signal DATA_OUT, a piece of image data including one pixel value related to the entire image P11 that is a first pixel value, sixteen pixel values related to the partial image P2 that are second to seventeenth pixel values, and five pixel values related to the entire image P11 that are eighteenth to 22nd pixel values. The data number NSP of this piece of image data is “3”. In other words, as illustrated in FIG. 44, the piece of image data with the data number NSP of “3” included in the image signal SP includes one pixel value related to the peripheral image P12, one pixel value related to the entire image P11, sixteen pixel values related to the partial image P2, five pixel values related to the entire image P11, and one pixel value related to the peripheral image P12; therefore, the display controller 56 outputs, as the data signal DATA_OUT, the one pixel value related to the entire image P11, the sixteen pixel values related to the partial image P2, and the five pixel values related to the entire image P11 of these pixel values. The display controller 56 knows that this piece of image data includes the pixel values related to the partial image P2, on the basis of the piece of image position data. Thereafter, the display controller 56 performs control to drive two pixel lines L corresponding to the data number NSP=3 and 4 in units of four pixels PIX on the basis of a total of six (one and five) pixel values related to the entire image P11. In addition, the display controller 56 performs control to drive the two pixel lines L corresponding to the data number NSP=3 and 4 in units of two pixels PIX on the basis of the sixteen pixel values related to the partial image P2.

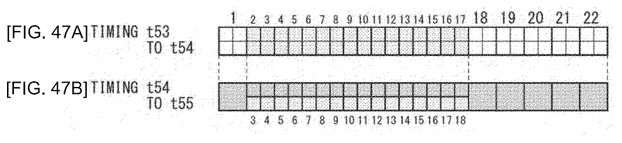

FIGS. 47A and 47B illustrate an example of a display driving operation on two pixel lines L indicated by the sign W7 in FIG. 46, where FIG. 47A indicates an operation from the timing t53 to the timing t54, and FIG. 47B indicates an operation from the timings t54 to the timing t55. As illustrated in (FIG. 47A), from the timing t53 to the timing t54, the pixel signal generation circuit 32 writes the pixel signals corresponding to the first to 22nd pixel values to the pixels PIX corresponding to these pixel values.

In the next period from the timing t54 to the timing t55, as illustrated in FIG. 46, the display controller 56 outputs, as the data signal DATA_OUT, a piece of image data including two pixel values representing black that are first and second pixel values, sixteen pixel values related to the partial image P2 that are third to eighteenth pixel values, and six pixel values representing black that are nineteenth to 24th pixel values. The data number NSP of this piece of image data is “4”. In other words, as illustrated in FIG. 44, the piece of image data with the data number NSP of “4” included in the image signal SP includes two pixel values representing black, sixteen pixel values related to the partial image P2, and six pixel values representing black; therefore, the display controller 56 outputs, as the data signal DATA_OUT, the two pixel values representing black, the sixteen pixel values related to the partial image P2, and the six pixel values representing black. The display controller 56 knows that this piece of image data includes the pixel values related to the partial image P2, on the basis of the piece of image position data. Thereafter, the display controller 56 performs control to drive one pixel line L corresponding to the data number NSP=4 in units of one pixel PIX on the basis of the sixteen pixel values related to the partial image P2.

As illustrated in FIG. 47B, from the timing t54 to the timing t55, the pixel signal generation circuit 32 writes the pixel signals corresponding to the sixteen pixel values that are the third to eighteenth pixel values to the pixels PIX corresponding to these pixel values. In addition, the pixel signal generation circuit 32 does not write the pixel value to the pixels PIX other than these pixels PIX.

Thus, as illustrated in FIGS. 47A and 47B, the pixel signal generation circuit 32 writes the pixel signals related to the entire image P11 or the pixel signals related to the partial image P2 to all the pixels PIX in two pixel lines L indicated by the sign W7 in FIG. 46 in the period from the timing t53 to the timing t55.

As illustrated in FIGS. 45A, 45B, 45C, and 45D, also after this, the display controller 56 and the display panel 27 operate similarly. Thereafter, at a timing t56, the vertical data enable signal VDE_OUT changes from the high level to the low level (FIG. 45C). Thereafter, at a timing t57, this vertical period V ends, and the next vertical period V starts.

Thus, in the display system 2, the reception circuit 21 receives a piece of first image data representing the entire image P11 having a first resolution, a piece of second image data representing the peripheral image P12 having a second resolution lower than or equal to the first resolution, and a piece of third image data representing the partial image P2 having a third resolution higher than the first resolution. The peripheral image P12 is an image outside the entire image P11. The partial image P2 is an image having an image range narrower than that of the entire image P11. The acceleration sensor 22 detects a change in orientation of the head-mounted display 50. The display controller 56 performs the geometric deformation processing on the piece of first image data, the piece of second image data, and the piece of third image data on the basis of the result of detection by the acceleration sensor 22 to thereby perform the first image processing for generating a piece of display image data. Thereafter, the pixel signal generation circuit 32 and the scanning circuit 33 drive the pixel array 31 that is configured to display an image having the same image range as the image range of the entire image P11, on the basis of the piece of display image data. Accordingly, as with the head-mounted display 20 according to the first embodiment, in the head-mounted display 50, it is possible to reduce the latency.

### Modification Example 2

The modification example 1-1, 1-2 or 1-3 of the first embodiment described above may be applied to the display system 2 according to the embodiment described above.

### 3. Third Embodiment

Next, description is given of a display system 3 according to a third embodiment. The present embodiment differs from the first embodiment described above in the structure of pieces of image data in the image signal SP. It is to be noted that components substantially the same as those of the display system 1 according to the first embodiment described above are denoted by the same reference signs, and description thereof is omitted as appropriate.

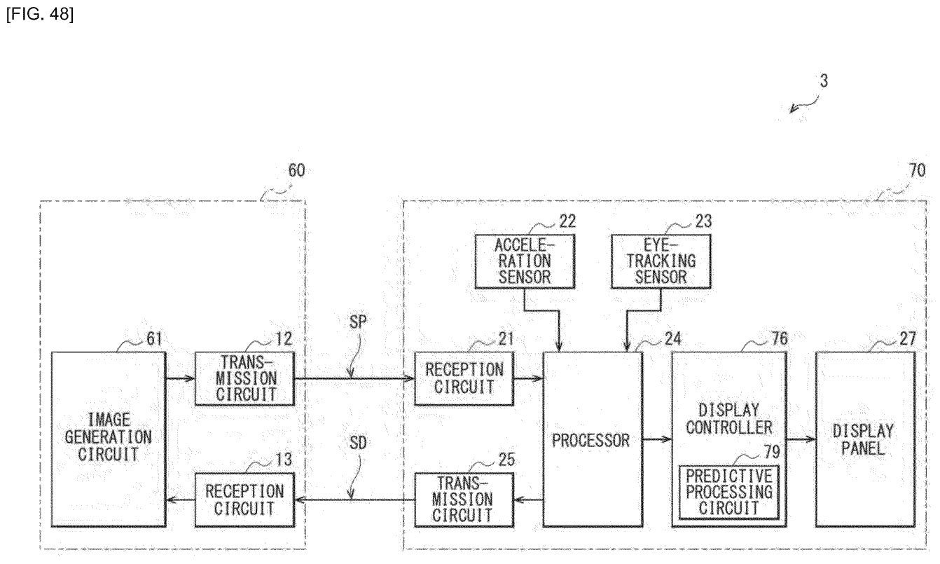

FIG. 48 illustrates a configuration example of the display system 3 according to the present embodiment. The display system 3 includes an image generation device 60 and a head-mounted display 70.

The image generation device 60 includes an image generation circuit 61. The image generation circuit 61 is configured to generate an image to be displayed on the head-mounted display 70 by performing, for example, a predetermined processing such as a rendering processing. The image generation circuit 61 generates the entire image P11 representing a scenery corresponding to the direction of the head-mounted display 70 in a virtual space on the basis of a result of detection by the acceleration sensor 22 included in a piece of data supplied from the reception circuit 13. In addition, the image generation circuit 61 generates the peripheral image P12 that is an image outside the entire image P11. The entire image P11 and the peripheral image P12 configure the image P1. In addition, the image generation circuit 61 generates the partial image P2 representing a portion at which the user is looking of the scenery corresponding to the direction of the head-mounted display 70 in the virtual space on the basis of a result of detection by the eye-tracking sensor 23 included in the piece of data supplied from the reception circuit 13.

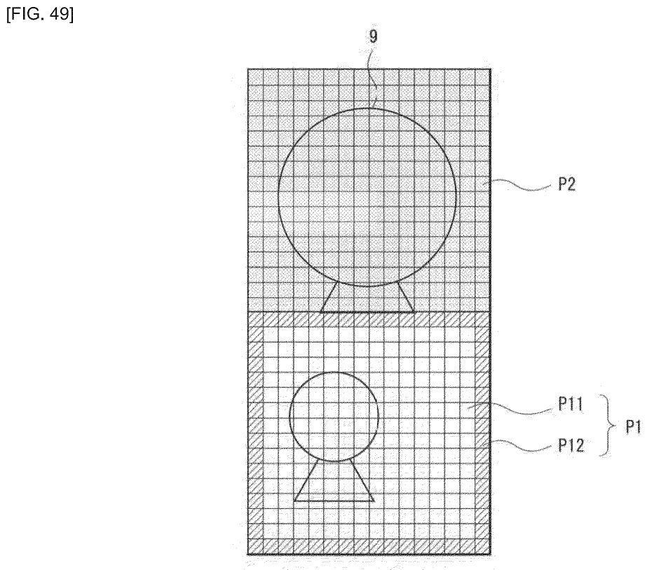

FIG. 49 illustrates an example of the image P1 and the partial image P2 generated by the image generation circuit 61. The image P1 corresponds to an image corresponding to the image P1 converted by the transmission signal generation circuit 18 according to the first embodiment described above, and is an image having a low resolution. The partial image P2 is an image having a high resolution. In this example, each pixel in the image P1 corresponds to four pixels PIX in the head-mounted display 70, and each pixel in the partial image P2 corresponds to one pixel PIX in the head-mounted display 70. In this example, the number of pixels in the image P1 and the number of pixels in the partial image P2 are equal to each other.

The image generation circuit 61 generates the image signal SP to be transmitted, on the basis of such an image. Thereafter, the transmission circuit 12 (FIG. 48) transmits the image signal SP supplied from the image generation circuit 61 to the head-mounted display 70.

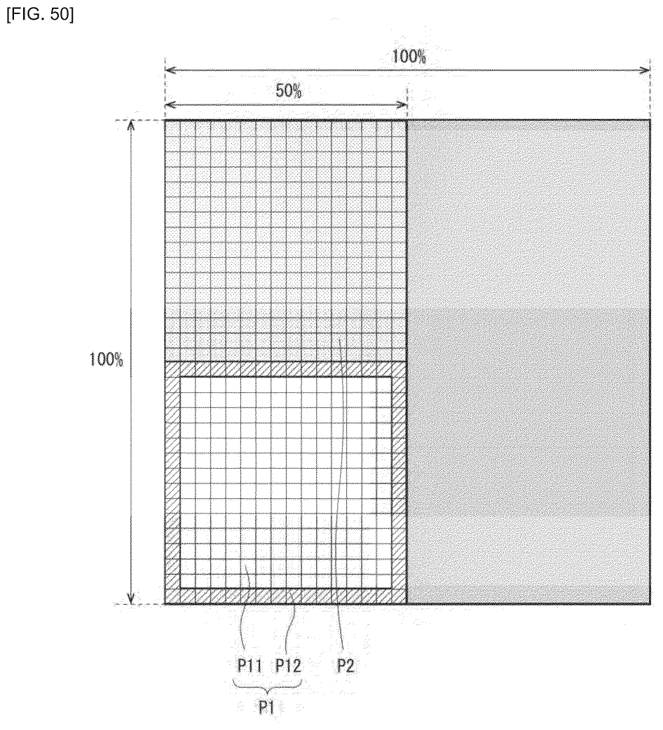

FIG. 50 illustrates a transmission band in the display system 3. In FIG. 50, an unshaded portion indicates to the entire image P11, a portion shaded with diagonal lines indicates the peripheral image P12, and a portion shaped with dots indicates the partial image P2. Thus, it is possible for the display system 3 to reduce an image data amount to a half, as compared with a case where the pixel values of all the pixels PIX in the display panel 27 are transmitted as they are.

The head-mounted display 70 (FIG. 48) includes a display controller 76. The display controller 76 is configured to control an operation of display panel 27 on the basis of the pieces of image data and the piece of image position data supplied from the processor 24. The display controller 76 includes a predictive processing circuit 79. The predictive processing circuit 79 is configured to generate a piece of display image data by performing the geometric deformation processing on the pieces of image data supplied from the processor 24 on the basis of a result of detection by the acceleration sensor 22 and a result of detection by the eye-tracking sensor 23. The display controller 76 controls the operation of the display panel 27 on the basis of the piece of display image data.

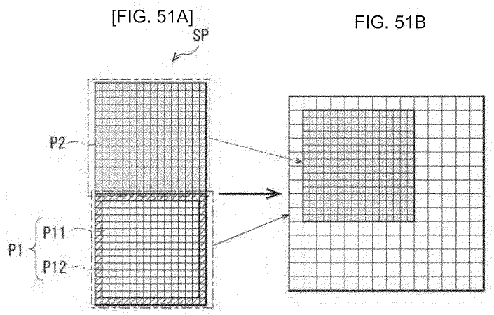

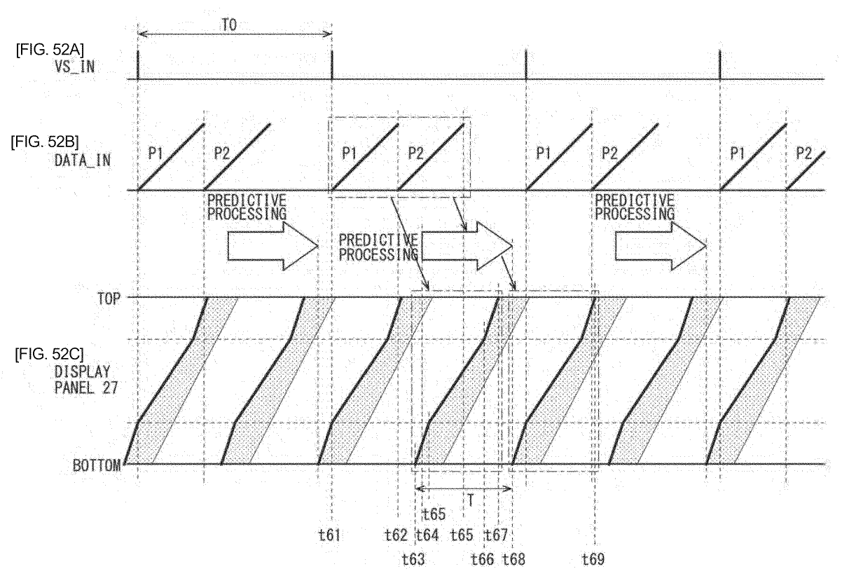

FIGS. 51A and 51B illustrate an operation example of the head-mounted display 70, where FIG. 51A indicates pieces of image data included in the image signal SP, and FIG. 51B indicates a display driving operation in the head-mounted display 70.

The predictive processing circuit 79 of the display controller 76 performs the geometric deformation processing on the pieces of image data supplied from the processor 24 on the basis of the result of detection by the acceleration sensor 22 and the result of detection by the eye-tracking sensor 23 to thereby generate a piece of display image data. Thereafter, the display controller 76 drives the plurality of pixels PIX in the display panel 27 in units of four pixels PIX on the basis of a piece of display image data generated on the basis of the image P1. In addition, the display controller 76 drives a plurality of pixels PIX at a position corresponding to the partial image P2 of the plurality of pixels PIX in the display panel 27 in units of one pixel PIX on the basis of a piece of display image data generated on the basis of the partial image P2.

FIGS. 52A, 52B, and 52C illustrate an operation example of the head-mounted display 70, where FIG. 52A indicates a waveform of the vertical synchronization signal VS_IN to be inputted to the display controller 76, FIG. 52B indicates the data signal DATA_IN to be inputted to the display controller 76, and FIG. 52C indicates the operation of the display panel 27. In this example, a frame rate is 120 Hz. In this case, the cycle T of the display operation in the display panel 27 is 8.3 [msec.](= 1/120 [Hz]). In addition, the cycle TO of the rendering processing in the image generation circuit 61 is 16.7 [msec.](= 1/60 [Hz]).

At a timing t61, a pulse of the vertical synchronization signal VS_IN is generated, and the vertical period V starts (FIG. 52A). Thereafter, in a period from the timing t61 to a timing t62, a piece of image data of the image P1 is supplied to the display controller 76, and in a period from the timing t62 to a timing t65, a piece of image data of the partial image P2 is supplied to the display controller 76 (FIG. 52B).

The display controller 76 generates a piece of display image data on the basis of the piece of image data of the entire image P11 and the piece of image data of the partial image P2 in the supplied image P1. Thereafter, in a period from the timing t63 to a timing t67, the display controller 76 controls the operation of the display panel 27 on the basis of the piece of display image data generated.

In this example, the scanning circuit 33 of the display panel 27 performs scanning in scanning units of one pixel line L or two pixel lines L from the top to the bottom of the pixel array 31. In this example, in a period from a timing t63 to a timing t65 and a period from a timing t66 to a timing t67, the scanning speed is fast, and in a period from the timing t65 to the timing t66, the scanning speed is slow. In other words, in the period from the timing t65 to the timing t66, the scanning circuit 33 scans a plurality of pixel lines L corresponding to the position of the partial image P2. In this case, the pixel signal generation circuit 32 performs scanning in scanning units of one pixel line L; therefore, the scanning speed is slow. In contrast, in the period from the timing t63 to the timing t65 and the period from the timing t66 to the timing t67, the pixel signal generation circuit 32 performs scanning in scanning units of two pixel lines L; therefore, the scanning speed is fast. Thus, in the display panel 27, scanning is performed in scanning units of one pixel line L or two pixel lines L, which makes it possible to decrease an operation frequency and reduce power consumption, as compared with, for example, a case where scanning is performed in scanning units of one pixel line L.

Thereafter, as indicated by a shaded portion in FIGS. 52A, 52B, and 52C, the pixel PIX to which the pixel signal is written emits light over a predetermined period after the pixel signal is written in this example. Thus, the display panel 27 displays an image.

In addition, in a period from the timing t64 to a timing t68, the predictive processing circuit 79 performs the predictive processing on the basis of the pieces of image data of the image P1 and the partial image P2 supplied to the display controller 76 to thereby generate a piece of display image data. Thereafter, in a period from the timing t68 to a timing t69, the display controller 76 controls the operation of the display panel 27 on the basis of the piece of display image data generated.

Thus, in the display system 3, the reception circuit 21 receives a piece of first image data representing the entire image P11 having a first resolution, a piece of second image data representing the peripheral image P12 having a second resolution lower than or equal to the first resolution, and a piece of third image data representing the partial image P2 having a third resolution higher than the first resolution. The peripheral image P12 is an image outside the entire image P11. The partial image P2 is an image having an image range narrower than that of the entire image P11. The acceleration sensor 22 detects a change in orientation of the head-mounted display 70. The display controller 76 performs the geometric deformation processing on the piece of first image data, the piece of second image data, and the piece of third image data on the basis of the result of detection by the acceleration sensor 22 to thereby perform the first image processing for generating a piece of display image data. Thereafter, the pixel signal generation circuit 32 and the scanning circuit 33 drive the pixel array 31 that is configured to display an image having the same image range as the image range of the entire image P11, on the basis of the piece of display image data. Accordingly, as with the head-mounted display 20 according to the first embodiment, in the head-mounted display 70, it is possible to reduce the latency.

### Modification Example 3

The modification example 1-2 or 1-3 of the first embodiment described above may be applied to the display system 3 according to the embodiment described above.

### 4. Fourth Embodiment

Next, description is given of a display system 4 according to a fourth embodiment. The present embodiment differs from the first embodiment described above in the structure of pieces of image data in an image signal SP. It is to be noted that components substantially the same as those of the display system 1 according to the first embodiment described above are denoted by the same reference signs, and description thereof is omitted as appropriate.

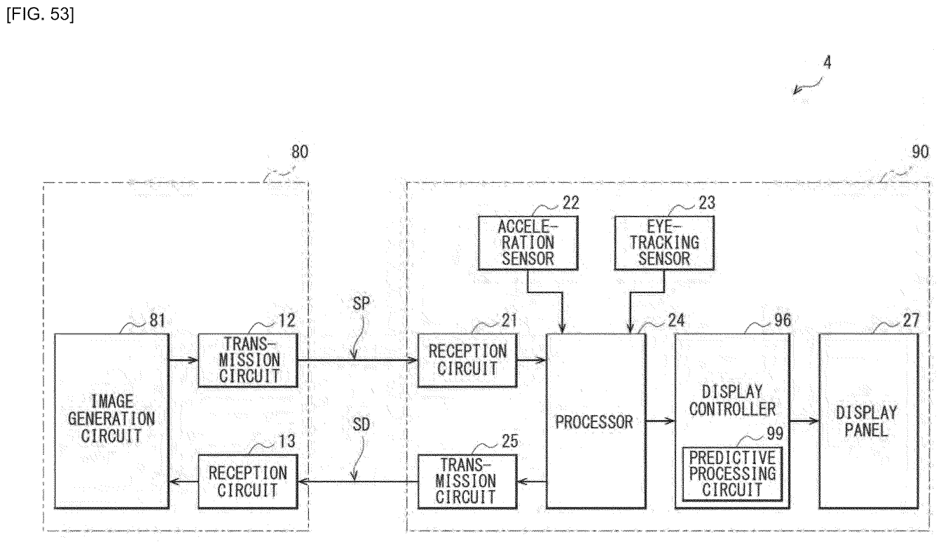

FIG. 53 illustrates a configuration example of the display system 4 according to the present embodiment. The display system 4 includes an image generation device 80 and a head-mounted display 90.

The image generation device 80 includes an image generation circuit 81. The image generation circuit 81 is configured to generate an image to be displayed on the head-mounted display 90 by performing, for example, a predetermined processing such as a rendering processing. The image generation circuit 81 generates the entire image P11 representing a scenery corresponding to the direction of the head-mounted display 90 in a virtual space on the basis of a result of detection by the acceleration sensor 22 included in a piece of data supplied from the reception circuit 13. In addition, the image generation circuit 81 generates the peripheral image P12 that is an image outside the entire image P11. The entire image P11 and the peripheral image P12 configure the image P1. In addition, the image generation circuit 81 generates the partial image P2 representing a portion at which the user is looking of the scenery corresponding to the direction of the head-mounted display 90 in the virtual space on the basis of a result of detection by the eye-tracking sensor 23 included in the piece of data supplied from the reception circuit 13.

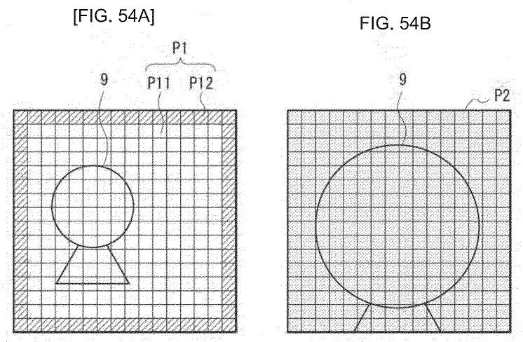

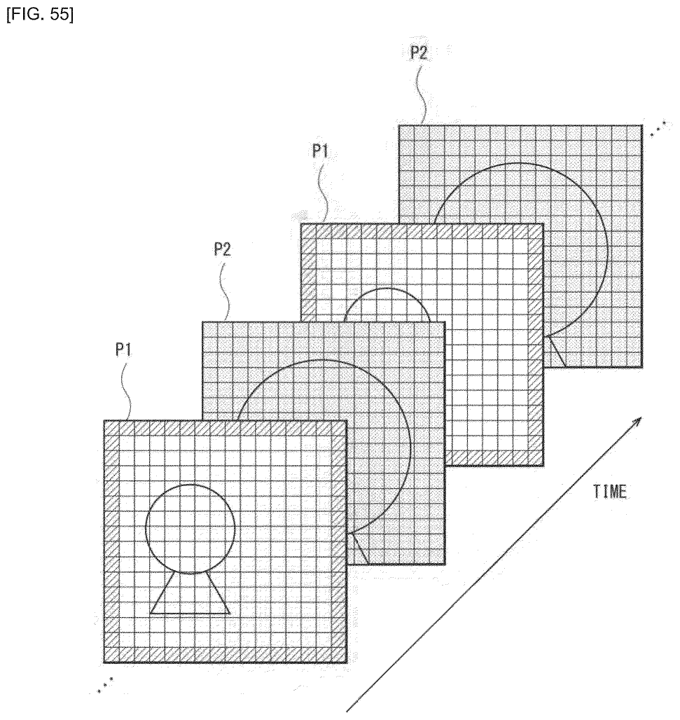

FIGS. 54A and 54B illustrate an example of the image P1 and the partial image P2 generated by the image generation circuit 81. The image P1 corresponds to an image corresponding to the image P1 converted by the transmission signal generation circuit 18 according to the first embodiment described above, and is an image having a low resolution. The partial image P2 is an image having a high resolution. The partial image P2 is an image having a high resolution. In this example, each pixel in the image P1 corresponds to four pixels PIX in the head-mounted display 90, and each pixel in the partial image P2 corresponds to one pixel PIX in the head-mounted display 90. In this example, the number of pixels in the image P1 and the number of pixels in the partial image P2 are equal to each other.

The image generation circuit 81 generates the image signal SP to be transmitted, on the basis of such an image. Thereafter, the transmission circuit 12 (FIG. 53) transmits the image signal SP supplied from the image generation circuit 81 to the head-mounted display 90.

FIG. 55 schematically illustrates an example of the image signal SP. The transmission circuit 12 transmits pieces of image data related to the image P1 and the pieces of image data related to the partial image P2 in a time division manner. Specifically, the transmission circuit 12 alternately transmits the pieces of image data related to the image P1 and the pieces of image data related to the partial image P2.

The head-mounted display 90 (FIG. 53) includes a display controller 96. The display controller 96 is configured to control an operation of display panel 27 on the basis of the pieces of image data and the piece of image position data supplied from the processor 24. The display controller 96 includes a predictive processing circuit 99. The predictive processing circuit 99 is configured to generate a piece of display image data by performing the geometric deformation processing on the pieces of image data supplied from the processor 24 on the basis of a result of detection by the acceleration sensor 22 and a result of detection by the eye-tracking sensor 23. The display controller 96 controls the operation of the display panel 27 on the basis of the piece of display image data.

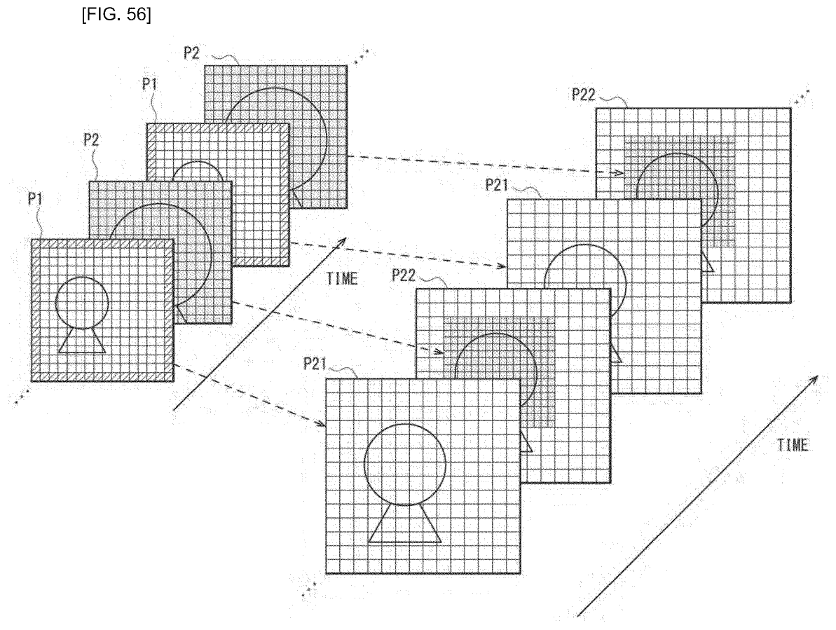

FIG. 56 illustrates an example of the display operation in the head-mounted display 90. The head-mounted display 90 alternately receives the pieces of image data related to the image P1 and the pieces of image data related to the partial image P2.

The display controller 96 performs control to drive the plurality of pixels PIX in the display panel 27 in units of four pixels PIX on the basis of the pieces of image data related to the image P1. This causes the display panel 27 to display a display image P21 related to the image P1 having a low resolution.

In addition, the display controller 96 performs control to drive a plurality of pixels PIX disposed in a region corresponding to the partial image P2 of the plurality of pixels PIX in the display panel 27 in units of one pixel PIX on the basis of pieces of data related to the partial image P2. This causes the display panel 27 to display a display image P22 related to the partial image P2 having a high resolution.

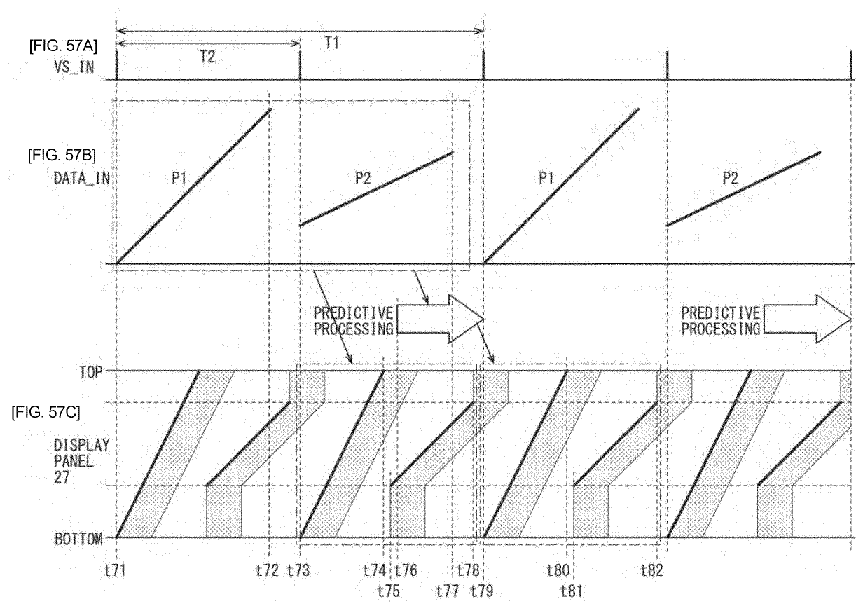

FIGS. 57A, 57B, and 57C illustrate an operation example of the head-mounted display 90, where FIG. 57A indicates a waveform of the vertical synchronization signal VS_IN to be inputted to the display controller 96, FIG. 57B indicates the data signal DATA_IN to be inputted to the display controller 96, and FIG. 57C indicates the operation of the display panel 27.

A pair of the image P1 and the partial image P2 is supplied in the cycle T1. In this example, the cycle T is, for example, 16.7 [msec.](= 1/60 [Hz]). Each of the image P1 and the partial image P2 is supplied in the cycle T2. The cycle T2 is, for example, 8.3 [msec.](= 1/120 [Hz]).

At a timing t71, a pulse of the vertical synchronization signal VS_IN is generated, and the vertical period V starts (FIG. 57A). Thereafter, in a period from the timing t71 to a timing t72, the piece of image data of the image P1 is supplied to the display controller 96, and in a period from a timing t73 to a timing t77, the piece of image data of the partial image P2 is supplied to the display controller 96 (FIG. 57B).

The display controller 96 generates a piece of display image data on the basis of the piece of image data of the entire image P11 in the supplied image P1. Thereafter, in a period from the timing t73 to a timing t74, the display controller 96 controls the operation of the display panel 27 on the basis of the piece of display image data generated. In this example, the scanning circuit 33 of the display panel 27 performs scanning in scanning units of two pixel lines L from the top to the bottom of the pixel array 31.

Thereafter, as indicated by a shaded portion in FIGS. 57A, 57B, and 57C, the pixel PIX to which the pixel signal is written emits light over a predetermined period after the pixel signal is written in this example. Thus, the display panel 27 displays an image.

In addition, the display controller 96 generates a piece of display image data on the basis of the piece of image data of the partial image P2 supplied. Thereafter, in a period from a timing t75 to a timing t78, the display controller 96 controls the operation of the display panel 27 on the basis of the piece of display image data generated. In this example, the scanning circuit 33 of the display panel 27 performs scanning on a plurality of pixels PIX at a position corresponding to the partial image P2 in the pixel array 31 in scanning units of one pixel line L.

Thereafter, as indicated by a shaded portion in FIGS. 57A, 57B, and 57C, the pixels PIX of the pixel line L belonging to the pixel PIX to which the pixel signal is written emits light over a predetermined period after the pixel signal is written in this example. In addition, the pixels PIX in the pixel line L near the bottom to which the pixel signal is not written emit light in the same period as a period in which the pixel PIX to which the pixel signal is first written emits light, and the pixels PIX in the pixel line L near the top to which the pixel signal is not written emit light in the same period as a period in which the pixel PIX to which the pixel signal is last written emits light. Thus, the display panel 27 displays an image.

In addition, in a period from the timing t75 to a timing t79, the predictive processing circuit 99 performs the predictive processing on the basis of the image P1 supplied to the display controller 96 to thereby generate a piece of display image data. Thereafter, in a period from the timing t79 to a timing t80, the display controller 96 controls the operation of the display panel 27 on the basis of the piece of display image data generated.

In addition, in the period from the timing t75 to the timing t79, the predictive processing circuit 99 performs the predictive processing on the basis of the partial image P2 supplied to the display controller 96 to thereby generate a piece of display image data. Thereafter, in a period from a timing t81 to a timing t82, the display controller 96 controls the operation of the display panel 27 on the basis of the piece of display image data generated.

Thus, in the display system 4, the reception circuit 21 receives a piece of first image data representing the entire image P11 having a first resolution, a piece of second image data representing the peripheral image P12 having a second resolution lower than or equal to the first resolution, and a piece of third image data representing the partial image P2 having a third resolution higher than the first resolution. The peripheral image P12 is an image outside the entire image P11. The partial image P2 is an image having an image range narrower than that of the entire image P11. The acceleration sensor 22 detects a change in orientation of the head-mounted display 90. The display controller 96 performs the geometric deformation processing on the piece of first image data, the piece of second image data, and the piece of third image data on the basis of the result of detection by the acceleration sensor 22 to thereby perform the first image processing for generating a piece of display image data. Thereafter, the pixel signal generation circuit 32 and the scanning circuit 33 drive the pixel array 31 that is configured to display an image having the same image range as the image range of the entire image P11, on the basis of the piece of display image data. Accordingly, as with the head-mounted display 20, in the head-mounted display 90, it is possible to reduce the latency.

### Modification Example 4

The modification example 1-2 or 1-3 of the first embodiment described above may be applied to the display system 4 according to the embodiment described above.

### 5. Application Examples

Next, description is given of application examples of the display systems described in the embodiments described above and the modification examples.

### Specific Example 1

FIG. 58 illustrates an example of an appearance of a head-mounted display 110. The head-mounted display 110 includes ear hook sections 112 for mounting on the head of a user on both sides of a glasses-shaped display section 111. The technology according to the embodiments described above and the like is applicable to such a head-mounted display 110.

### Specific Example 2

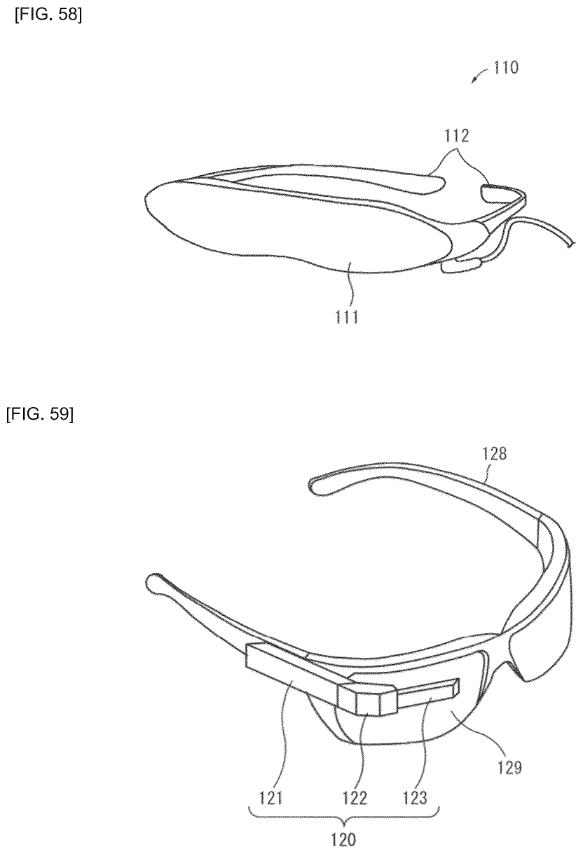

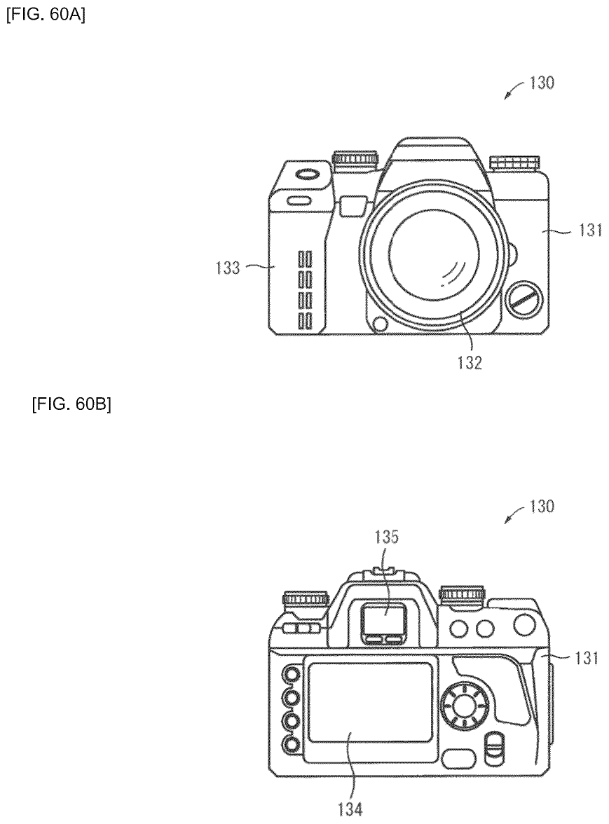

FIG. 59 illustrates an example of an appearance of another head-mounted display 120. The head-mounted display 120 is a see-through head-mounted display including a main body section 121, an arm section 122, and a barrel section 123. The head-mounted display 120 is mounted on glasses 128. The main body section 121 includes a control substrate for controlling an operation of the head-mounted display 120, and a display section. This display section outputs image light of a display image. The arm section 122 couples the main body section 121 and the barrel section 123 to each other, and supports the barrel section 123. The barrel section 123 projects the image light supplied from the main body section 121 through the arm section 122 toward a user's eye through a lens 129 of the glasses 128. The technology according to the embodiments described above and the like is applicable to such a head-mounted display 120.

It is to be noted that the head-mounted display 120 is a so-called light guide plate system head-mounted display, but is not limited thereto. For example, the head-mounted display 120 may be, for example, what is called a birdbath system head-mounted display. The birdbath system head-mounted display includes, for example, a beam splitter, and a partially transparent mirror. The beam splitter outputs light encoded with image information toward the mirror, and the mirror reflects the light toward the user's eye. Both of the beam splitter and the partially transparent mirror are partially transparent. This causes light from an ambient environment to reach the user's eye.

### Application Example 3

FIGS. 60A and 60B illustrate an example of an appearance of a digital still camera 130. FIG. 60A illustrates a front view, and FIG. 60B illustrates a rear view. The digital still camera 130 is an interchangeable lens single-lens reflex type camera, and includes a camera main body section (camera body) 131, a photographing lens unit 132, a grip section 133, a monitor 134, and an electronic view finder 135. The photographing lens unit 312 is an interchangeable lens unit, and is provided almost in the vicinity of a middle of a front surface of the camera main body section 311. The grip section 133 is provided on left side of the front surface of the camera main body section 311, and a photographer grasps the grip section 133. The monitor 134 is provided on left side from almost a middle of a rear surface of the camera main body section 131. The electronic view finder 135 is provided above the monitor 14 on the rear surface of the camera main body section 131. The photographer looks into the electronic view finder 135, thereby making it possible to visually recognize a light image of a subject guided from the photographing lens unit 132 and determine a composition. The technology according to the embodiments described above and the like is applicable to the electronic view finder 135.

### Application Example 4

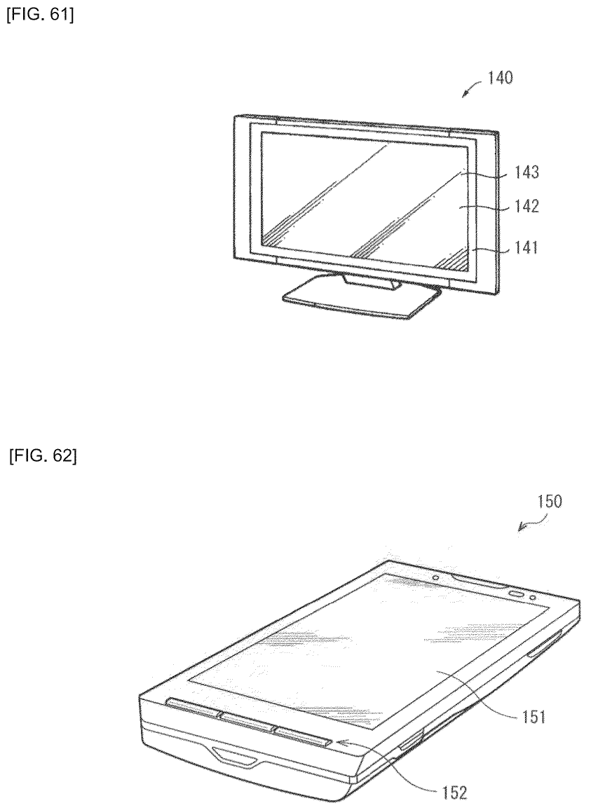

FIG. 61 illustrates an example of an appearance of a television apparatus 140. The television apparatus 140 includes an image display screen section 141 including a front panel 142 and filter glass 143. The technology according to the embodiments described above and the like is applicable to the image display screen section 141.

### Application Example 5

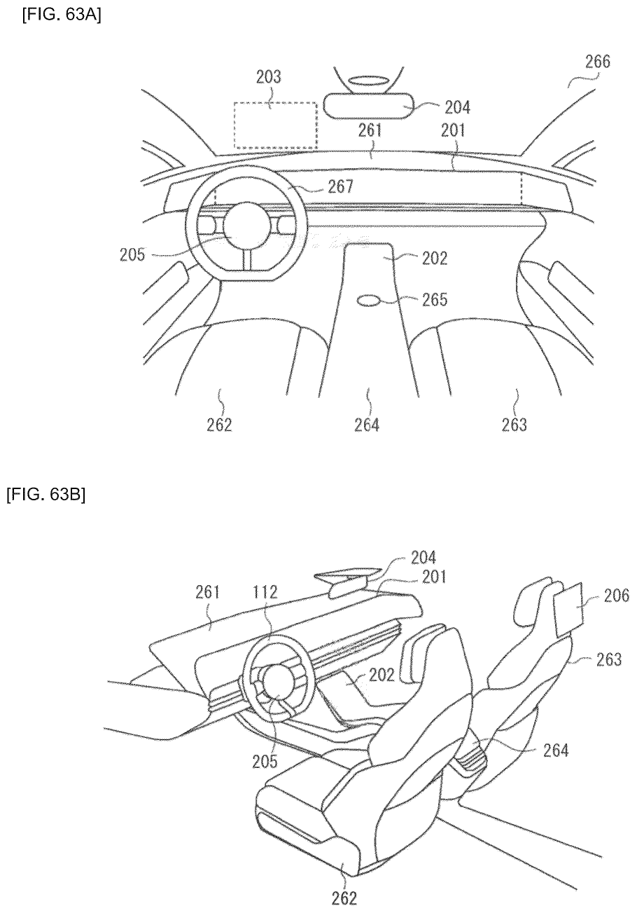

FIG. 62 illustrates an example of an appearance of a smartphone 150. The smartphone 150 includes a display section 151 and an operation section 152. The display section 151 displays various types of information. The operation section 152 includes a button that receives operation input by a user, and the like. The technology according to the embodiments described above and the like is applicable to the display section 151.

### Application Example 6

FIGS. 63A and 63B illustrate a configuration example of a vehicle to which the technology of the present disclosure is applied. FIG. 63A illustrates an example of a vehicle interior viewed from the rear of a vehicle 200, and FIG. 63B illustrates the vehicle interior viewed from the left rear of the vehicle 200.

The vehicle in FIGS. 63A and 63B includes a center display 201, a console display 202, a head-up display 203, a digital rearview mirror 204, a steering wheel display 205, and a rear entertainment display 106.

The center display 201 is provided at a location opposed to a driver seat 262 and a passenger seat 263 in a dashboard 261. FIG. 63A illustrates an example of the horizontally long center display 201 extending from side of the driver seat 262 to side of the passenger seat 263, but the screen size and installation location of the center display 201 are not limited thereto. The center display 201 is configured to display information detected by various sensors. As a specific example, the center display 201 is configured to display a shot image captured by an image sensor, a distance image to an obstacle in front of the vehicle or on a side of the vehicle measured by a ToF sensor, the temperature of an occupant detected by an infrared sensor, and the like. It is possible to use the center display 201 for displaying, for example, at least one of safety relevant information, operation relevant information, a lifelog, health relevant information, authentication/identification relevant information, or entertainment relevant information.

The safety relevant information includes information based on results of detection by sensors, such as drowsiness detection, looking-away detection, detection of tampering by a child in the vehicle, detection of whether or not a seat belt is fastened, and detection of a left-behind occupant. The operation relevant information includes information about a gesture related to an operation by an occupant detected with use of a sensor. The gesture may include operations of various facilities in the vehicle, and includes, for example, operations of an air-conditioning facility, a navigation device, an AV (Audio Visual) device, a lighting device, and the like. The lifelog includes lifelogs of all occupants. For example, the lifelog includes behavior recording of each occupant. Obtaining and storing the lifelog makes it possible to confirm the condition of the occupant at the time of occurrence of an accident. The health relevant information includes information about the temperature of an occupant detected with use of a temperature sensor, and a health condition of the occupant presumed on the basis of the detected temperature. Alternatively, information about the health condition of the occupant may be presumed on the basis of an image of the face of the occupant captured by an image sensor. In addition, the information about the health condition of the occupant may be presumed on the basis of answer contents of the occupant obtained by performing conversation with the occupant with use of automated voice. The authentication/identification relevant information includes information about a keyless entry function in which facial recognition is performed with use of a sensor, a function of automatedly adjusting the height and position of a seat by facial identification, and the like. The entertainment relevant information includes information about an operation of an AV device by an occupant detected by a sensor and information about contents to be displayed that are suitable for an occupant detected and recognized by a sensor.

It is possible to use the console display 202, for example, for displaying lifelog information. The console display 202 is disposed near a shift lever 265 in a center console 264 between the driver seat 262 and the passenger seat 263. The console display 202 is also configured to display information detected by various sensors. In addition, the console display 202 may display an image around the vehicle captured by an image sensor, or may display a distance image to an obstacle around the vehicle.

The head-up display 203 is virtually displayed at the back of a windshield 266 in front of the driver seat 262. It is possible to use the head-up display 203 for displaying, for example, at least one of safety relevant information, operation relevant information, a lifelog, health relevant information, authentication/identification relevant information, or entertainment relevant information. The head-up display 203 is often virtually disposed in front of the driver seat 262, and is therefore suitable to display information directly related to an operation of the vehicle such as speed of the vehicle, a fuel level, and remaining battery life.

The digital rearview mirror 204 is configured not only to display a rear side of the vehicle but also to display the state of an occupant on a backseat; therefore, it is possible to use the digital rearview mirror 204, for example, for displaying lifelog information about the occupant on the backseat.

The steering wheel display 205 is disposed around the center of a steering wheel 267 of the vehicle. It is possible to use the steering wheel display 205 for displaying, for example, at least one of safety relevant information, operation relevant information, a lifelog, health relevant information, authentication/identification relevant information, or entertainment relevant information. Specifically, the steering wheel display 205 is disposed near a driver's hand, and is therefore suitable to display lifelog information such as the temperature of the driver or to display information related to operations of an AV device, an air-conditioning facility, and the like.

The rear entertainment display 206 is mounted on rear surface side of the driver seat 262 or the passenger seat 263, and is for being watched by an occupant on the backseat. It is possible to use the rear entertainment display 206 for displaying, for example, at least one of safety relevant information, operation relevant information, a lifelog, health relevant information, authentication/identification relevant information, or entertainment relevant information. Specifically, the rear entertainment display 206 is disposed in front of the occupant on the backseat, and therefore displays information related to the occupant on the backseat. The rear entertainment display 206 may display, for example, information related to the operations of an AV device and an air-conditioning facility, or may display a result obtained by measuring the temperature or the like of the occupant on the backseat by a temperature sensor 5.

The technology according to the embodiments described above and the like is applicable to the center display 201, the console display 202, the head-up display 203, the digital rearview mirror 204, the steering wheel display 205, and the rear entertainment display 206.

The present technology has been described above with reference to some embodiments, the modification examples, and the application examples to electronic apparatuses, but the present technology is not limited to the embodiments and the like, and may be modified in a variety of ways.

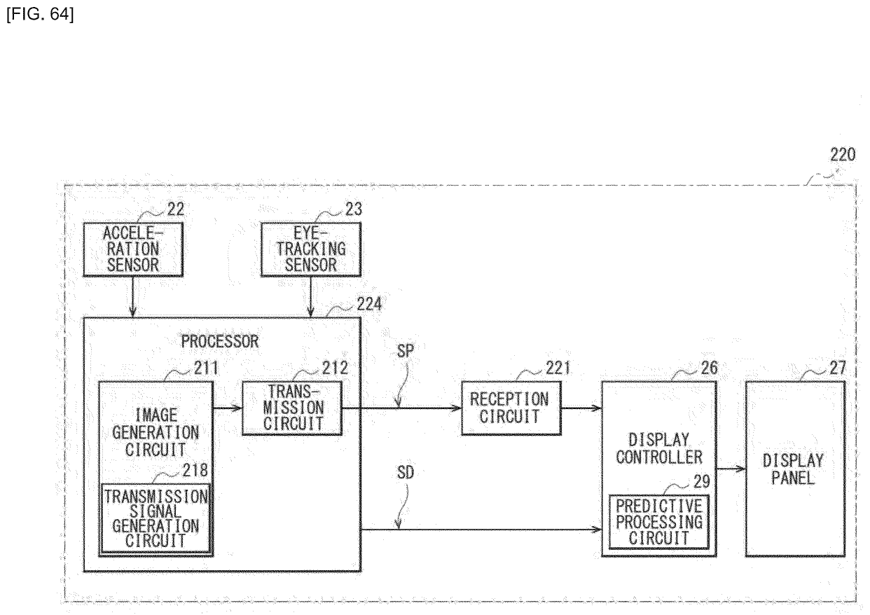

For example, in the display system 1 according to the first embodiment described above, for example, the image generation device 10 generates the image signal SP, and the head-mounted display 20 displays an image on the basis of the image signal SP, but this is not limitative. Instead of this, for example, as with a head-mounted display 220 illustrated in FIG. 64, the head-mounted display 220 may generate the image signal SP and display an image on the basis of the image signal SP. The head-mounted display 220 includes a processor 224 and a reception circuit 221. The processor 224 includes an image generation circuit 211 and a transmission circuit 212. The image generation circuit 211 generates the entire image P11 representing a scenery corresponding to the direction of the head-mounted display 220 in a virtual space on the basis of the result of detection by the acceleration sensor 22. In addition, the image generation circuit 211 generates the peripheral image P12 that is an image outside the entire image P11. In addition, the image generation circuit 211 specifies the partial image P2 representing a portion at which the user is looking of the scenery corresponding to the direction of the head-mounted display 220 in the virtual space on the basis of the result of detection by the eye-tracking sensor 23. The image generation circuit 211 includes a transmission signal generation circuit 218. The transmission signal generation circuit 218 is configured to generate the image signal SP to be transmitted, on the basis of the image generated by the image generation circuit 211. The transmission circuit 212 is configured to transmit, to the display controller 26, the image signal SP supplied from the image generation circuit 211. In addition, the processor 224 is configured to transmit, to the display controller 26, the detection signal SD including the result of detection by the acceleration sensor 22 and the result of detection by the eye-tracking sensor 23. The reception circuit 221 is configured to receive the image signal SP transmitted from the processor 224. Although the display system 1 according to the first embodiment has been described as an example, the same applies to the display system 2 according to the second embodiment, the display system 3 according to the third embodiment, and the display system 4 according to the fourth embodiment.

The present technology is applicable not only to a closed system described in the embodiments described above and the like, but also to a video see-through system and a mixed reality system.

In addition, the present technology is applicable to various simulators such as a flight simulator, and applications for gaming, projection mapping, and the like.

In addition, in the embodiments described above, the display panel 27 illustrated in FIG. 10 is used, but this is not limitative. A display panel 27E according to the present modification example is described in detail below.

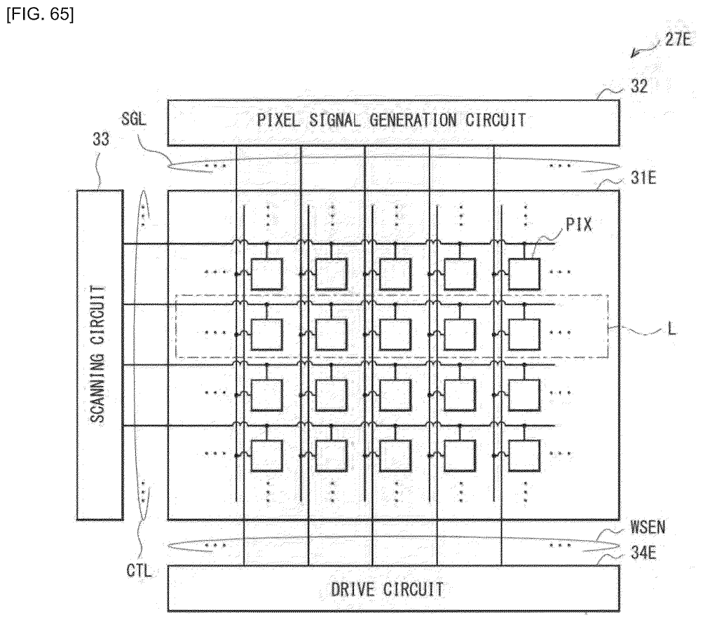

FIG. 65 illustrates a configuration example of the display panel 27E. The display panel 27E includes a pixel array 31E, the pixel signal generation circuit 32, the scanning circuit 33, and a drive circuit 34E.

The pixel array 31E includes a plurality of signal lines SGL, a plurality of control lines CTL, a plurality of control lines WSEN, and a plurality of pixels PIX. The plurality of control lines WSEN extends in the vertical direction (the longitudinal direction in FIG. 65), and is provided side by side in the horizontal direction (the lateral direction in FIG. 65). The plurality of control lines WSEN each supplies a control signal generated by the drive circuit 34E to the pixels PIX.

The drive circuit 34E is configured to generate a control signal and apply the generated control signal to the plurality of control lines WSEN, thereby performing control on the pixels PIX to which the pixel signal generated by the pixel signal generation circuit 32 is to be written to determine which pixel PIX of the plurality of pixels PIX the pixel signal is to be written to.

FIG. 66 illustrates a configuration example of the pixel PIX. The pixel array including this pixel PIX includes a control line WSL. The control lines CTL illustrated in FIG. 65 include this control line WSL. The pixel PIX includes transistors MN01 to MN03, a capacitor C01, and a light-emitting element EL. The transistors MN01 to MN03 are N-type MOSFETs (Metal Oxide Semiconductor Field Effect Transistors). The transistor MN01 has a gate coupled to the control line WSEN, a drain coupled to the signal line SGL, and a source coupled to a drain of the transistor MN02. The transistor MN02 has a gate coupled to the control line WSL, the drain coupled to the source of the transistor MN01, and a source coupled to a gate of the transistor MN03 and the capacitor C01. The capacitor C01 has one end coupled to the source of the transistor MN02 and the gate of the transistor MN03, and another end coupled to a source of the transistor MN03 and an anode of the light-emitting element EL. The transistor MN03 has the gate coupled to the source of the transistor MN02 and the one end of the capacitor C01, a drain coupled to a power supply line VCCP, and the source coupled to the other end of the capacitor C01 and the anode of the light-emitting element EL. The light-emitting element EL is, for example, an organic EL light-emitting element, and has the anode coupled to the source of the transistor MN03 and the other end of the capacitor C01, and a cathode coupled to a power supply line Vcath.

With this configuration, in the pixel PIX, the transistors MN01 and MN02 are turned on to thereby set a voltage between both ends of the capacitor C01 on the basis of a pixel signal supplied from the signal line SGL. The transistor MN03 causes a current corresponding to the voltage between both ends of the capacitor C01 to flow into the light-emitting element EL. The light-emitting element EL emits light on the basis of the current supplied from the transistor MN03. Thus, the pixel PIX emits light with luminance corresponding to the pixel signal.

In an example in FIGS. 17A, 17B, and 17C, as illustrated in FIG. 17A, in the period from the timing t13 to the timing t14, the display controller 26 performs control to drive the plurality of pixels PIX in the display panel 27E in units of four pixels PIX on the basis of the piece of image data of the entire image P1. As illustrated in FIG. 15, in the period from the timing t13 to the timing t14, the scanning circuit 33 of the display panel 27 scans the plurality of pixels PIX in scanning units US of two pixel lines L. The drive circuit 34E sets all the control lines WSEN active (high level). The pixel signal generation circuit 32 applies the same pixel signal to two signal lines SGL adjacent to each other. Accordingly, the same pixel signal is written to four pixels PIX in selected two pixel lines L. Thus, the display panel 27E drives the plurality of pixels PIX in units UD of four pixels PIX.

In addition, as illustrated in FIG. 17B, in the period from the timing t14 to the timing t15, the display controller 26 performs control to drive a plurality of pixels PIX disposed in a region corresponding to the partial image P2 of the plurality of pixels PIX in the display panel 27E in units of one pixel PIX on the basis of the piece of image data of the partial image P2 and a piece of data about the position of the partial image P2. As illustrated in FIG. 16, from the timing t14 to the timing t15, the scanning circuit 33 of the display panel 27E scans the plurality of pixels PIX in scanning units US of one pixel line L. The drive circuit 34E sets a plurality of control lines WSEN related to the region corresponding to the partial image P2 active (high level), and sets a plurality of other control lines WSEN inactive (low level). The pixel signal generation circuit 32 applies each of a plurality of pixel signals to a corresponding one of a plurality of signal lines SGL related to the region corresponding to the partial image P2 of the plurality of signal lines SGL. Accordingly, each of a plurality of pixel signals is written to a corresponding one of a plurality of pixels PIX related to the region corresponding to the partial image P2 in selected one pixel line L. Meanwhile, the pixel signal is not written to a plurality of pixels PIX related to a region other than the region corresponding to the partial image P2. Thus, the display panel 27E drives the plurality of pixels PIX in units UD of one pixel PIX.

In addition, as illustrated in FIG. 17C, in the period from the timing t15 to the timing t16, the display controller 26 performs control to drive a plurality of pixels PIX provided in a region corresponding to the partial image P2 of the plurality of pixels PIX in the display panel 27E in units of one pixel PIX on the basis of the piece of image data of the partial image P2 and the piece of data about the position of the partial image P2. This operation is similar to the operation in the period from the timing t14 to the timing t15 illustrated in FIG. 17B.

The configuration of the pixel PIX is not limited to the example in FIG. 66. Some examples of the configuration of the pixel PIX are described below.

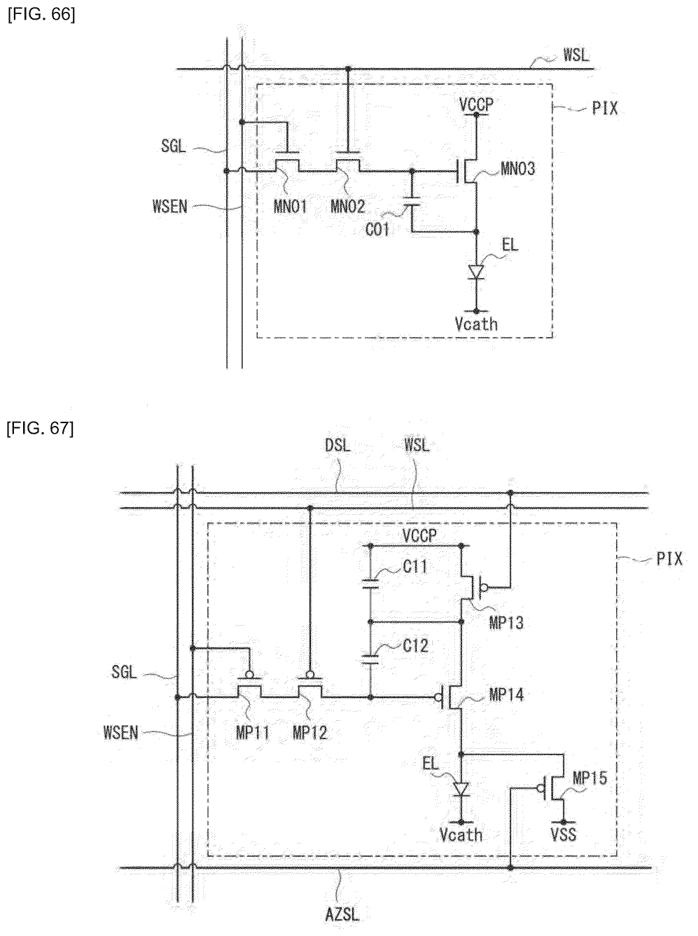

FIG. 67 illustrates another configuration example of the pixel PIX. The pixel array including this pixel PIX includes the control line WSL, a control line DSL, and a control line AZSL. The control lines CTL illustrated in FIG. 65 include the control lines WSL, DSL, and AZSL. This pixel PIX includes transistors MP11 and MP12, capacitors C11 and C12, transistors MP13 to MP15, and the light-emitting element EL. The transistors MP11 to MP15 are P-type MOSFETs. The transistor MP11 has a gate coupled to the control line WSEN, a source coupled to the signal line SGL, and a drain coupled to a source of the transistor MP12. The transistor MP12 has a gate coupled to the control line WSL, the source coupled to the drain of the transistor MP11, and a drain coupled to a gate of the transistor MP14 and the capacitor C12. The capacitor C11 has one end coupled to the power supply line VCCP, and another end coupled to the capacitor C12, a drain of the transistor MP13, and a source of the transistor MP14. The capacitor C12 has one end coupled to the other end of the capacitor C11, the drain of the transistor MP13, and the source of the transistor MP14, and another end coupled to the drain of the transistor MP12 and the gate of the transistor MP14. The transistor MP13 has a gate coupled to the control line DSL, a source coupled to the power supply line VCCP, and the drain coupled to the source of the transistor MP14, the other end of the capacitor C11, and the one end of the capacitor C12. The transistor MP14 has the gate coupled to the drain of the transistor MP12 and the other end of the capacitor C12, the source coupled to the drain of the transistor MP13, the other end of the capacitor C11, and the one end of the capacitor C12, and a drain coupled to the anode of the light-emitting element EL and a source of the transistor MP15. The transistor MP15 has a gate coupled to the control line AZSL, the source coupled to the drain of the transistor MP14 and the anode of the light-emitting element EL, and a drain coupled to a power supply line VSS.

With this configuration, in the pixel PIX, the transistors MP11 and MP12 are turned on to thereby set a voltage between both ends of the capacitor C12 on the basis of the pixel signal supplied from the signal line SGL. The transistor MP13 is turned on or off on the basis of a signal of the control line DSL. The transistor MP14 causes a current corresponding to the voltage between both ends of the capacitor C12 to flow into the light-emitting element EL in a period in which the transistor MP13 is turned on. The light-emitting element EL emits light on the basis of the current supplied from the transistor MP14. Thus, the pixel PIX emits light with luminance corresponding to the pixel signal. The transistor MP15 is turned on or off on the basis of a signal of the control line AZSL. In a period in which the transistor MP15 is turned on, a voltage of the anode of the light-emitting element EL is set to a voltage of the power supply line VSS, thereby being initialized.

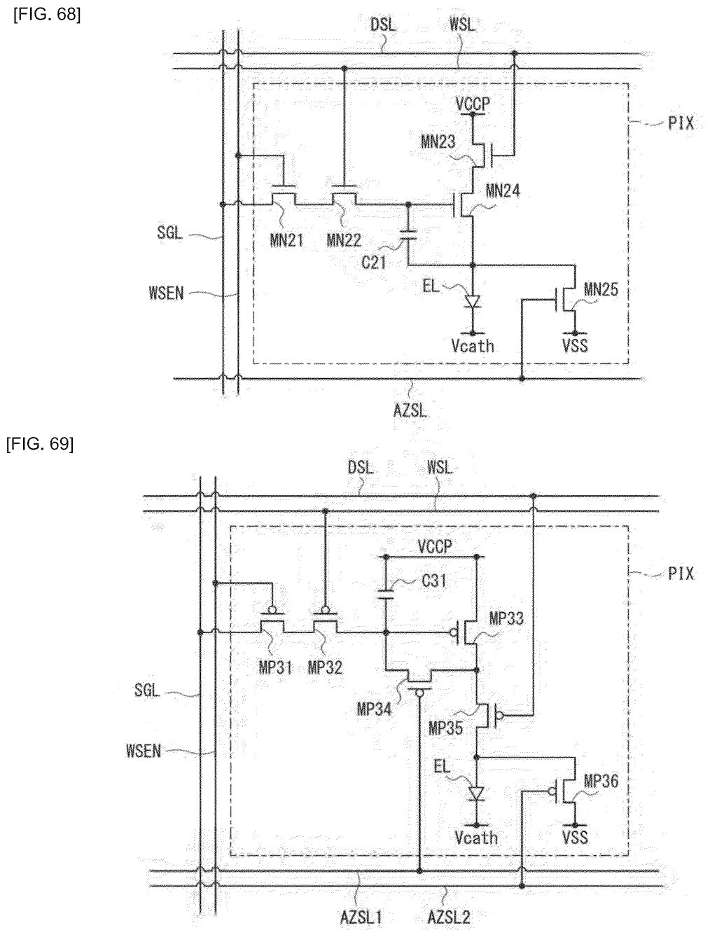

FIG. 68 illustrates another configuration example of the pixel PIX. The pixel array including this pixel PIX includes the control line WSL, the control line DSL, and the control line AZSL. The control lines CTL illustrated in FIG. 65 include the control lines WSL, DSL, and AZSL. This pixel PIX includes transistors MN21 and MN22, a capacitor C21, transistors MN23 to MN25, and the light-emitting element EL. The transistors MN21 to MN25 are N-type MOSFETs. The transistor MN21 has a gate coupled to the control line WSEN, a drain coupled to the signal line SGL, and a source coupled to a drain of the transistor MN22. The transistor MN22 has a gate coupled to the control line WSL, the drain coupled to the source of the transistor MN21, and a source coupled to a gate of the transistor MN24 and the capacitor C21. The capacitor C21 has one end coupled to the source of the transistor MN22 and the gate of the transistor MN24, and another end coupled to a source of the transistor MN24 and a drain of the transistor MN25, and the anode of the light-emitting element EL. The transistor MN23 has a gate coupled to the control line DSL, a drain coupled to the power supply line VCCP, and a source coupled to a drain of the transistor MN24. The transistor MN24 has the gate coupled to the source of the transistor MN22 and the one end of the capacitor C21, the drain coupled to the source of the transistor MN23, and the source coupled to the other end of the capacitor C21, the drain of the transistor MN25, and the anode of the light-emitting element EL. The transistor MN25 has a gate coupled to the control line AZSL, the drain coupled to the source of the transistor MN24, the other end of the capacitor C21, and the anode of the light-emitting element EL, and a source coupled to the power supply line VSS.

With this configuration, in the pixel PIX, the transistors MN21 and MN22 are turned on to thereby set a voltage between both ends of the capacitor C21 on the basis of the pixel signal supplied from the signal line SGL. The transistor MN23 is turned on or off on the basis of a signal of the control line DSL. The transistor MN24 causes a current corresponding to the voltage between both ends of the capacitor C21 to flow into the light-emitting element EL in a period in which the transistor MN23 is turned on. The light-emitting element EL emits light on the basis of the current supplied from the transistor MN24. Thus, the pixel PIX emits light with luminance corresponding to the pixel signal. The transistor MN25 is turned on or off on the basis of a signal of the control line AZSL. In a period in which the transistor MN25 is turned on, the voltage of the anode of the light-emitting element EL is set to the voltage of the power supply line VSS, thereby being initialized.

FIG. 69 illustrates another configuration example of the pixel PIX. The pixel array including this pixel PIX includes the control line WSL, the control line DSL, and control lines AZSL1 and AZSL2. The control lines CTL illustrated in FIG. 65 include the control lines WSL, DSL, AZSL1, and AZSL2. This pixel PIX includes transistors MP31 and MP32, a capacitor C31, transistors MP33 to MP36, and the light-emitting element EL. The transistors MP31 to MP36 are P-type MOSFETs. The transistor MP31 has a gate coupled to the control line WSEN, a source coupled to the signal line SGL, and a drain coupled to a source of the transistor MP32. The transistor MP32 has a gate coupled to the control line WSL, the source coupled to the drain of the transistor MP31, and a drain coupled to a gate of the transistor MP33, a source of the transistor MP34, and the capacitor C31. The capacitor C31 has one end coupled to the power supply line VCCP, and another end coupled to the drain of the transistor MP32, the gate of the transistor MP33, and the source of the transistor MP34. The transistor MP34 has a gate coupled to the control line AZSL1, the source coupled to the drain of the transistor MP32, the gate of the transistor MP33, and the other end of the capacitor C31, and a drain coupled to a drain of the transistor MP33 and a source of the transistor MP35. The transistor MP35 has a gate coupled to the control line DSL, the source coupled to the drains of the transistors MP33 and MP34, and a drain coupled to a source of the transistor MP36 and the anode of the light-emitting element EL. The transistor MP36 has a gate coupled to the control line AZSL2, the source coupled to the drain of the transistor MP35 and the anode of the light-emitting element EL, and a drain coupled to the power supply line VSS.

With this configuration, in the pixel PIX, the transistors MP31 and MP32 are turned on to thereby set a voltage between both ends of the capacitor C31 on the basis of the pixel signal supplied from the signal line SGL. The transistor MP35 is turned on or off on the basis of a signal of the control line DSL. The transistor MP33 causes a current corresponding to the voltage between both ends of the capacitor C31 to flow into the light-emitting element EL in a period in which the transistor MP35 is turned on. The light-emitting element EL emits light on the basis of the current supplied from the transistor MP33. Thus, the pixel PIX emits light with luminance corresponding to the pixel signal. The transistor MP34 is turned on or off on the basis of a signal of the control line AZSL1. In a period in which the transistor MP34 is turned on, the drain and the gate of the transistor MP33 are coupled to each other. The transistor MP36 is turned on or off on the basis of a signal of the control line AZSL2. In a period in which the transistor MP36 is turned on, the voltage of the anode of the light-emitting element EL is set to the voltage of the power supply line VSS, thereby being initialized.

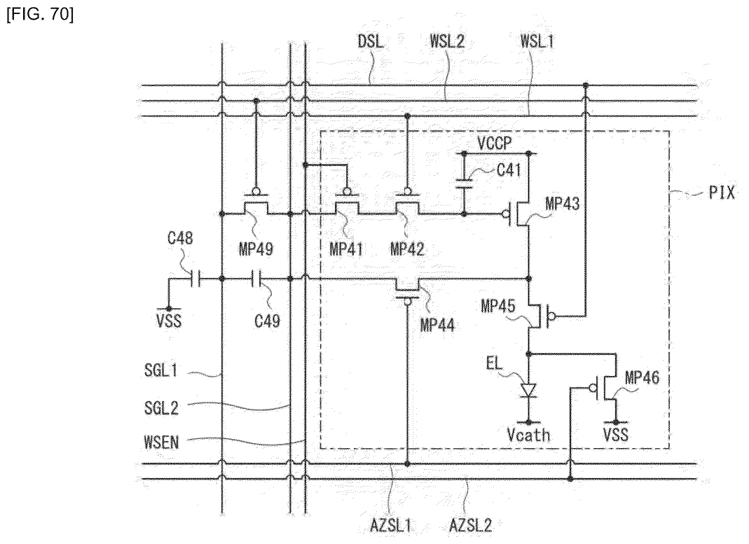

FIG. 70 illustrates another configuration example of the pixel PIX. The pixel array including this pixel PIX includes control lines WSL1 and WSL2, the control line DSL, the control lines AZSL1 and AZSL2, signal lines SGL1 and SGL2, capacitors C48 and C49, and a transistor MP49. The control lines CTL illustrated in FIG. 65 include the control lines WSL1, WSL2, DSL, AZSL1, and AZSL2. The signal lines SGL illustrated in FIG. 65 include the signal lines SGL1 and SGL2. The capacitor C48 has one end coupled to the signal line SGL1, and another end coupled to the power supply line VSS. The capacitor C49 has one end coupled to the signal line SGL1, and another end coupled to the signal line SGL2. The transistor MP49 is a P-type MOSFET, and has a gate coupled to the control line WSL2, a source coupled to the signal line SGL1, and a drain coupled to the signal line SGL2.

The pixel PIX includes transistors MP41 and MP42, a capacitor C41, transistors MP43 to MP46, and the light-emitting element EL. The transistors MP41 to MP46 are P-type MOSFETs. The transistor MP41 has a gate coupled to the control line WSEN, a source coupled to the signal line SGL2, and a drain coupled to a source of the transistor MP42. The transistor MP42 has a gate coupled to the control line WSL1, the source coupled to the drain of the transistor MP41, and a drain coupled to a gate of the transistor MP43 and the capacitor C41. The capacitor C41 has one end coupled to the power supply line VCCP, and another end coupled to the drain of the transistor MP42 and the gate of the transistor MP43. The transistor MP43 has the gate coupled to the drain of the transistor MP42 and the other end of the capacitor C41, a source coupled to the power supply line VCCP, and a drain coupled to sources of the transistors MP44 and MP45. The transistor MP44 has a gate coupled to the control line AZSL1, the source coupled to the drain of the transistor MP43 and the source of the transistor MP45, and a drain coupled to the signal line SGL2. The transistor MP45 has a gate coupled to the control line DSL, the source coupled to the drain of the transistor MP43 and the source of the transistor MP44, and a drain coupled to a source of the transistor MP46 and the anode of the light-emitting element EL. The transistor MP46 has a gate coupled to the control line AZSL2, the source coupled to the drain of the transistor MP45 and the anode of the light-emitting element EL, and a drain coupled to the power supply line VSS.

With this configuration, in the pixel PIX, the transistors MP41 and MP42 are turned on to thereby set a voltage between both ends of the capacitor C41 on the basis of the pixel signal supplied from the signal line SGL1 through the capacitor C49. The transistor MP45 is turned on or off on the basis of a signal of the control line DSL. The transistor MP43 causes a current corresponding to the voltage between both ends of the capacitor C41 to flow into the light-emitting element EL in a period in which the transistor MP45 is turned on. The light-emitting element EL emits light on the basis of the current supplied from the transistor MP43. Thus, the pixel PIX emits light with luminance corresponding to the pixel signal. The transistor MP44 is turned on or off on the basis of a signal of the control line AZSL1. In a period in which the transistor MP44 is turned on, the drain of the transistor MP43 and the signal line SGL2 are coupled to each other. The transistor MP46 is turned on or off on the basis of a signal of the control line AZSL2. In a period in which the transistor MP46 is turned on, the voltage of the anode of the light-emitting element EL is set to the voltage of the power supply line VSS, thereby being initialized.

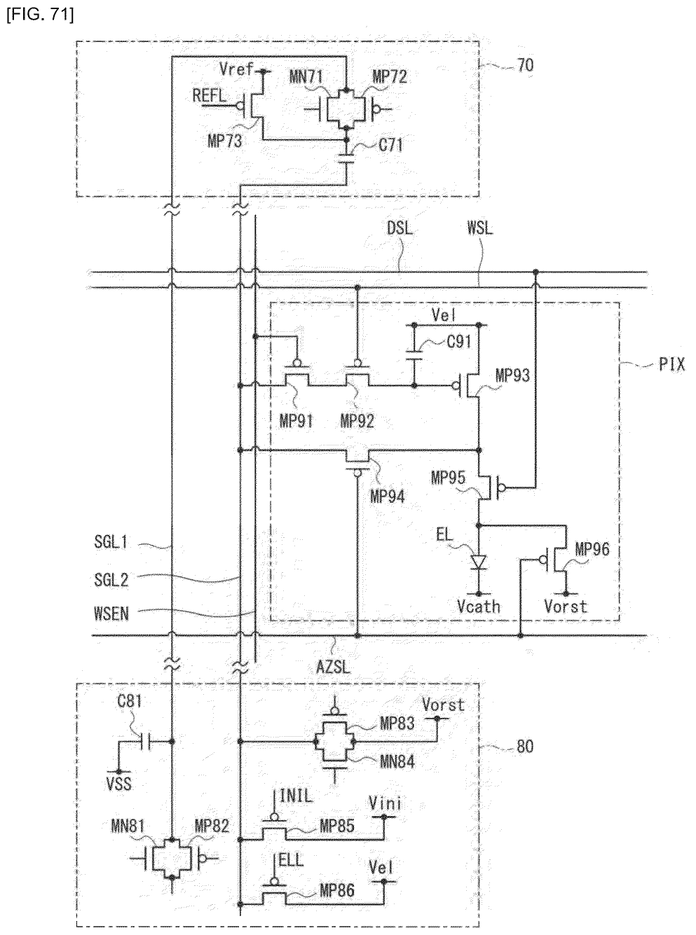

FIG. 71 illustrates another configuration example of the pixel PIX. The pixel array including this pixel PIX includes the control line WSL, the control line DSL, the control line AZSL, the signal lines SGL1 and SGL2, and controllers 70 and 80. The control lines CTL illustrated in FIG. 56 include the control lines WSL, DSL, and AZSL. The signal lines SGL illustrated in FIG. 56 include the signal lines SGL1 and SGL2.

The controller 70 includes transistors MN71 and MP72, a capacitor C71, and a transistor MP73. The transistor MN71 is an N-type MOSFET, and the transistors MP72 and MP73 are P-type MOSFETs. The transistor MN71 has a gate to be supplied with a control signal, a drain coupled to a source of the transistor MP72 and the signal line SGL1, and a source coupled to a drain of the transistor MP72, the capacitor C71, and a drain of the transistor MP73. The transistor MP72 has a gate to be supplied with a control signal, the source coupled to the drain of the transistor MN71 and the signal line SGL1, and the drain coupled to the source of the transistor MN71, the capacitor C71, and the drain of the transistor MP73. The transistors MN71 and MP72 configure a transmission gate. The capacitor C71 has one end coupled to the source of the transistor MN71, the drain of the transistor MP72, and the drain of the transistor MP73, and another end coupled to the signal line SGL2. The transistor MP73 has a gate coupled to a control line REFL, a source coupled to a power supply line Vref, and the drain coupled to the source of the transistor MN71, the drain of the transistor MP72, and the capacitor C71.

The controller 80 includes transistors MN81 and MP82, a capacitor C81, and transistors MP83, MN84, MP85, and MP86. The transistors MN81 and MN84 are N-type MOSFETs, and the transistors MP82, MP83, MP85, and MP86 are P-type MOSFETs. The transistor MN81 has a gate to be supplied with a control signal, a drain coupled to a source of the transistor MP82 and the signal line SGL1, and a source coupled to a drain of the transistor MP82. The transistor MP82 has a gate to be supplied with a control signal, the source coupled to the drain of the transistor MN81 and the signal line SGL1, and the drain coupled to the source of the transistor MN81. The transistors MN81 and MP82 configure a transmission gate. A pixel signal generated by the pixel signal generation circuit 32 is supplied to the source of the transistor MN81 and the drain of the transistor MP82. The capacitor C81 has one end coupled to the signal line SGL1, and another end coupled to the power supply line VSS. The transistor MP83 has a gate to be supplied with a control signal, a drain coupled to a source of the transistor MN84 and signal line SGL2, and a source coupled to a drain of the transistor MN84 and a power supply line Vorst. The transistor MN84 has a gate to be supplied with a control signal, the source coupled to the drain of the transistor MP83 and the signal line SGL2, and the drain coupled to the source of the transistor MP83 and the power supply line Vorst. The transistors MP83 and MN84 configure a transmission gate. The transistor MP85 has a gate coupled to a control line INIL, a drain coupled to the signal line SGL2, and a source coupled to a power supply line Vini. The transistor MP86 has a gate coupled to a control line ELL, a drain coupled to the signal line SGL2, and a source coupled to a power supply line Vel.

The pixel PIX includes transistors MP91 and MP92, a capacitor C91, transistors MP93 to MP96, and the light-emitting element EL. The transistors MP91 to MP96 are P-type MOSFETs. The transistor MP91 has a gate coupled to the control line WSEN, a source coupled to the signal line SGL2, and a drain coupled to a source of the transistor MP92. The transistor MP92 has a gate coupled to the control line WSL, the source coupled to the drain of the transistor MP91, and a drain coupled to a gate of the transistor MP93 and the capacitor C91. The capacitor C91 has one end coupled to the power supply line Vel, and another end coupled to the drain of the transistor MP92 and the gate of the transistor MP93. The transistor MP93 has the gate coupled to the drain of the transistor MP92 and the other end of the capacitor C91, a source coupled to the power supply line Vel, and a drain coupled to sources of the transistors MP94 and MP95. The transistor MP94 has a gate coupled to the control line AZSL, the source coupled to the drain of the transistor MP93 and the source of the transistor MP95, and a drain coupled to the signal line SGL2. The transistor MP95 has a gate coupled to the control line DSL, the source coupled to the drain of the transistor MP93 and the source of the transistor MP94, and a drain coupled to a source of the transistor MP96 and the anode of the light-emitting element EL. The transistor MP96 has a gate coupled to the control line AZSL, the source coupled to the drain of the transistor MP95 and the anode of the light-emitting element EL, and a drain coupled to the power supply line VSS.

With this configuration, in the pixel PIX, the transistors MP91 and MP92 are turned on to thereby set a voltage between both ends of the capacitor C91 on the basis of the pixel signal supplied through the transistors MN81 and MP82, the signal line SGL1, the transistors MN71 and MP72, the capacitor C71, and the signal line SGL2. The transistor MP95 is turned on or off on the basis of a signal of the control line DSL. The transistor MP93 causes a current corresponding to the voltage between both ends of the capacitor C91 to flow into the light-emitting element EL in a period in which the transistor MP95 is turned on. The light-emitting element EL emits light on the basis of the current supplied from the transistor MP93. Thus, the pixel PIX emits light with luminance corresponding to the pixel signal. The transistor MP94 and 96 are turned on or off on the basis of a signal of the control line AZSL. In a period in which the transistor MP94 is turned on, the drain of the transistor MP93 and the source of the transistor MP95 are coupled to the signal line SGL2. In a period in which the transistor MP96 is turned on, the voltage of the anode of the light-emitting element EL is set to a voltage of the power supply line Vorst, thereby being initialized. In addition, the transistor MP85 is turned on or off on the basis of a signal of the control line INIL, the transistor MP86 is turned on or off on the basis of a signal of the control line ELL, and the transistor MP73 is turned on or off on the basis of a signal of the control line REFL. When the transistor MP85 is turned on, the voltage of the signal line SGL2 is set to a voltage of the power supply line Vini. When the transistor MP86 is turned on, the voltage of the signal line SGL2 is set to a voltage of the power supply line Vel. When the transistor MP73 is turned on, the end of the capacitor C71 is set to a voltage of the power supply line Vref, thereby being initialized.

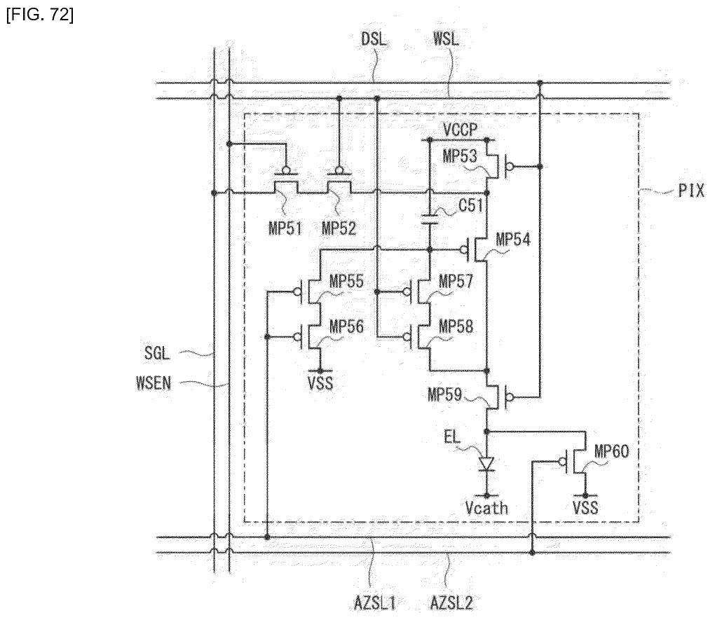

FIG. 72 illustrates another configuration example of the pixel PIX. The pixel array including this pixel PIX includes the control line WSL, the control line DSL, and the control lines AZSL1 and AZSL2. The control lines CTL illustrated in FIG. 65 include the control lines WSL, DSL, AZSL1, and AZSL2. This pixel PIX includes transistors MP51 to MP54, a capacitor C51, transistors MP55 to MP60, and the light-emitting element EL. The transistors MP51 to MP60 are P-type MOSFETs. The transistor MP51 has a gate coupled to the control line WSEN, a source coupled to the signal line SGL, and a drain coupled to a source of the transistor MP52. The transistor MP52 has a gate coupled to the control line WSL, the source coupled to the drain of the transistor MP51, and a drain coupled to a drain of the transistor MP53 and a source of the transistor MP54. The transistor MP53 has a gate coupled to the control line DSL, a source coupled to the power supply line VCCP, and the drain coupled to the drain of the transistor MP52 and the source of the transistor MP54. The transistor MP54 has a gate coupled to a source of the transistor MP55, a drain of the transistor MP57, and the capacitor C51, the source coupled to the drains of the transistors MP52 and MP53, and a drain coupled to sources of the transistors MP58 and MP59. The capacitor C51 has one end coupled to the power supply line VCCP, and another end coupled to the gate of the transistor MP54, the source of the transistor MP55, and the drain of the transistor MP57. The capacitor C51 may include two capacitors coupled in parallel to each other. The transistor MP55 has a gate coupled to the control line AZSL1, the source coupled to the gate of the transistor MP54, the drain of the transistor MP57, and the other end of the capacitor C51, and a drain coupled to a source of the transistor MP56. The transistor MP56 has a gate coupled to the control line AZSL1, the source coupled to the drain of the transistor MP55, a drain coupled to the power supply line VSS. The transistor MP57 has a gate coupled to the control line WSL, the drain coupled to the gate of the transistor MP54, the source of the transistor MP55, and the other end of the capacitor C51, and a source coupled to a drain of the transistor MP58. The transistor MP58 has a gate coupled to the control line WSL, the drain coupled to the drain of the transistor MP57, and the source coupled to the drain of the transistor MP54 and the source of the transistor MP59. The transistor 59 has a gate coupled to the control line DSL, the source coupled to the drain of the transistor MP54 and the source of the transistor MP58, and a drain coupled to a source of the transistor MP60 and the anode of the light-emitting element EL. The transistor MP60 has a gate coupled to the control line AZSL2, the source coupled to the drain of the transistor MP59 and the anode of the light-emitting element EL, and a drain coupled to the power supply line VSS.

With this configuration, in the pixel PIX, the transistors MP51, MP52, MP54, MP58, and MP57 are turned on to thereby set a voltage between both ends of the capacitor C51 on the basis of the pixel signal supplied from the signal line SGL. The transistors MP53 and MP59 are turned on or off on the basis of a signal of the control line DSL. The transistor MP54 causes a current corresponding to the voltage between both ends of the capacitor C51 to flow into the light-emitting element EL in a period in which the transistors MP53 and MP59 are turned on. The light-emitting element EL emits light on the basis of the current supplied from the transistor MP54. Thus, the pixel PIX emits light with luminance corresponding to the pixel signal. The transistors MP55 and MP56 are turned on or off on the basis of a signal of the control line AZSL1. In a period in which the transistors MP55 and MP56 are turned on, a voltage of the gate of the transistor MP54 is set to the voltage of the power supply line VSS, thereby being initialized. The transistor MP60 is turned on or off on the basis of a signal of the control line AZSL2. In a period in which the transistor MP60 is turned on, the voltage of the anode of the light-emitting element EL is set to the voltage of the power supply line VSS, thereby being initialized.

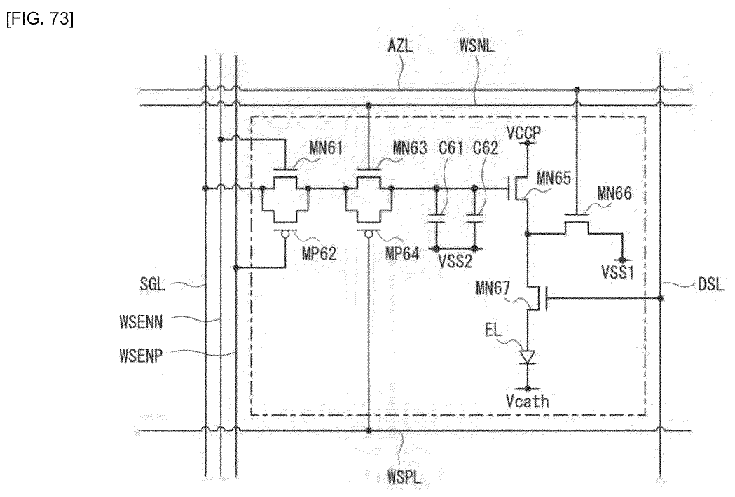

FIG. 73 illustrates another configuration example of the pixel PIX. The pixel array including this pixel PIX includes control lines WSENN and WSENP, control lines WSNL and WSPL, the control line AZL, and the control line DSL. The control lines WSEN illustrated in FIG. 65 include the control lines WSENN and WSENP. The control lines CTL illustrated in FIG. 65 include the control lines WSNL, WSPL, AZL, and DSL. A signal of the control line WSENN and a signal of the control line WSENP are signals inverted from each other. A signal of the control line WSNL and a signal of the control line WSPL are signals inverted from each other.

The pixel PIX includes transistors MN61, MP62, MN63, and MP64, capacitors C61 and C62, transistors MN65 to MN67, and the light-emitting element EL. The transistors MN61, MN63, and MN65 to MN67 are N-type MOSFETs, and the transistors MP62 and MP64 are P-type MOSFETs. The transistor MN61 has a gate coupled to the control line WSENN, a drain coupled to the signal line SGL and a source of the transistor MP62, and a source coupled to a drain of the transistor MP62, a drain of the transistor MN63, and a source of the transistor MP64. The transistor MP62 has a gate coupled to the control line WSENP, the source coupled to the signal line SGL and the drain of the transistor MN61, and the drain coupled to the source of the transistor MN61, the drain of the transistor MN63, and the source of the transistor MP64. The transistor MN63 has a gate coupled to the control line WSNL, the drain coupled to the source of the transistor MN61, the drain of the transistor MP62, and the source of the transistor MP64, and a source coupled to a drain of the transistor MP64, the capacitors C61 and C62, and a gate of the transistor MN65. The transistor MP64 has a gate coupled to the control line WSPL, the source coupled to the source of the transistor MN61, the drain of the transistor MP62, and the drain of the transistor MN63, and the drain coupled to the source of the transistor MN63, the capacitors C61 and C62, and the gate of the transistor MN65. The capacitor C61 is configured with use of, for example, a MOM (Metal Oxide Metal) capacitor, and has one end coupled to the source of the transistor MN63, the drain of the transistor MP64, the capacitor C62, and the gate of the transistor MN65, and another end coupled to a power supply line VSS2. It is to be noted that the capacitor C61 may be configured with use of, for example, a MOS capacitor or a MIM (Metal Insulator Metal) capacitor. The capacitor C62 is configured with use of, for example, a MOS capacitor, and has one end coupled to the source of the transistor MN63, the drain of the transistor MP64, the one end of the capacitor C61, and the gate of the transistor MN65, and another end coupled to the power supply line VSS2. It is to be noted that the capacitor C62 may be configured with use of, for example, a MOM capacitor or a MIM capacitor. The transistor MN65 has the gate coupled to the source of the transistor MN63, the drain of the transistor MP64, and the one ends of the capacitors C61 and C62, a drain coupled to the power supply line VCCP, and a source coupled to drains of the transistors MN66 and MN67. The transistor MN66 has a gate coupled to the control line AZL, the drain coupled to the source of the transistor MN65 and the drain of the transistor MN67, and a source coupled to a power supply line VSS1. The transistor MN67 has a gate coupled to the control line DSL, the drain coupled to the source of the transistor MN65 and the drain of the transistor MN66, and a source coupled to the anode of the light-emitting element EL.

With this configuration, in the pixel PIX, at least one of the transistor MN61 or the transistor MP62 is turned on, and at least one of the transistor MN63 or the transistor MP64 is turned on, thereby setting a voltage between both ends of the capacitor C61 and a voltage between both ends of the capacitor C62 on the basis of the pixel signal supplied from the signal line SGL. The transistor MN67 is turned on or off on the basis of a signal of the control line DSL. The transistor MN65 causes a current corresponding to the voltages between both ends of the capacitor C61 and between both ends of capacitor C62 to flow into the light-emitting element EL in a period in which the transistor MN67 is turned on. The light-emitting element EL emits light on the basis of the current supplied from the transistor MP65. Thus, the pixel PIX emits light with luminance corresponding to the pixel signal. The transistor MN66 may be turned on or off on the basis of a signal of the control line AZL. In addition, the transistor MN66 may function as a resistor having a resistance value corresponding to a signal of the control line AZL. In this case, the transistor MN65 and the transistor MN66 configure what is called a source-follower circuit.

It is to be noted that the effects described herein are merely illustrative and non-limiting, and other effects may be provided.

It is to be noted that the present technology may have the following configurations. According to the present technology having the following configurations, it is possible to reduce the latency.

(1)

A display device including:
a reception circuit that is configured to receive a piece of first image data, a piece of second image data, and a piece of third image data, the piece of first image data representing an entire image having a first resolution, the piece of second image data representing a peripheral image having a second resolution less than or equal to the first resolution, the peripheral image including an image outside the entire image, the piece of third image data representing a first partial image having a third resolution higher than the first resolution, the first partial image including an image having an image range narrower than an image range of the entire image;
a display section that includes a plurality of pixels, and is configured to display an image having a same image range as the image range of the entire image;
a first sensor that is configured to detect a change in orientation of the display device; an image processing circuit that is configured to perform a first image processing for generating a piece of display image data by performing a geometric deformation processing on the piece of first image data, the piece of second image data, and the piece of third image data on the basis of a result of detection by the first sensor; and
a display drive circuit that is configured to drive the display section on the basis of the piece of display image data.
   (2)

The display device according to (1), in which, in a case where the result of detection by the first sensor indicates that the orientation has changed, the piece of display image data includes a piece of first data based on the piece of first image data, a piece of second data based on the piece of second image data, and a piece of third data based on the piece of third image data.

(3)

The display device according to (2), in which the piece of display image data further includes a piece of fourth data representing an outside image outside an image represented by the piece of second data.

(4)

The display device according to (3), in which the image processing circuit is configured to generate the piece of fourth data having a predetermined pixel value.

(5)

The display device according to (3), in which the image processing circuit is configured to generate the piece of fourth data on the basis of the piece of second data.

(6)

The display device according to (2), in which, in a case where the result of detection by the first sensor indicates that the orientation has not changed, the piece of display image data includes the piece of first data and the piece of third data out of the piece of first data, the piece of second data, and the piece of third data.

(7)

The display device according to any one of (1) to (6), further including a second sensor that is configured to detect which region in a display region of the display section a user is observing, in which
in a case where the result of detection by the second sensor indicates that a region being observed by the user has changed, the image processing circuit is configured to generate a piece of fourth image data representing a second partial image having the third resolution in the region being observed by the user by performing an image processing for increasing a resolution on the basis of the piece of first image data, and
the image processing circuit is configured to generate the piece of display image data by performing the geometric deformation processing on the piece of first image data, the piece of second image data, and the piece of fourth image data in the first image processing.
   (8)

The display device according to any one of (1) to (7), in which
the image processing circuit is configured to perform a second image processing for generating the piece of display image data on the basis of the piece of first image data and the piece of third image data, and
the image processing circuit is configured to selectively perform one of the first image processing and the second image processing.
   (9)

The display device according to (8), in which
the reception circuit is configured to receive the piece of first image data, the piece of second image data, and the piece of third image data in each of a plurality of reception periods repeatedly set,
in a case where the reception circuit has finished receiving the piece of first image data, the piece of second image data, and the piece of third image data in a first reception period of the plurality of reception periods, the image processing circuit is configured to perform the second image processing on the basis of the piece of first image data, the piece of second image data, and the piece of third image data that have been received in the first reception period, and
in a case where the reception circuit has not finished receiving the piece of first image data, the piece of second image data, and the piece of third image data in a second reception period subsequent to the first reception period of the plurality of reception periods, the image processing circuit is configured to perform the first image processing on the basis of the piece of first image data, the piece of second image data, and the piece of third image data that have been received in the first reception period.
   (10)

The display device according to any one of (1) to (7), in which
the reception circuit is configured to receive the piece of first image data, the piece of second image data, and the piece of third image in each of a plurality of reception periods repeatedly set,
the image processing circuit is configured to perform a plurality of the first image processings in each of the plurality of reception periods, and
the display drive circuit is configured to drive the display section on the basis of a plurality of pieces of the display image data generated by the plurality of the first image processings in each of the plurality of reception periods.
   (11)

The display device according to any one of (1) to (7), in which
the reception circuit is configured to receive the piece of first image data, the piece of second image data, and the piece of third image data in each of a plurality of reception periods repeatedly set,
in each of the plurality of reception periods, the image processing circuit is configured to perform the first image processing, and a second image processing for generating the piece of display image data on the basis of the piece of first image data and the piece of third image data, and
in each of the plurality of reception periods, the display drive circuit is configured to drive the display section on the basis of the piece of display image data generated by the first image processing after driving the display section on the basis of the piece of display image data generated by the second image processing.
   (12)

The display device according to (1), in which
the piece of display image data includes a piece of first data based on the piece of first image data and a piece of third data based on the piece of third image data, and
the display drive circuit is configured to perform first driving and second driving, the first driving in which the display section is driven in units of a first number of pixels on the basis of the piece of first data, and the second driving in which the display section is driven in units of a second number of pixels smaller than the first number on the basis of the piece of third data.
   (13)

The display device according to (12), in which
in a case where the result of detection by the first sensor indicates that the orientation has changed, the piece of display image data further includes a piece of second data based on the piece of second image data, and
the display drive circuit is configured to further perform third driving in which the display section is driven in units of a third number of pixels larger than or equal to the first number on the basis of the piece of second data.
   (14)

A display system including:
an image generation device that is configured to transmit a piece of first image data, a piece of second image data, and a piece of third image data, the piece of first image data representing an entire image having a first resolution, the piece of second image data representing a peripheral image having a second resolution less than or equal to the first resolution, the peripheral image including an image outside the entire image, the piece of third image data representing a first partial image having a third resolution higher than the first resolution, the first partial image including an image having an image range narrower than an image range of the entire image; and
a display device,
the display device including
a reception circuit that is configured to receive the piece of first image data, the piece of second image data, and the piece of third image data,
a display section that includes a plurality of pixels, and is configured to display an image having a same image range as the image range of the entire image,
a first sensor that is configured to detect a change in orientation of the display device,
an image processing circuit that is configured to perform a first image processing for generating a piece of display image data by performing a geometric deformation processing on the piece of first image data, the piece of second image data, and the piece of third image data on the basis of a result of detection by the first sensor, and
a display drive circuit that is configured to drive the display section on the basis of the piece of display image data.
   (15)

The display system according to (14), in which
the display device includes a transmission circuit that is configured to transmit the result of detection by the first sensor to the image generation device, and
the image generation device is configured to generate the piece of first image data representing the entire image on the basis of the result of detection by the first sensor transmitted from the transmission circuit.
   (16)

A display method including:
receiving a piece of first image data, a piece of second image data, and a piece of third image data, the piece of first image data representing an entire image having a first resolution, the piece of second image data representing a peripheral image having a second resolution less than or equal to the first resolution, the peripheral image including an image outside the entire image, the piece of third image data representing a first partial image having a third resolution higher than the first resolution, the first partial image including an image having an image range narrower than an image range of the entire image;
detecting a change in orientation of a display device with use of a first sensor;
performing a first image processing for generating a piece of display image data by performing a geometric deformation processing on the piece of first image data, the piece of second image data, and the piece of third image data on the basis of a result of detection by the first sensor; and
driving a display section on the basis of the piece of display image data, the display section being configured to display an image having a same image range as the image range of the entire image.

The present application claims the benefit of Japanese Priority Patent Application JP 2021-195400 filed with the Japan Patent Office on Dec. 1, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display device, comprising:
a reception circuit configured to receive a piece of first image data and a piece of second image data, wherein
the piece of first image data represents an entire image having a first resolution,
the piece of second image data represents a peripheral image having a second resolution less than or equal to the first resolution, and
the peripheral image comprising an image outside the entire image;
a display section including a plurality of pixels, wherein the display section is configured to display a first image having an image range same as an image range of the entire image;
a sensor configured to detect a change in an orientation of the display device;
an image processing circuit configured to generate a piece of display image data based on the piece of first image data, the piece of second image data, and a result of the detection by the sensor; and
a display drive circuit configured to drive the display section based on the piece of display image data.

2. The display device according to claim 1, wherein
the sensor is further configured to determine that the orientation of the display device has changed,
the image processing circuit is further configured to generate, based on the determination that the orientation of the display device has changed, the piece of display image data to include a piece of first data and a piece of second data,
the piece of first data is based on the piece of first image data, and
piece of second data is based on the piece of second image data.

3. The display device according to claim 2, wherein
the piece of display image data further includes a piece of third data that represents an outside image outside a second image, and
the piece of second data represents the second image.

4. The display device according to claim 3, wherein the image processing circuit is further configured to generate the piece of third data having a specific pixel value.

5. The display device according to claim 3, wherein the image processing circuit is further configured to generate the piece of third data based on the piece of second data.

6. The display device according to claim 1, wherein
the sensor is further configured to determine that the orientation of the display device has not changed, and
image processing circuit is further configured to generate, based on the determination that the orientation of the display device has not changed, the piece of display image data to include the piece of first data.

7. The display device according to claim 1, wherein
the reception circuit is further configured to receive the piece of first image data and the piece of second image data in each of a plurality of reception periods repeatedly set,
the image processing circuit is further configured to generate the piece of display image data corresponding to each of the plurality of reception periods, and
the display drive circuit is further configured to drive the display section based on the display image data corresponding to each of the plurality of reception periods.

8. A display system, comprising:
an image generation device configured to transmit a piece of first image data and a piece of second image data, wherein
the piece of first image data represents an entire image having a first resolution,
the piece of second image data represents a peripheral image having a second resolution less than or equal to the first resolution, and
the peripheral image comprising an first image outside the entire image; and
a display device that includes:
a reception circuit configured to receive the piece of first image data and the piece of second image data;
a display section including a plurality of pixels, wherein the display section is configured to display an second image having an image range same as an image range of the entire image;
a sensor configured to detect a change in an orientation of the display device;
an image processing circuit configured to generate a piece of display image data based on the piece of first image data, the piece of second image data, and a result of the detection by the sensor; and
a display drive circuit configured to drive the display section based on the piece of display image data.

9. The display system according to claim 8, wherein
the display device further includes a transmission circuit configured to transmit the result of the detection by the sensor to the image generation device, and
the image generation device is further configured to generate the piece of first image data based on the received result of the detection by the sensor.

10. A display method, comprising:
receiving a piece of first image data and a piece of second image data, wherein
the piece of first image data represents an entire image having a first resolution,
the piece of second image data represents a peripheral image having a second resolution less than or equal to the first resolution, and
the peripheral image comprising a first image outside the entire image;
detecting, by a sensor, a change in an orientation of a display device;
generating a piece of display image data based on the piece of first image data, the piece of second image data, and a result of the detection by the sensor; and
driving a display section based on the piece of display image data, wherein the display section is configured to display a second image having an image range same as an image range of the entire image.
